(19) United States
(12) Patent Application Publication
(10) Pub. No.: US 2025/0326149 A1
(43) Pub. Date: Oct. 23, 2025

(54) MEDIUM CUTTING METHOD, MEDIUM CUTTING DEVICE, MEDIUM END CONNECTION METHOD, AND CONTROL METHOD OF MEDIUM CUTTING DEVICE

(71) Applicant: MIMAKI ENGINEERING CO., LTD., Nagano (JP)

(72) Inventors: Tomoya Kawai, Nagano (JP); Arata Kobayashi, Nagano (JP); Kohei Nakamura, Nagano (JP); Takahito Shinohara, Nagano (JP); Masayuki Furuse, Nagano (JP); Shota Tsukahara, Nagano (JP)

(73) Assignee: MIMAKI ENGINEERING CO., LTD., Nagano (JP)

(21) Appl. No.: 18/707,879

(22) PCT Filed: Oct. 31, 2022
(86) PCT No.: PCT/JP2022/040823

§ 371 Date: Oct. 28, 2024

(30) Foreign Application Priority Data
Nov. 18, 2021 (JP) 2021-188008
Nov. 18, 2021 (JP) 2021-188009
Feb. 18, 2022 (JP) 2022-024097
Jun. 29, 2022 (JP) 2022-104525
Sep. 27, 2022 (JP) 2022-153306

(51) Int. Cl. B26D 1/04; B26D 5/20; B41J 11/66; B41J 11/70; B65H 23/26; B65H 35/06

(52) U.S. Cl. CPC B26D 1/045; B26D 5/20; B41J 11/663; B41J 11/706; B65H 23/26; B65H 35/06; B65H 2511/21; B65H 2701/1752

(57) ABSTRACT

To stabilize a shape of a cut portion regardless of characteristics of a medium. The medium cutting method includes a first thrusting process of thrusting a cutter blade into a medium 2 so as to penetrate the medium 2, and a first cutting process of relatively moving the cutter blade with respect to the medium 2 in a longitudinal direction of the medium 2 and a width direction of the medium 2 with a first thrusting spot SP2 as a starting point, which is a spot thrust by the cutter blade in the first thrusting process, to cut the medium 2 in a direction inclined with respect to the width direction of the medium 2.

### TECHNICAL FIELD

The present invention relates to a medium cutting method, a medium cutting device, a medium end connection method, and a control method of the medium cutting device.

### BACKGROUND ART

Patent Literature 1 discloses a printing apparatus that performs printing on a long sheet-like medium (continuous medium) by an inkjet method. This printing apparatus includes a cutter blade that cuts a medium on which printing has been completed. The cutter blade moves from one end toward the other end in the width direction of the medium to cut the medium.

### CITATION LIST

### Patent Literature

Patent Literature 1: Japanese Unexamined Patent Publication No. 2018-83251

### SUMMARY OF INVENTION

### Technical Problems

In Patent Literature 1, when the medium is cut, the cutter blade is moved in a direction inclined with respect to the width direction of the medium. Thus, the cut portion of the medium has a shape inclined with respect to the width direction of the medium. Accordingly, the roll-shaped medium can be easily pulled out at the time of replacing the medium, and the medium can be easily set in the printing apparatus.

Here, depending on the characteristics of the medium, the cutter blade may not smoothly enter in the oblique direction from one end in the width direction of the medium. Therefore, even if the same cutting processing is performed, the shape of the cut portion may not be stable depending on the characteristics of the medium.

Therefore, it is required to stabilize the shape of the cut portion regardless of the characteristics of the medium.

### Solutions to Problems

A medium cutting method of the present invention is a medium cutting method for cutting a medium in a medium cutting device including a cutter unit having a cutter blade for cutting a long medium and a moving mechanism for relatively moving the cutter unit to the medium in a width direction of the medium orthogonal to a longitudinal direction of the medium and a thickness direction of the medium and the longitudinal direction of the medium, the medium cutting method including: a first thrusting process of thrusting the cutter blade into the medium so as to penetrate the medium; a first cutting process of cutting the medium in a direction inclined with respect to the width direction of the medium by relatively moving the cutter blade with respect to the medium in the longitudinal direction of the medium and the width direction of the medium with a first thrusting spot as a starting point, which is a spot thrust by the cutter blade in the first thrusting process.

In the medium cutting method of the present invention, after the medium is thrust with the cutter blade so as to penetrate the medium in the first thrusting process, the medium is cut in a direction inclined with respect to the width direction of the medium by relatively moving the cutter blade with respect to the medium in the longitudinal direction of the medium and the width direction of the medium with the first thrusting spot as a starting point, which is the spot thrust with the cutter blade, in the first cutting process.

As a result, cutting is started from between one end and the other end in the width direction of the medium. Thus, the cutting is started in a state where the cutter blade is reliably positioned in the medium. Therefore, the shape of the cut portion is stabilized regardless of the characteristics of the medium.

Thus, it is possible to start cutting the medium in a direction inclined with respect to the width direction of the medium using the cutter blade penetrating the medium. Therefore, the medium can be appropriately cut in the direction inclined with respect to the width direction of the medium.

The medium cutting method of the present invention includes: a second cutting process of relatively moving the cutter blade to the medium in the width direction of the medium to cut the medium in an entire region in the width direction of the medium. The moving mechanism includes a medium conveyance mechanism that conveys the medium in the longitudinal direction of the medium and a cutter unit driving mechanism that moves the cutter unit in the width direction of the medium. When an upstream side in a conveyance direction of the medium is defined as a conveyance direction upstream side, a downstream side in a conveyance direction of the medium is defined as a conveyance direction downstream side, one side in the width direction of the medium is defined as a first direction side, an other side in the width direction of the medium is defined as a second direction side, the medium disposed on the conveyance direction upstream side with respect to a cutting position of the medium in the second cutting process is defined as an upstream medium, and an end surface on the conveyance direction downstream side of the upstream medium after the second cutting process is finished is defined as a first end surface, in the first thrusting process, the cutter blade is preferable to thrust into the upstream medium, and in the first cutting process, the upstream medium is preferable to cut from the first thrusting spot to the first end surface.

Thus, in the first cutting process, the upstream medium is cut to the first end surface that is the end surface on the conveyance direction downstream side of the upstream medium while the upstream medium is conveyed to the conveyance direction upstream side that is the upstream side in the conveyance direction of the medium, so that the generation of wrinkles on the upstream medium when cutting the upstream medium can be reduced. Therefore, the medium can be more appropriately cut in the direction inclined with respect to the width direction of the medium.

The medium cutting method of the present invention includes: a second thrusting process of thrusting the cutter blade into the upstream medium so as to penetrate the upstream medium; and a third cutting process of cutting the upstream medium in a direction inclined with respect to the width direction of the medium by relatively moving the cutter blade with respect to the upstream medium in the longitudinal direction of the medium and the width direction of the medium with a second thrusting spot as a starting point, which is a spot thrust by the cutter blade in the second thrusting process. The medium cutting device includes a medium winding mechanism that rotates a winding core material to which an end portion of the medium on the conveyance direction downstream side is fixed and winds the medium around the core material. In the first thrusting process, the cutter blade is thrust into an end portion of the upstream medium on the first direction side. In the first cutting process, the cutter blade is relatively moved with respect to the upstream medium from the first thrusting spot to the first end surface toward the conveyance direction downstream side and the second direction side. In the second thrusting process, the cutter blade is thrust into an end portion of the upstream medium on the second direction side. In the third cutting process, the cutter blade is relatively moved with respect to the upstream medium from the second thrusting spot to the first end surface toward the conveyance direction downstream side and the first direction side.

As a result, both side portions in the width direction of the medium on the conveyance direction downstream end of the upstream medium are inclined with respect to the width direction of the medium, so that the medium can be easily wound by the core material when the end portion on the conveyance direction downstream side of the upstream medium is fixed to the core material and the winding of the upstream medium by the core material is started.

The medium cutting method of the present invention includes: a fourth cutting process of moving the cutter blade toward the first direction side with respect to the upstream medium with the first thrusting spot as a starting point to cut the upstream medium in the width direction of the medium from the first thrusting spot to an end surface of the upstream medium on the first direction side after the first thrusting process and before the first cutting process; and a fifth cutting process of moving the cutter blade toward the second direction side with respect to the upstream medium with the second thrusting spot as a starting point to cut the upstream medium in the width direction of the medium from the second thrusting spot to the end surface on the second direction side of the upstream medium after the second thrusting process and before the third cutting process.

In the present invention, preferably, the cutter unit includes a cutter holder to which the cutter blade is fixed, and a unit frame that rotatably holds the cutter holder, the cutter holder is rotatable with respect to the unit frame with the thickness direction of the medium as an axial direction of rotation, in the first cutting process and the third cutting process, the cutter blade is rotatable with respect to the unit frame, and a cutting angle of the upstream medium with respect to the width direction of the medium in the first cutting process and a cutting angle of the upstream medium with respect to the width direction of the medium in the third cutting process are constant regardless of a width of the medium.

This makes it possible to make the rotation angle of the cutter holder with respect to the unit frame constant in the first cutting process and the third cutting process regardless of the width of the medium. Therefore, in the first cutting process and the third cutting process, it is possible to reduce excessive rotation of the cutter holder with respect to the unit frame.

In the present invention, preferably, the second cutting process includes: a third thrusting process of thrusting the medium with the cutter blade so as to penetrate the medium; a sixth cutting process of moving the cutter blade toward the first direction side with respect to the medium to cut the medium in the width direction of the medium with a third thrusting spot as a starting point, which is a spot thrust with the cutter blade in the third thrusting process; and a seventh cutting process of moving the cutter blade toward the second direction side with respect to the medium to cut the medium in the width direction of the medium with the third thrusting spot as a starting point up to an end surface on the second direction side of the medium.

Thus, in the sixth cutting process and the seventh cutting process, the medium can be started to be cut in the width direction of the medium using the cutter blade penetrating the medium. Therefore, it is possible to appropriately cut the medium in the width direction of the medium.

A control method of a medium cutting device of the present invention which includes a cutter unit having a cutter blade for cutting a long medium, and a moving mechanism that relatively moves the cutter unit with respect to the medium in a width direction of the medium orthogonal to a longitudinal direction of the medium and a thickness direction of the medium and the longitudinal direction of the medium, wherein the moving mechanism includes a medium conveyance mechanism that conveys the medium in the longitudinal direction of the medium, and a cutter unit driving mechanism that moves the cutter unit in the width direction of the medium, the control method including: when an upstream side in a conveyance direction of the medium is defined as a conveyance direction upstream side, a downstream side in a conveyance direction of the medium is defined as a conveyance direction downstream side, one side in the width direction of the medium is defined as a first direction side, and an other side in the width direction of the medium is defined as a second direction side, a first thrusting step of thrusting the cutter blade into an end portion of the medium on the first direction side so as to penetrate the medium; a first cutting step of relatively moving the cutter blade with respect to the medium toward the conveyance direction downstream side and the second direction side with a first thrusting spot as a starting point, which is a spot thrust by the cutter blade in the first thrusting step, to cut the medium in a direction inclined with respect to the width direction of the medium from the first thrusting spot to a first end surface that is an end surface on the conveyance direction downstream side of the medium; a second thrusting step of thrusting the cutter blade into an end portion of the medium on the second direction side so as to penetrate the medium; a third cutting step of relatively moving the cutter blade toward the conveyance direction downstream side and the first direction side with respect to the medium with a second thrusting spot as a starting point, which is a spot thrust by the cutter blade in the second thrusting step, to cut the medium in a direction inclined with respect to the width direction of the medium from the second thrusting spot to the first end surface; a fourth cutting step of moving the cutter blade toward the first direction side with respect to the medium with the first thrusting spot as a starting point to cut the medium in the width direction of the medium from the first thrusting spot to an end surface on the first direction side of the medium; and a fifth cutting step of moving the cutter blade toward the second direction side with respect to the medium with the second thrusting spot as a starting point to cut the medium in the width direction of the medium from the second thrusting spot to an end surface on the second direction side of the medium.

In the control method of the medium cutting device of the present invention, the medium is thrust with the cutter blade so as to penetrate the medium in the first thrusting step, and then the medium is cut in a direction inclined with respect to the width direction of the medium by relatively moving the cutter blade to the conveyance direction downstream side and the second direction side with respect to the medium with the first thrusting spot, which is the portion thrust with the cutter blade, as a starting point in the first cutting step. In the present invention, in the second thrusting step, the medium is thrust with the cutter blade so as to penetrate the medium, and then in the second cutting step, the medium is cut in a direction inclined with respect to the width direction of the medium by relatively moving the cutter blade to the conveyance direction downstream side and the first direction side with respect to the medium with the second thrusting spot, which is the place thrust with the cutter blade, as a starting point.

This makes it possible to start cutting the medium in a direction inclined with respect to the width direction of the medium using the cutter blade penetrating the medium. Therefore, in the present invention, the medium can be appropriately cut in a direction inclined with respect to the width direction of the medium.

In the present invention, the fourth cutting step is performed before the first cutting step, and the fifth cutting step is performed before the third cutting step.

A medium cutting device of the present invention for cutting a long medium, includes: a cutter unit having a cutter blade fur cutting the medium, a moving mechanism that relatively moves the cutter unit to the medium in a width direction of the medium orthogonal to a longitudinal direction of the medium and a thickness direction of the medium and the longitudinal direction of the medium, and a control unit that controls the medium cutting device. The cutter unit includes a cutter holder to which the cutter blade is fixed, a unit frame that rotatably holds the cutter holder, and a switching mechanism that switches a state of the cutter holder between a rotation regulating state in which rotation of the cutter holder with respect to the unit frame is regulated and a rotatable state in which the cutter holder can rotate with respect to the unit frame. The cutter holder is rotatable with respect to the unit frame with the thickness direction of the medium as an axial direction of rotation. The control unit performs cutting of the medium in a lateral cutting mode in which the cutter unit is relatively moved with respect to the medium in the width direction of the medium to cut the medium in the width direction of the medium and cutting of the medium in an oblique cutting mode in which the cutter unit is relatively moved with respect to the medium in the longitudinal direction of the medium and the width direction of the medium to cut the medium in a direction inclined with respect to the width direction of the medium, and sets the cutter holder in the rotation regulating state in the lateral cutting mode and sets the cutter holder in the rotatable state in the oblique cutting mode.

In the medium cutting device of the present invention, the cutter unit includes a switching mechanism that switches the state of the cutter holder between a rotation regulating state in which the rotation of the cutter holder to which the cutter blade is fixed with respect to the unit frame is restricted and a rotatable state in which the cutter holder can be rotated with respect to the unit frame. In the present invention, the control unit sets the cutter holder in the rotatable state when cutting the medium in the oblique cutting mode in which the cutter unit is relatively moved to the medium in the longitudinal direction of the medium and the width direction of the medium to cut the medium in the direction inclined with respect to the width direction of the medium, and sets the cutter holder in the rotation regulating state when cutting the medium in the lateral cutting mode in which the cutter unit is relatively moved to the medium in the width direction of the medium to cut the medium in the width direction of the medium.

Thus, even if the medium can be cut in the lateral cutting mode in which the medium is cut in the width direction of the medium and the medium can be cut in the oblique cutting mode in which the medium is cut in the direction inclined with respect to the width direction of the medium, the state of the cutter holder when cutting the medium in the lateral cutting mode can be stabilized. As a result, the state of the cutter blade when cutting the medium in the lateral cutting mode can be stabilized.

In the present invention, the switching mechanism includes a regulation member that regulates rotation of the cutter holder, and a drive source that moves the regulation member to a regulation position where the regulation member approaches the cutter holder and a regulation release position where the regulation member moves away from the cutter holder, the cutter holder is brought into the rotation regulating state when the regulation member is disposed at the regulation position, and the cutter holder is in the rotatable state when the regulation member is disposed at the regulation release position.

This makes it possible to switch the state of the cutter holder with a relatively simple configuration.

In the present invention, the cutter unit includes a rotation range regulation member that restricts the rotation range of the cutter holder in the rotatable state.

The medium cutting device of the present invention includes a medium winding mechanism that rotates a winding core material to which an end portion of the medium is fixed and winds the medium around the core material.

In the present invention, the control unit performs cutting of the medium in a first oblique cutting mode as the oblique cutting mode in which the medium is cut between an intermediate position of the medium in the width direction of the medium and one end side of the medium in the width direction of the medium and cutting the medium in a second oblique cutting mode as the oblique cutting mode in which the medium is cut between the intermediate position of the medium in the width direction of the medium and an other end side of the medium in the width direction of the medium.

Thus, since both side portions in the width direction of the medium at one end of the medium in the longitudinal direction of the medium are inclined with respect to the width direction of the medium, the medium is easily wound by the core material at the start of winding of the medium by the core material.

In the present invention, the moving mechanism includes a medium conveyance mechanism that conveys the medium in the longitudinal direction of the medium and a cutter unit driving mechanism that moves the cutter unit in the width direction of the medium, and the control unit sets a cutting angle of the medium with respect to the width direction of the medium by controlling a conveyance speed of the medium by the medium conveyance mechanism and a moving speed of the cutter unit by the cutter unit driving mechanism in the first oblique cutting mode and the second oblique cutting mode according to predetermined data input to the control unit.

In the present invention, the outer diameter of the core material is 3 inches or 2 inches. In this case, the medium is formed of soft polyvinyl chloride or tarpaulin, and a cutting angle of the medium with respect to the width direction of the medium in the first oblique cutting mode and the second oblique cutting mode is 7° to 13°.

This makes it possible to appropriately wind up the medium with the core material while reducing the breakage of the medium at the start of winding up the medium with the core material.

In this case, a cutting angle of the medium with respect to the width direction of the medium in the first oblique cutting mode and the second oblique cutting mode is 8° to 12°.

This makes it possible to further appropriately wind up the medium with the core material while reducing the breakage of the medium at the start of winding up the medium with the core material.

The medium cutting device of the present invention includes: a processing mechanism that performs predetermined processing on the medium before being cut. When a portion of the medium processed by the processing mechanism is defined as a processed portion, and a portion of the medium on an upstream side of the processed portion in a conveyance direction of the medium, the portion not processed by the processing mechanism, is defined as a non-processed portion, after the medium is processed by the processing mechanism, the control unit cuts the non-processed portion over an entire region in the width direction of the medium in the lateral cutting mode, and then performs cutting the medium in the first oblique cutting mode and cutting the medium in the second oblique cutting mode with respect to the non-processed portion disposed on an upstream side in the conveyance direction of the medium with respect to a cutting position in the lateral cutting mode.

Thus, after the cutting of the medium in the first oblique cutting mode and the cutting of the medium in the second oblique cutting mode are performed with respect to the non-processed portion disposed on the upstream side in the conveyance direction of the medium with respect to the cutting position in the lateral cutting mode, both side portions in the width direction of the medium of one end of the medium detached from the medium cutting device are inclined with respect to the width direction of the medium. Therefore, even if the medium is once removed from the medium cutting device and then set again in the medium cutting device, both side portions of one end of the medium in the width direction of the medium are inclined with respect to the width direction of the medium.

Therefore, even if the medium is not cut after the medium is set in the medium cutting device, the medium can be easily wound by the core material at the start of winding of the medium by the core material.

The medium cutting device of the present invention includes: a printing mechanism that performs printing through an inkjet method on the medium before being cut. The printing mechanism preferably includes an inkjet head that ejects ink onto the medium and a carriage on which the inkjet head is mounted. The moving mechanism preferably includes a medium conveyance mechanism that conveys the medium in the longitudinal direction of the medium and a cutter unit driving mechanism that moves the cutter unit in the width direction of the medium. The cutter unit is preferably mounted on the carriage. The cutter unit driving mechanism preferably moves the carriage in the width direction of the medium.

Thus, the inkjet head can be moved in the width direction of the medium in addition to the cutter unit using the cutter unit driving mechanism. Therefore, the configuration of the medium cutting device can be simplified as compared with a case where a drive mechanism for moving the inkjet head is separately provided.

In a medium cutting method of the present invention for cutting a medium in a medium cutting device including a cutter unit having a cutter blade for cutting a long medium, a medium feeding mechanism for holding the medium wound in a roll shape, a medium conveyance mechanism for conveying the medium in a longitudinal direction of the medium, and a cutter unit driving mechanism for moving the cutter unit in a width direction of the medium orthogonal to the longitudinal direction of the medium and a thickness direction of the medium, the medium cutting method includes: when, in a conveyance direction of the medium by the medium conveyance mechanism, a side on which the cutter blade is disposed with respect to the medium feeding mechanism is defined as a conveyance direction downstream side, and a side opposite to the conveyance direction downstream side is defined as a conveyance direction upstream side, a linear cutting process of moving the cutter blade in the width direction of the medium in a state where the medium is stopped to cut the medium in an entire region in the width direction of the medium; a medium conveyance process of conveying the medium by a predetermined amount toward the conveyance direction downstream side after the linear cutting process; and a convex cutting process of moving the cutter blade in the width direction of the medium and conveying the medium to cut the medium in an entire region in the width direction of the medium after the medium conveyance process. When the medium disposed on the conveyance direction upstream side of the cutting position of the medium in the convex cutting process is defined as a first upstream medium, and the medium disposed on the conveyance direction upstream side of the cutting position of the medium in the linear cutting process is defined as a second upstream medium. An end surface of the second upstream medium on the conveyance direction downstream side is linear parallel to the width direction of the medium. An end surface of the first upstream medium on the conveyance direction downstream side has a trapezoidal shape or a triangular convex shape. In the medium conveyance process, the medium is conveyed to a position where a predetermined interval is formed between the conveyance direction downstream end of the second upstream medium and the conveyance direction downstream end of the first upstream medium.

In the medium cutting method of the present invention, in the medium conveyance process after the linear cutting process of moving the cutter blade in the width direction of the medium to cut the medium in the entire region in the width direction of the medium in a state where the medium is stopped so that the end surface on the conveyance direction downstream side of the second upstream medium is linear parallel to the width direction of the medium, and before the convex cutting process of moving the cutter blade in the width direction of the medium so that the end surface on the conveyance direction downstream side of the first upstream medium is in a trapezoidal shape or a triangular convex shape and conveying the medium to cut the medium in the entire region in the width direction of the medium, the medium is conveyed to the conveyance direction downstream side to a position where a predetermined interval is formed between the conveyance direction downstream end of the second upstream medium and the conveyance direction downstream end of the first upstream medium.

Thus, this makes it possible to increase the distance in the conveyance direction of the medium between the end surface of the second upstream medium on the conveyance direction downstream side and the arrangement position of the cutter unit before the convex cutting process is performed. Therefore, even if the curling tendency of the medium becomes strong, the floating of the medium from the platen at the arrangement position of the cutter unit in the medium conveyance direction can be reduced when the convex cutting process is performed. As a result, even if the curling tendency of the medium becomes strong, one end portion in the longitudinal direction of the medium can be appropriately cut so that the end surface of the medium becomes a convex shape forming a trapezoidal shape or a triangular convex shape after the medium is cut in a straight line parallel to the width direction over the entire region in the width direction before the medium is replaced.

In the present invention, the medium cutting device includes a carriage on which the cutter unit is mounted and which is moved in the width direction of the medium by the cutter unit driving mechanism, an inkjet head which is mounted on the carriage and which ejects ink onto the medium to perform printing, and a medium winding mechanism which rotates a winding core material to which an end portion on the conveyance direction downstream side of the medium is connected and winds the printed medium around the core material, printing of the medium by the inkjet head is performed before the linear cutting process, and in the linear cutting process, a portion of the medium on the conveyance direction upstream side of a portion where printing has been performed is cut.

In a medium cutting method of the present invention for cutting a medium in a medium cutting device including a cutter unit having a cutter blade for cutting a long medium, a processing mechanism for performing predetermined processing on the medium, a medium feeding mechanism for holding the medium before processing wound in a roll shape, a medium conveyance mechanism for conveying the medium in a longitudinal direction of the medium, and a cutter unit driving mechanism for moving the cutter unit in a width direction of the medium orthogonal to the longitudinal direction of the medium and a thickness direction of the medium, the medium cutting method includes: when, in a conveyance direction of the medium by the medium conveyance mechanism, a side on which the cutter blade is disposed with respect to the medium feeding mechanism is defined as a conveyance direction downstream side, and a side opposite to the conveyance direction downstream side is defined as a conveyance direction upstream side, a medium setting process of setting the medium wound in a roll shape in the medium feeding mechanism; a medium conveyance process of conveying the medium by a predetermined amount toward the conveyance direction downstream side after the medium setting process; and a convex cutting process of moving the cutter blade in the width direction of the medium and conveying the medium to cut the medium in an entire region in the width direction of the medium after the medium conveyance process. When the medium disposed on the conveyance direction upstream side from the cutting position of the medium in the convex cutting process is defined as a first upstream medium, an end surface of the first upstream medium on the conveyance direction downstream side has a trapezoidal shape or a triangular convex shape, the medium is not processed by the processing mechanism after the medium conveyance process and before the convex cutting process, and the medium is processed by the processing mechanism after the convex cutting process, and in the medium conveyance process, the medium is conveyed to a position where a predetermined interval is formed between the conveyance direction downstream end of the medium and the conveyance direction downstream end of the first upstream medium before the convex cutting process.

In the medium cutting method of the present invention, in the medium conveyance process after the medium setting process of setting the medium wound in a roll shape to the medium feeding mechanism and before the convex cutting process of moving the cutter blade in the width direction of the medium so that the end surface on the conveyance direction downstream side of the first upstream medium is in a trapezoidal shape or a triangular convex shape and conveying the medium to cut the medium in the entire region in the width direction of the medium, the medium is conveyed to the conveyance direction downstream side to a position where a predetermined interval is formed between the conveyance direction downstream end of the medium before the convex cutting process and the conveyance direction downstream end of the first upstream medium.

Thus, this makes it possible to increase the distance in the conveyance direction of the medium between the conveyance direction downstream end of the medium and the arrangement position of the cutter unit before the convex cutting process is performed. Therefore, even if the curling tendency of the medium becomes strong, the floating of the medium from the platen at the arrangement position of the cutter unit in the medium conveyance direction can be reduced when the convex cutting process is performed. As a result, even if the curling tendency of the medium becomes strong, one end portion in the longitudinal direction of the medium can be appropriately cut so that the end surface of the medium becomes a convex shape forming a trapezoidal shape or a triangular convex shape after the medium is replaced.

The medium cutting method of the present invention includes: a linear cutting process of moving the cutter blade in the width direction of the medium in a state where the medium is stopped to cut the medium in an entire region in the width direction of the medium. When the medium disposed on the conveyance direction upstream side of a cutting position of the medium in the linear cutting process is defined as a second upstream medium, an end surface of the second upstream medium on the conveyance direction downstream side is linear parallel to the width direction of the medium, the processing mechanism is a printing mechanism including an inkjet head that ejects ink onto the medium to perform printing, the medium cutting device includes a carriage on which the cutter unit and the inkjet head are mounted and which is moved in the width direction of the medium by the cutter unit driving mechanism, and a medium winding mechanism which rotates a winding core material to which an end portion on the conveyance direction downstream side of the medium is connected and winds the printed medium around the core material, the medium is printed by the inkjet head after the convex cutting process and before the linear cutting process, and in the linear cutting process, a portion of the medium on the conveyance direction upstream side of a portion where printing has been performed is cut.

In the present invention, it is preferable that the medium cutting device includes a platen which is disposed below the carriage and on which a part of the medium in the conveyance direction of the medium is placed, and in the medium conveyance process, the medium is conveyed to a position where a maximum distance in an up-down direction between a portion of the medium disposed on a lower side of the inkjet head in the convex cutting process and an upper surface of the platen is smaller than a distance in an up-down direction between a lower end surface of the inkjet head and the upper surface of the platen.

Thus, even if the curling tendency of the medium becomes strong, the contact between the inkjet head moving in the width direction of the medium and the medium can be reduced when the convex cutting process is performed. Therefore, even if the curling tendency of the medium becomes strong, one end portion in the longitudinal direction of the medium can be reliably cut so that the end surface of the medium becomes a convex shape forming a trapezoidal shape or a triangular convex shape. Furthermore, the contact between the medium and the inkjet head can be reduced.

In the present invention, it is preferable that, when one side in the width direction of the medium is a first direction side and a side opposite to the first direction side is a second direction side, the convex cutting process includes: a first thrusting process of thrusting the cutter blade into an end portion of the medium on the first direction side so as to penetrate the medium; a first oblique cutting process of cutting the medium at least in a direction inclined with respect to the width direction of the medium by relatively moving the cutter blade with respect to the medium toward the conveyance direction downstream side and the second direction side with a first thrusting spot as a starting point, which is a spot thrust by the cutter blade in the first thrusting process; a second thrusting process of thrusting the cutter blade into an end portion of the medium on the second direction side so as to penetrate the medium; a second oblique cutting process of cutting the medium at least in a direction inclined with respect to the width direction of the medium by relatively moving the cutter blade with respect to the medium toward the conveyance direction downstream side and the first direction side with a second thrusting spot as a starting point, which is a spot thrust by the cutter blade in the second thrusting process; a first lateral cutting process of, after the first oblique cutting process and the second oblique cutting process, moving the cutter blade in the first direction with respect to the medium with the first thrusting spot as a starting point to cut the medium in the width direction of the medium from the first thrusting spot to an end surface of the medium on the first direction side; and a second lateral cutting process of, after the first oblique cutting process and the second oblique cutting process, moving the cutter blade toward the second direction side with respect to the medium with the second thrusting spot as a starting point to cut the medium in the width direction of the medium from the second thrusting spot to an end surface on the second direction side of the medium.

Thus, the first lateral cutting process and the second lateral cutting process are performed after the first oblique cutting process and the second oblique cutting process. Therefore, even when the first oblique cutting process and the second oblique cutting process are completed, the medium is not completely cut in the width direction of the medium, and the medium on the conveyance direction upstream side and the medium on the conveyance direction downstream side are connected on both sides in the width direction of the medium. Therefore, during the first oblique cutting process and the second oblique cutting process, for example, the medium on the conveyance direction downstream side can be reduced from being torn by gravity acting on the medium on the conveyance direction downstream side.

In the present invention, it is preferable that the medium cutting device includes a carriage on which the cutter unit is mounted and which is moved in the width direction of the medium by the cutter unit driving mechanism, and an inkjet head which is mounted on the carriage and which ejects ink onto the medium to perform printing, the inkjet head is disposed on the second direction side of the cutter unit, and the second lateral cutting process is performed before the first lateral cutting process.

Thus, the first lateral cutting process is performed after the second lateral cutting process. In this case, during the first lateral cutting process, for example, the medium on the conveyance direction downstream side may be torn and dropped by gravity acting on the medium on the conveyance direction downstream side, but the medium on the conveyance direction downstream side that is torn and dropped falls while moving toward the first direction side. Thus, the contact between the inkjet head disposed on the second direction side of the cutter unit and the medium that is torn and dropped can be reduced. Therefore, it is possible to reduce the contact between the medium that has been torn and dropped and the inkjet head.

In the present invention, it is preferable that the medium cutting device includes a carriage on which the cutter unit is mounted and which is moved in the width direction of the medium by the cutter unit driving mechanism, the cutter unit includes a cutter blade moving mechanism that moves the cutter blade between a retreating position where the cutter blade is not in contact with the medium and a cuttable position where the medium can be cut by the cutter blade, the second lateral cutting process is performed before the first lateral cutting process, the convex cutting process includes: a cutter blade retreating process of moving the cutter blade disposed at the cuttable position to the retreating position after the second lateral cutting process; a third medium conveyance process of conveying the medium by a predetermined amount toward a conveyance direction downstream side after the second lateral cutting process; a carriage moving process of moving the carriage toward the first direction side until a blade edge of the cutter blade is disposed at a same position as the first thrusting spot in the width direction of the medium after the cutter blade retreating process and the third medium conveyance process; a fourth medium conveyance process of conveying the medium toward the conveyance direction upstream side until a blade edge of the cutter blade is disposed at a same position as the first thrusting spot in the conveyance direction of the medium after the carriage moving process; and a cutter blade arrangement process of moving the cutter blade disposed at the retreating position to the cuttable position after the fourth medium conveyance process, and the first lateral cutting process is performed after the cutter blade arrangement process.

Here, if the curling tendency of the medium becomes stronger, the floating of the portion of the first upstream medium on the conveyance direction downstream side may increase even before the first lateral cutting process is performed after the second lateral cutting process. As a result, after the second lateral cutting process, the carriage moving toward the first direction side for performing the first lateral cutting process and various configurations mounted on the carriage may come into contact with a portion of the first upstream medium on the conveyance direction downstream side, which may interfere with the movement of the carriage.

Therefore, in the present invention, the medium is conveyed by a predetermined amount toward the conveyance direction downstream side in the third medium conveyance process, and then the carriage is moved to the first direction side in the carriage moving process. Thus, even if the curling tendency of the medium becomes stronger, the carriage moving toward the first direction side for performing the first lateral cutting process can be moved without any trouble after the second lateral cutting process.

In the present invention, the medium cutting device may include a carriage on which the cutter unit is mounted and which is moved in the width direction of the medium by the cutter unit driving mechanism, the cutter unit may include a cutter blade moving mechanism that moves the cutter blade between a retreating position where the cutter blade is not in contact with the medium and a cuttable position where the medium can be cut by the cutter blade, the first lateral cutting process may be performed before the second lateral cutting process, the convex cutting process may include: a cutter blade retreating process of moving the cutter blade disposed at the cuttable position to the retreating position after the first lateral cutting process; a third medium conveyance process of conveying the medium by a predetermined amount toward a conveyance direction downstream side after the first lateral cutting process; a carriage moving process of moving the carriage toward the second direction side until a blade edge of the cutter blade is disposed at a same position as the second thrusting spot in the width direction of the medium after the cutter blade retreating process and the third medium conveyance process; a fourth medium conveyance process of conveying the medium toward the conveyance direction upstream side until a blade edge of the cutter blade is disposed at a same position as the second thrusting spot in the conveyance direction of the medium after the carriage moving process; and a cutter blade arrangement process of moving the cutter blade disposed at the retreating position to the cuttable position after the fourth medium conveyance process, and the second lateral cutting process may be performed after the cutter blade arrangement process.

If the curling tendency of the medium becomes stronger, the floating of the portion of the first upstream medium on the conveyance direction downstream side may increase even before the second lateral cutting process is performed after the first lateral cutting process. As a result, after the first lateral cutting process, the carriage moving toward the second direction side for performing the second lateral cutting process and various configurations mounted on the carriage may come into contact with a portion of the first upstream medium on the conveyance direction downstream side, which may interfere with the movement of the carriage.

Therefore, in the present invention, the medium is conveyed by a predetermined amount toward the conveyance direction downstream side in the third medium conveyance process, and then the carriage is moved to the second direction side in the carriage moving process. Thus, even if the curling tendency of the medium becomes stronger, the carriage moving toward the second direction side for performing the second lateral cutting process can be moved without any trouble after the first lateral cutting process.

The medium cutting method of the present invention includes: a standby position moving process of moving the cutter unit to a predetermined standby position after the convex cutting process. It is preferable that the cutter unit includes a cutter blade moving mechanism that moves the cutter blade between a retreating position where the cutter blade is not in contact with the medium and a cuttable position where the medium can be cut by the cutter blade, the second lateral cutting process is performed before the first lateral cutting process, the cutter unit disposed at the standby position is disposed on the second direction side with respect to the medium, the cutter blade is disposed on the first direction side with respect to the medium when the first lateral cutting process is completed, and the standby position moving process includes: a cutter blade retreating process of moving the cutter blade disposed at the cuttable position to the retreating position after the first lateral cutting process; a fifth medium conveyance process of conveying the medium by a predetermined amount toward the conveyance direction downstream side after the first lateral cutting process; and a cutter unit moving process of moving the cutter unit to the standby position after the cutter blade retreating process and the fifth medium conveyance process.

When the convex cutting process is completed (specifically, when the first lateral cutting process is completed), the end portion of the first upstream medium of the conveyance direction downstream side and the first direction side may be turned up. Therefore, if the cutter unit is moved as it is to the standby position with the cutter blade moved to the retreating position after the first lateral cutting process is completed, the cutter unit may come into contact with the turned-up portion of the first upstream medium, which may interfere with the movement of the cutter unit.

Therefore, in the present invention, the medium is conveyed by a predetermined amount toward the conveyance direction downstream side in the fifth medium conveyance process, and then the cutter unit is moved to the standby position in the cutter unit moving process. Thus, even if the end portion of the first upstream medium on the conveyance direction downstream side and on the first direction side is turned up, the cutter unit moving to the standby position can be moved without any trouble after the convex cutting process.

In the present invention, it is preferable that the medium cutting device includes a platen on which a part of the medium in the conveyance direction of the medium is placed, a first medium guide that presses an end portion of the medium placed on the platen on the first direction side from above, and a second medium guide that presses an end portion of the medium placed on the platen on the second direction side from above, the conveyance direction downstream end of the first medium guide and the conveyance direction downstream end of the second medium guide are disposed on the conveyance direction upstream side of a blade edge of the cutter blade, the conveyance direction upstream end of the first medium guide is disposed on the conveyance direction upstream side of the first thrusting spot when the first oblique cutting process is completed, and the conveyance direction upstream end of the second medium guide is disposed on the conveyance direction upstream side of the second thrusting spot when the second oblique cutting process is completed.

Thus, when the medium is conveyed toward the conveyance direction downstream side after the first oblique cutting process and before the second thrusting process, it is possible to reduce the portion of the medium cut in the first oblique cutting process from being caught by the conveyance direction upstream end of the first medium guide.

Thus, when the medium is conveyed toward the conveyance direction downstream side after the second oblique cutting process and before the first lateral cutting process and the second lateral cutting process, it is possible to reduce the portion of the medium cut in the second oblique cutting process from being caught by the conveyance direction upstream end of the second medium guide. Therefore, the medium can be appropriately conveyed.

In the present invention, preferably, the cutter unit includes a cutter holder to which the cutter blade is fixed, and a unit frame that rotatably holds the cutter holder, the cutter holder is rotatable with respect to the unit frame with the thickness direction of the medium as an axial direction of rotation, in the first oblique cutting process and the second oblique cutting process, the cutter blade is rotatable with respect to the unit frame, and a cutting angle of the medium with respect to the width direction of the medium in the first oblique cutting process and a cutting angle of the medium with respect to the width direction of the medium in the second oblique cutting process are constant regardless of a width of the medium.

This makes it possible to make the rotation angle of the cutter holder with respect to the unit frame constant in the first oblique cutting process and the second oblique cutting process regardless of the width of the medium. Therefore, in the first oblique cutting process and the second oblique cutting process, it is possible to reduce excessive rotation of the cutter holder with respect to the unit frame.

The medium cutting method of the present invention includes: a second linear cutting process of moving the cutter blade in the width direction of the medium in a state where the medium is stopped to cut the medium in an entire region in the width direction of the medium; and a second medium conveyance process of conveying the medium by a predetermined amount toward the conveyance direction downstream side after the second linear cutting process. The linear cutting process is performed after the second medium conveyance process.

Assuming that a medium disposed on the conveyance direction downstream side of a cutting position in the linear cutting process of the medium cut by the medium cutting method is defined as a downstream medium, and an end portion of the downstream medium in the width direction of the medium at the time of completion of the linear cutting process is defined as a downstream medium end portion, it is preferable to connect the end portion on the conveyance direction downstream side of the medium using the downstream medium as a winding core material to which the end portion on the conveyance direction downstream side of the medium is connected. In this medium end connection method, one downstream medium end portion is fixed to the end portion on the conveyance direction downstream side of the medium, the other downstream medium end portion is fixed to the core material, and the end portion on the conveyance direction downstream side in the medium conveyance direction is connected to the core material.

For example, in a case where a distance between a processing mechanism for performing predetermined processing on a medium such as a printing mechanism that performs printing processing on the medium and the core material of the winding roll in the conveyance direction of the medium is long, when an end portion (one end portion in the longitudinal direction) on the conveyance direction downstream side of the medium is directly fixed to the core material of the winding roll with a tape or the like, a portion where processing by the processing mechanism cannot be performed between a portion of the medium fixed to the core material and a portion disposed in the vicinity of the processing mechanism becomes long, and thus loss occurs in the medium.

Therefore, in the present invention, the end portion on the conveyance direction downstream side of the medium is connected to the core material. As a result, even if the distance between the processing mechanism and the core material in the conveyance direction of the medium is long, the end portion on the conveyance direction downstream side of the medium disposed in the vicinity of the processing mechanism and the core material can be connected by the downstream medium. Therefore, it is possible to process the medium with a small loss. Therefore, even if the distance between the processing mechanism and the core material in the conveyance direction of the medium is long, the loss of the medium can be reduced.

In a control method of a medium cutting device including a cutter unit having a cutter blade for cutting a long medium, a medium feeding mechanism for holding the medium wound in a roll shape, a medium conveyance mechanism for conveying the medium in a longitudinal direction of the medium, and a cutter unit driving mechanism for moving the cutter unit in a width direction of the medium orthogonal to the longitudinal direction of the medium and a thickness direction of the medium, the control method of the present invention includes: when, in a conveyance direction of the medium by the medium conveyance mechanism, a side on which the cutter blade is disposed with respect to the medium feeding mechanism is defined as a conveyance direction downstream side, and a side opposite to the conveyance direction downstream side is defined as a conveyance direction upstream side, a linear cutting step of moving, by the cutter unit driving mechanism, the cutter blade in the width direction of the medium in a state where the medium is stopped to cut the medium in an entire region in the width direction of the medium; a medium conveyance step of conveying, by the medium conveyance mechanism, the medium by a predetermined amount toward the conveyance direction downstream side after the linear cutting step; and a convex cutting step of moving, by the cutter unit driving mechanism, the cutter blade in the width direction of the medium and conveying the medium by the medium conveyance mechanism to cut the medium in an entire region in the width direction of the medium after the medium conveyance step. When the medium disposed on the conveyance direction upstream side of the cutting position of the medium in the convex cutting step is defined as a first upstream medium, and the medium disposed on the conveyance direction upstream side of the cutting position of the medium in the linear cutting step is defined as a second upstream medium, an end surface of the second upstream medium on the conveyance direction downstream side is linear parallel to the width direction of the medium, an end surface of the first upstream medium on the conveyance direction downstream side has a trapezoidal shape or a triangular convex shape, and in the medium conveyance step, the medium is conveyed to a position where a predetermined interval is formed between the conveyance direction downstream end of the second upstream medium and the conveyance direction downstream end of the first upstream medium.

In the control method of the medium cutting device of the present invention, in the medium conveyance step after the linear cutting step of moving the cutter blade in the width direction of the medium to cut the medium in the entire region in the width direction of the medium in a state where the medium is stopped so that the end surface on the conveyance direction downstream side of the second upstream medium is linear parallel to the width direction of the medium, and before the convex cutting step of moving the cutter blade in the width direction of the medium so that the end surface on the conveyance direction downstream side of the first upstream medium is in a trapezoidal shape or a triangular convex shape and conveying the medium to cut the medium in the entire region in the width direction of the medium, the medium is conveyed to the conveyance direction downstream side to a position where a predetermined interval is formed between the conveyance direction downstream end of the second upstream medium and the conveyance direction downstream end of the first upstream medium.

Thus, this makes it possible to increase the distance in the conveyance direction of the medium between the end surface of the second upstream medium on the conveyance direction downstream side and the arrangement position of the cutter unit before the convex cutting step is performed. Therefore, even if the curling tendency of the medium becomes strong, the floating of the medium from the platen at the arrangement position of the cutter unit in the medium conveyance direction can be reduced when the convex cutting step is performed. As a result, even if the curling tendency of the medium becomes strong, one end portion in the longitudinal direction of the medium can be appropriately cut so that the end surface of the medium becomes a convex shape forming a trapezoidal shape or a triangular convex shape after the medium is cut in a straight line parallel to the width direction over the entire region in the width direction before the medium is replaced.

In a control method of a medium cutting device including a cutter unit having a cutter blade for cutting a long medium, a processing mechanism for performing predetermined processing on the medium, a medium feeding mechanism for holding the medium before processing wound in a roll shape, a medium conveyance mechanism for conveying the medium in a longitudinal direction of the medium, and a cutter unit driving mechanism for moving the cutter unit in a width direction of the medium orthogonal to the longitudinal direction of the medium and a thickness direction of the medium, the control method of the present invention includes: when, in a conveyance direction of the medium by the medium conveyance mechanism, a side on which the cutter blade is disposed with respect to the medium feeding mechanism is defined as a conveyance direction downstream side, and a side opposite to the conveyance direction downstream side is defined as a conveyance direction upstream side, a medium conveyance step of conveying the medium by a predetermined amount toward the conveyance direction downstream side by the medium conveyance mechanism after the medium wound in a roll shape is set in the medium feeding mechanism; and a convex cutting step of moving the cutter blade in the width direction of the medium by the cutter unit driving mechanism and conveying the medium by the medium conveyance mechanism to cut the medium in an entire region in the width direction of the medium after the medium conveyance step. When the medium disposed on the conveyance direction upstream side from the cutting position of the medium in the convex cutting step is defined as a first upstream medium. An end surface of the first upstream medium on the conveyance direction downstream side has a trapezoidal shape or a triangular convex shape. The medium is not processed by the processing mechanism after the medium conveyance step and before the convex cutting step, and the medium is processed by the processing mechanism after the convex cutting step. In the medium conveyance step, the medium is conveyed to a position where a predetermined interval is formed between the conveyance direction downstream end of the medium and the conveyance direction downstream end of the first upstream medium before the convex cutting step.

In the control method of the medium cutting device of the present invention, after the medium wound in a roll shape is set in the medium feeding mechanism, in the medium conveyance step before the convex cutting step of moving the cutter blade in the width direction of the medium so that the end surface on the conveyance direction downstream side of the first upstream medium becomes a trapezoidal shape or a triangular convex shape and conveying the medium to cut the medium in the entire region in the width direction of the medium, the medium is conveyed toward the conveyance direction downstream side to a position where a predetermined interval is formed between the conveyance direction downstream end of the medium before the convex cutting step and the conveyance direction downstream end of the first upstream medium.

Thus, this makes it possible to increase the distance in the conveyance direction of the medium between the conveyance direction downstream end of the medium and the arrangement position of the cutter unit before the convex cutting step is performed. Therefore, even if the curling tendency of the medium becomes strong, the floating of the medium from the platen at the arrangement position of the cutter unit in the medium conveyance direction can be reduced when the convex cutting step is performed. As a result, even if the curling tendency of the medium becomes strong, one end portion in the longitudinal direction of the medium can be appropriately cut so that the end surface of the medium becomes a convex shape forming a trapezoidal shape or a triangular convex shape after the medium is replaced.

### Effect of the Invention

According to the present invention, the shape of the cut portion can be stabilized regardless of the characteristics of the medium.

### BRIEF DESCRIPTION OF THE DRAWINGS

FIG. 1 is a diagram for explaining a medium cutting device.

FIG. 2 is a block diagram for explaining a configuration of the medium cutting device.

FIG. 3 is a diagram for explaining a medium in a state of being fixed to a paper tube.

FIG. 4 is a perspective view of a cutter unit.

FIG. 5 is a side view of a distal end portion of a cutter blade included in the cutter unit.

FIG. 6 is a side view for explaining the cutter unit.

FIG. 7 is a plan view for explaining the cutter unit.

FIG. 8 is a flowchart for explaining a medium cutting procedure.

FIG. 9 is a diagram for explaining a medium cutting method.

FIG. 10 is a diagram for explaining a medium cutting method.

FIG. 11 is a diagram for explaining a medium in a state of being fixed to a paper tube in a medium cutting device according to a first modification.

FIG. 12 is a diagram for explaining a periphery of a carriage of the medium cutting device according to the first modification.

FIG. 13 is an enlarged view of a main part of the medium cutting device according to the first modification.

FIG. 14 is a flowchart for explaining a medium cutting procedure according to the first modification.

FIG. 15 is a diagram for explaining a medium cutting method according to the first modification.

FIG. 16 is a diagram for explaining a medium cutting method according to the first modification.

FIG. 17 is a diagram for explaining a medium cutting method according to the first modification.

FIG. 18 is a flowchart for explaining a medium cutting procedure according to a second modification.

FIG. 19 is a flowchart for explaining a medium cutting procedure according to a third modification.

FIG. 20 is a diagram for explaining a medium cutting method according to the third modification.

FIG. 21 is a diagram for explaining fixing of a paper tube and a medium in the third modification.

FIG. 22 is a flowchart for explaining a convex cutting process according to a fourth modification.

FIG. 23 is a diagram for explaining a convex cutting process according to the fourth modification.

FIG. 24 is a diagram for explaining a convex cutting process according to the fourth modification.

FIG. 25 is a flowchart for explaining a medium cutting method according to a fifth modification.

FIG. 26 is a diagram for explaining a medium cutting method according to the fifth modification.

Hereinafter, embodiments of the present invention will be described with reference to the drawings.

### (Overall Configuration of Printing Apparatus)

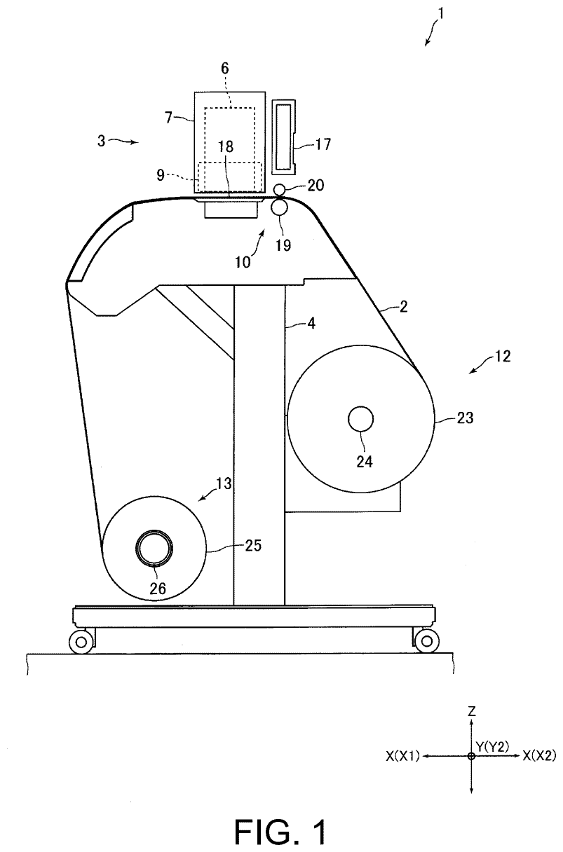

FIG. 1 is a diagram for explaining a configuration of a printing apparatus 1 according to an example embodiment. FIG. 1 is a side view of the printing apparatus 1.

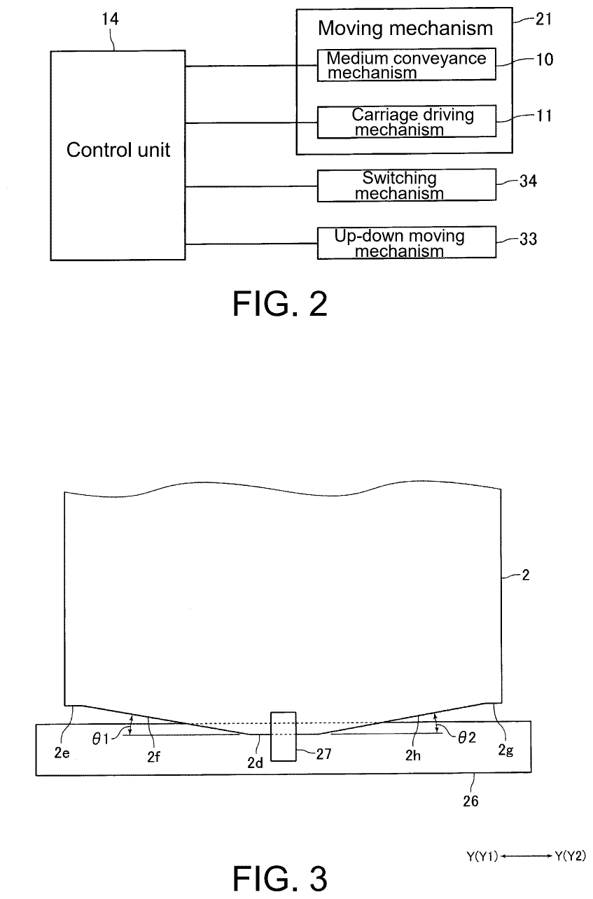

FIG. 2 is a block diagram for explaining a configuration of the printing apparatus 1.

FIG. 3 is a diagram for explaining a medium 2 in a state of being fixed to a paper tube 26.

As illustrated in FIG. 1, the printing apparatus 1 is a business inkjet printer for performing printing on a long medium 2. The medium 2 is made of soft polyvinyl chloride or tarpaulin. The printing apparatus 1 includes a printing mechanism 3 that performs printing on the medium 2 by an inkjet method, and a support body 4 that supports the printing mechanism 3 from below. The printing mechanism 3 includes an inkjet head 6 (hereinafter, referred to as a “head 6”) that ejects ink onto the medium 2, and a carriage 7 on which the head 6 is mounted.

Here, the printing apparatus 1 has a cutting function for cutting the medium 2 and separating the medium 2 in the longitudinal direction of the medium 2 after the printing is completed. Therefore, the printing apparatus 1 according to the present example embodiment also functions as a medium cutting device for cutting the long medium 2.

Further, the printing mechanism 3 performs printing on the medium 2 as one aspect of processing. That is, the printing mechanism 3 constitutes a processing mechanism. In the present example embodiment, the processing of the medium 2 by the printing mechanism 3 does not include cutting of the medium 2.

As illustrated in FIG. 1, the printing apparatus 1 includes a cutter unit 9 having a cutter blade 8 (see FIG. 5 and the like) for cutting the medium 2, a medium conveyance mechanism 10 for conveying the medium 2 in a longitudinal direction of the medium 2, a carriage driving mechanism 11 (see FIG. 2) for moving the carriage 7 in a width direction of the medium 2 (main scanning direction, Y direction in FIG. 1 and the like), a medium feeding mechanism 12 for feeding the medium 2 before printing toward the printing mechanism 3, and a medium winding mechanism 13 for winding the medium 2 after printing. Furthermore, the printing apparatus 1 includes a control unit 14 that controls the printing apparatus 1.

In the following description, a width direction (Y direction in FIG. 1 and the like) of the medium 2 when the printing apparatus 1 is viewed from the front is referred to as a “left-right direction”. In addition, a direction in a state where the printing apparatus 1 is installed is referred to as an up-down direction (Z direction of FIG. 1 and the like). In addition, a direction (X direction in FIG. 1 and the like) orthogonal to the up-down direction and the left-right direction is referred to as a “front-rear direction”. In addition, the Y1 direction side in FIG. 3 and the like, which is one side in the left-right direction, is referred to as a “left” side, and the Y2 direction side in FIG. 3 and the like, which is the opposite side, is referred to as a “right” side. An X1 direction side in FIG. 1 and the like, which is one side in the front-rear direction, is referred to as a “front” side, and an X2 direction side in FIG. 1 and the like, which is the opposite side, is referred to as a “rear” side. In the following description, a conveyance direction of the medium 2 by the medium conveyance mechanism 10 is referred to as a “medium conveyance direction”. The upstream side in the medium conveyance direction is referred to as “conveyance direction upstream side”, and the downstream side in the medium conveyance direction is referred to as “conveyance direction downstream side”. As illustrated in FIG. 3, the left side (Y1 direction side) of the medium 2 is a first direction side which is one side in the width direction of the medium 2, and the right side (Y2 direction side) is a second direction side which is the other side in the width direction of the medium 2.

The carriage 7 is supported by a support frame 17 so as to be movable in the left-right direction. A platen 18 is disposed below the carriage 7. That is, the printing apparatus 1 includes the platen 18 disposed below the carriage 7. The head 6 ejects ink downward. A plurality of nozzles for ejecting ink is formed on a lower end surface of the head 6. The lower end surface of the head 6 is disposed below the lower end surface of the carriage 7. The carriage driving mechanism 11 includes, for example, a belt partially fixed to the carriage 7, a pulley around which the belt is stretched, and a motor for rotating the pulley.

The upper surface of the platen 18 is a plane orthogonal to the up-down direction. A part of the medium 2 in the medium conveyance direction is placed on the platen 18. A portion of the medium 2 on which printing is performed by the head 6 is placed on the platen 18. The thickness direction of the medium 2 placed on the platen 18 substantially coincides with the up-down direction. The medium 2 before printing is conveyed from the rear side to the upper surface of the platen 18, and the medium 2 after printing is conveyed from the upper surface of the platen 18 to the front side.

The medium conveyance mechanism 10 includes a conveyance roller 19 and a pad roller 20 that is disposed to face the conveyance roller 19 and is biased toward the conveyance roller 19. The conveyance roller 19 and the pad roller 20 are disposed on the conveyance direction upstream side of the platen 18. The conveyance roller 19 and the pad roller 20 are disposed conveyance direction upstream side of the head 6 and the cutter blade 8. The conveyance roller 19 is connected to a drive mechanism that rotates the conveyance roller 19. The drive mechanism includes a motor as a drive source. The medium 2 is conveyed while being interposed between the conveyance roller 19 and the pad roller 20.

The cutter unit 9 is mounted on the carriage 7. The cutter unit 9 is disposed above the platen 18 with the medium 2 interposed therebetween. The cutter unit 9 is mounted on the left end portion of the carriage 7 (the back side of the drawing in FIG. 1). The cutter unit 9 may be mounted on the right end portion of the carriage 7.

The cutter unit 9 moves in the left-right direction together with the carriage 7. The carriage driving mechanism 11 moves the cutter unit 9 and the carriage 7 in the left-right direction, which is the width direction of the medium 2. That is, the carriage drive function 11 also functions as a cutter unit driving mechanism.

In the present example embodiment, the medium conveyance mechanism 10 and the carriage driving mechanism 11 constitute a moving mechanism 21. The moving mechanism 21 moves the cutter unit 9 relatively to the medium 2 in the longitudinal direction of the medium 2 and the width direction of the medium 2. A specific configuration of the cutter unit 9 will be described later.

The medium feeding mechanism 12 is disposed below the printing mechanism 3. The medium feeding mechanism 12 rotatably holds a feed roll 23. The feed roll 23 includes a cylindrical paper tube 24 constituting a core material of the feed roll 23, and the medium 2 before printing wound in a roll shape around the paper tube 24. An end portion of the medium 2 is fixed to the paper tube 24. Specifically, an end portion on the conveyance direction upstream side of the medium 2 is fixed to the paper tube 24. The medium feeding mechanism 12 includes a rotation shaft (not illustrated) inserted through the inner peripheral side of the paper tube 24. The core material of the feed roll 23 is not limited to the paper tube 24. For example, the cylindrical member may be made of resin or metal.

The medium winding mechanism 13 is disposed below the printing mechanism 3. The medium winding mechanism 13 rotatably holds a winding roll 25. The winding roll 25 includes a cylindrical paper tube 26 constituting a core material of the winding roll 25 and a medium 2 after printing wound in a roll shape around the paper tube 26. The outer diameter of the paper tube 26 is 3 inches or 2 inches. The end portion of the medium 2 is fixed to the paper tube 26. Specifically, the end portion on the conveyance direction downstream side of the medium 2 is fixed to the paper tube 26. The end portion on the conveyance direction downstream side of the medium 2 is fixed to the paper tube 26 by, for example, a tape 27. The core material of the winding roll 25 is not limited to the paper tube 26. For example, the cylindrical member may be made of resin or metal.

The medium winding mechanism 13 includes a rotation shaft (not illustrated) inserted through the inner peripheral side of the paper tube 26, and a drive mechanism (not illustrated) that rotates the rotation shaft. The medium winding mechanism 13 rotates the winding paper tube 26 to which the end portion of the medium 2 is fixed to wind the medium 2 around the paper tube 26.

The medium winding mechanism 13 includes a torque limiter for idling the winding roll 25 so that the tension of the medium 2 applied when being wound around the winding roll 25 does not exceed a predetermined value.

The medium conveyance mechanism 10 is electrically connected to the control unit 14. Specifically, a motor or the like constituting a part of the medium conveyance mechanism 10 is electrically connected to the control unit 14. The carriage driving mechanism 11 is electrically connected to the control unit 14. Specifically, a motor or the like constituting a part of the carriage driving mechanism 11 is electrically connected to the control unit 14. Further, an up-down moving mechanism 33 and a switching mechanism 34, which will be described later and constitute a part of the cutter unit 9, are electrically connected to the control unit 14. Specifically, a solenoid 37 to be described later constituting a part of the up-down moving mechanism 33 and a solenoid 43 to be described later constituting a part of the switching mechanism 34 are electrically connected to the control unit 14.

### (Configuration of Cutter Unit)

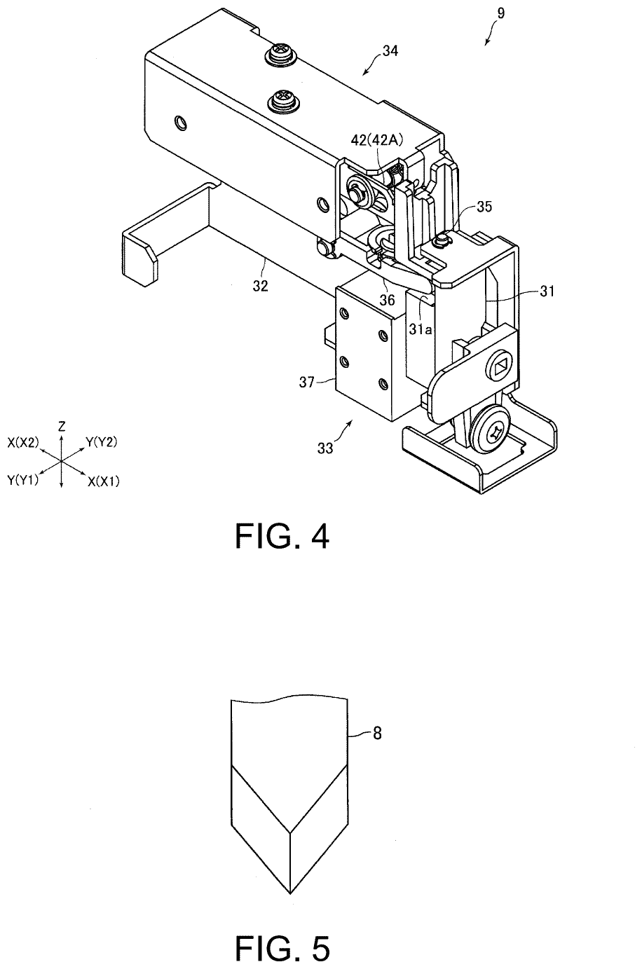

FIG. 4 is a perspective view of the cutter unit 9. In FIG. 4, the cutter blade 8 is not illustrated.

FIG. 5 is a side view of a distal end portion of the cutter blade 8 in the cutter unit 9.

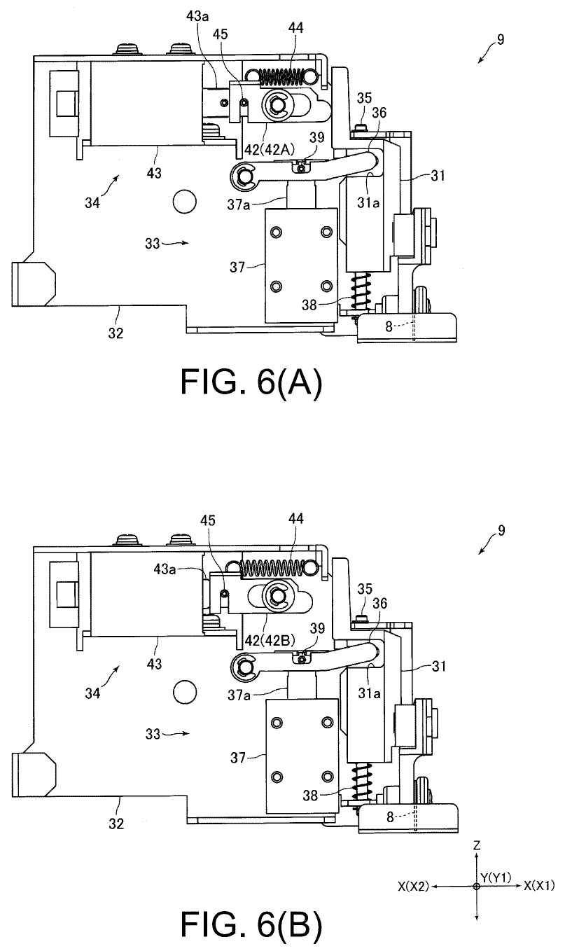

FIG. 6 is a diagram for explaining the cutter unit 9. FIG. 6 is a diagram of the cutter unit 9 as viewed from the Y2 direction in FIG. 4.

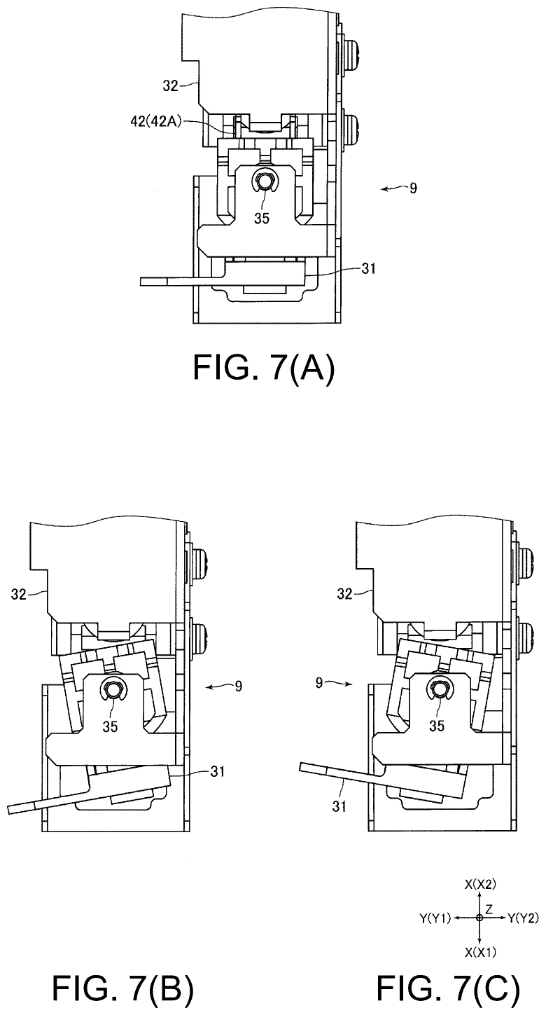

FIG. 7 is a diagram for explaining the cutter unit 9. FIG. 7 is a diagram of the cutter unit 9 as viewed from the upper side in the Z direction.

As illustrated in FIG. 6, the cutter unit 9 includes a cutter holder 31 to which the cutter blade 8 is fixed, and a unit frame 32 that rotatably holds the cutter holder 31. The cutter blade 8 cuts the medium 2 placed on the platen 18. The cutter holder 31 is rotatable with respect to the unit frame 32 with the thickness direction of the medium 2 placed on the platen 18 as an axial direction of rotation. That is, the cutter holder 31 is rotatable with respect to the unit frame 32 with the thickness direction of the medium 2 cut by the cutter blade 8 as an axial direction of rotation. Specifically, the cutter holder 31 is rotatable with respect to the unit frame 32 with the up-down direction as an axial direction of rotation.

The unit frame 32 holds the cutter holder 31 so as to be movable up and down. The cutter holder 31 is movable up and down with respect to the unit frame 32. The cutter unit 9 includes the up-down moving mechanism 33 that lifts and lowers the cutter holder 31 with respect to the unit frame 32. In addition, the cutter unit 9 includes the switching mechanism 34 that switches the state of the cutter holder 31 between a rotation regulating state in which the rotation of the cutter holder 31 with respect to the unit frame 32 is regulated and a rotatable state in which the cutter holder 31 can be rotated with respect to the unit frame 32.

As illustrated in FIG. 5, the cutter blade 8 is a double-edged cutter blade having a sharp edge.

As illustrated in FIG. 4, the cutter holder 31 is attached to the front end portion of the unit frame 32 so as to be movable up and down and rotatable. The cutter blade 8 is fixed to a front lower end portion of the cutter holder 31. When the cutter holder 31 is in the rotation regulating state, the thickness direction of the cutter blade 8 coincides with the front-rear direction, and the width direction of the cutter blade 8 coincides with the left-right direction. The cutter blade 8 may be a single-edged cutter blade.

The unit frame 32 is fixed to the carriage 7 (see FIG. 1). A guide shaft 35 for guiding the cutter holder 31 in the up-down direction is fixed to the unit frame 32. The guide shaft 35 is disposed such that the axial direction of the guide shaft 35 coincides with the up-down direction. A guide hole through which the guide shaft 35 is inserted is formed in the cutter holder 31, and the guide hole penetrates the cutter holder 31 in the up-down direction. The guide shaft 35 is a rotation center of the cutter holder 31 that rotates with respect to the unit frame 32 with the up-down direction as an axial direction of rotation.

As illustrated in FIG. 6(A), the up-down moving mechanism 33 includes a lever member 36 rotatably held by the unit frame 32, a solenoid 37 for rotating the lever member 36 with respect to the unit frame 32, and a compression coil spring 38 for biasing the cutter holder 31 upward with respect to the unit frame 32. The lever member 36 is rotatable with respect to the unit frame 32 with the left-right direction as an axial direction of rotation. The rear end portion of the lever member 36 is rotatably held by the unit frame 32. The front end portion of the lever member 36 is engaged with the cutter holder 31. An engagement recess 31a into which the front end portion of the lever member 36 is inserted and engaged is formed in the cutter holder 31.

The solenoid 37 is fixed to the unit frame 32 such that a plunger 37a of the solenoid 37 protrudes upward. An engagement pin 39 that engages with an intermediate portion of the lever member 36 in the front-rear direction is fixed to the upper end portion of the plunger 37a. The guide shaft 35 is inserted through the compression coil spring 38. The upper end of the compression coil spring 38 is in contact with the cutter holder 31, and a lower end of the compression coil spring 38 is in contact with the unit frame 32.

When the solenoid 37 is in the non-energized state, the cutter holder 31 is raised by the biasing force of the compression coil spring 38. When the cutter holder 31 is raised by the biasing force of the compression coil spring 38, the lower end of the cutter blade 8 is raised to a position not in contact with the medium 2 placed on the platen 18. When the solenoid 37 is in the energized state, the plunger 37a descends, the lever member 36 rotates in a direction in which the front end of the lever member 36 descends, and the cutter holder 31 descends. When the cutter holder 31 descends, the medium 2 can be cut by the cutter blade 8. That is, when cutting the medium 2 with the cutter blade 8, the solenoid 37 is in the energized state.

As illustrated in FIGS. 6(A) and 6(B), the switching mechanism 34 includes a regulation member 42 for regulating the rotation of the cutter holder 31 with the up-down direction as an axial direction of rotation. The regulation member 42 is held by the unit frame 32 so as to be movable in the front-rear direction. The regulation member 42 is disposed on the rear side of the upper end portion of the cutter holder 31. The surface of the cutter holder 31 facing the regulation member 42 is a flat surface. The portion of the regulation member 42 facing the cutter holder 31 is a semicircular arcuate curved surface bulging toward the cutter holder 31.

In addition, the switching mechanism 34 includes the solenoid 43 as a drive source for moving the regulation member 42 to a regulation position 42A (see FIG. 6(A)) where the regulation member 42 approaches the cutter holder 31 and a regulation release position 42B (see FIG. 6(B)) where the regulation member 42 moves away from the cutter holder 31. That is, the switching mechanism 34 includes the solenoid 43 for moving the regulation member 42 in the front-rear direction with respect to the unit frame 32. The switching mechanism 34 further includes a tension coil spring 44 that biases the regulation member 42 toward the front side with respect to the unit frame 32.

The solenoid 43 is fixed to the unit frame 32 such that a plunger 43a of the solenoid 43 protrudes forward. An engagement pin 45 that engages with the rear end portion of the regulation member 42 is fixed to the front end portion of the plunger 43a. The front end portion of the tension coil spring 44 is attached to the unit frame 32, and the rear end portion of the tension coil spring 44 is attached to the rear end portion of the regulation member 42. When the solenoid 43 is in the non-energized state, the regulation member 42 is disposed at the regulation position 42A by the biasing force of the tension coil spring 44. When the solenoid 43 is in the energized state, the plunger 43a moves toward the rear side and the regulation member 42 moves toward the rear side, so that the regulation member 42 is disposed at the regulation release position 42B.

As illustrated in FIG. 6(A), in a state where the regulation member 42 is disposed at the regulation position 42A, the regulation member 42 and the cutter holder 31 are in contact with each other, or a slight gap is formed. Therefore, when the regulation member 42 is disposed at the regulation position 42A, the cutter holder 31 is in the rotation regulating state in which the rotation of the cutter holder 31 with respect to the unit frame 32 is regulated.

On the other hand, as illustrated in FIG. 6(B), a large gap is formed between the regulation member 42 and the cutter holder 31 in a state where the regulation member 42 is disposed at the regulation release position 42B. Therefore, when the regulation member 42 is disposed at the regulation release position 42B, the cutter holder 31 is in a rotatable state in which the cutter holder 31 can rotate with respect to the unit frame 32.

When the cutter holder 31 enters the rotatable state, the rotation of the cutter holder 31 in a direction of the counterclockwise turning of FIG. 7 (hereinafter, referred to as “counterclockwise direction”) as illustrated in FIG. 7(B), and the rotation of the cutter holder 31 in a direction of the clockwise turning of FIG. 7 (hereinafter, referred to as “clockwise direction”) as illustrated in FIG. 7(C) are possible.

Although not illustrated, the cutter unit 9 may include a rotation range regulation member that regulates the rotation range (rotation angle) of the cutter holder 31 in the rotatable state. The rotation range regulation member is fixed to the unit frame 32. The rotation range regulation member can be brought into contact with the rear surface of the cutter holder 31, and regulates the rotation range of the cutter holder 31 in the clockwise direction and the rotation range of the cutter holder 31 in the counterclockwise direction. The rotation range regulation member regulates the maximum rotation angle in the clockwise direction and the maximum rotation angle in the counterclockwise direction of the cutter holder 31 to about 15° when the thickness direction of the cutter blade 8 coincides with the front-rear direction, for example.

### (Medium Cutting Method)

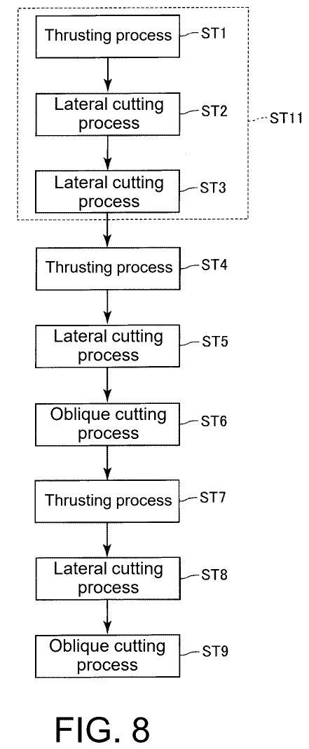

FIG. 8 is a flowchart for explaining a cutting procedure of the medium 2 in the printing apparatus 1.

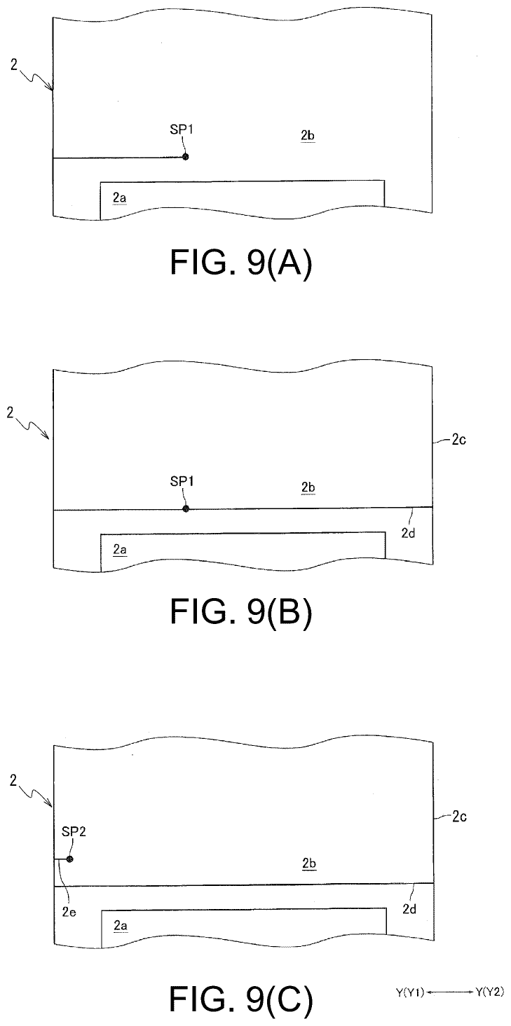

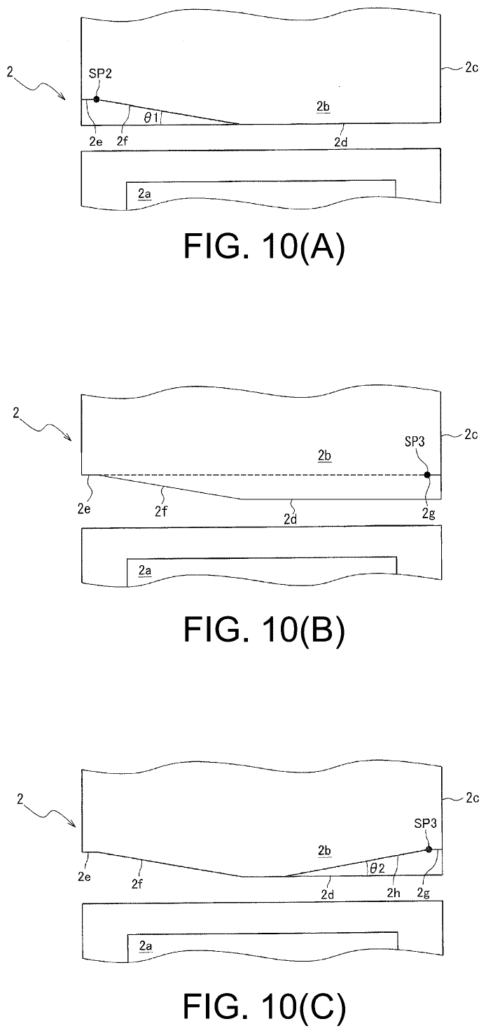

FIGS. 9 and 10 are diagrams for explaining a cutting method of the medium 2 in the printing apparatus 1.

In the printing apparatus 1, when printing is performed on a medium 2′ (specifically, a medium having different material and width) different from a certain medium 2, which is not illustrated, after printing on the medium 2 is completed, the medium 2 set in the printing apparatus 1 is replaced with the next medium 2′. The medium 2 is cut by the cutter blade 8 before replacing it with the medium 2′. Hereinafter, a cutting method of the medium 2 performed on the medium 2 before replacement in the printing apparatus 1 will be described.

In the replacement operation of the medium 2, the medium 2 before printing disposed on the conveyance direction upstream side of the cutting position is wound on, for example, the feed roll 23 and removed from the printing apparatus 1, and the medium 2 after printing disposed on the conveyance direction downstream side of the cutting position is wound on, for example, the winding roll 25 and removed from the printing apparatus 1. When the removed medium 2 is set again in the printing apparatus 1, after the feed roll 23 is attached to the printing apparatus 1, the medium 2 is pulled out from the feed roll 23 and passed over the upper side of the platen 18, and then the end portion on the conveyance direction downstream side of the medium 2 is fixed to the paper tube 26.

The cutting method of the medium 2 includes a thrusting process ST1 of thrusting the medium 2 with the cutter blade 8 so as to penetrate the medium 2, and lateral cutting processes ST2 and ST3 of cutting the medium 2 in the left-right direction by relatively moving the cutter blade 8 in the left-right direction with respect to the medium 2 with a thrusting spot SP1 (see FIG. 9(A)), which is a spot where the cutter blade 8 has thrust in the thrusting process ST1, as a starting point.

The cutting method of the medium 2 includes a thrusting process ST4 of thrusting the medium 2 with the cutter blade 8 so as to penetrate the medium 2, a lateral cutting process ST5 of cutting the medium 2 in the left-right direction by relatively moving the cutter blade 8 in the left-right direction with respect to the medium 2 with a thrusting spot SP2 (see FIG. 9(C)) as a starting point, which is a spot where the cutter blade 8 has thrust in the thrusting process ST4, as a starting point, and an oblique cutting process ST6 of cutting the medium 2 in a direction inclined with respect to the left-right direction by relatively moving the cutter blade 8 in the longitudinal direction and the left-right direction of the medium 2 with respect to the medium 2 with the thrusting spot SP2 as a starting point.

Further, the cutting method of the medium 2 includes a thrusting process ST7 of thrusting the medium 2 with the cutter blade 8 so as to penetrate the medium 2, a lateral cutting process ST8 of cutting the medium 2 in the left-right direction by relatively moving the cutter blade 8 in the left-right direction with respect to the medium 2 with a thrusting spot SP3 (see FIG. 10(B)) as a starting point, which is a spot where the cutter blade 8 has thrust in the thrusting process ST7, as a starting point, and an oblique cutting process ST9 of cutting the medium 2 in a direction inclined with respect to the left-right direction by relatively moving the cutter blade 8 in the longitudinal direction and the left-right direction of the medium 2 with respect to the medium 2 with the thrusting spot SP3 as a starting point.

As illustrated in FIG. 8, the thrusting process ST1, the lateral cutting process ST2, the lateral cutting process ST3, the thrusting process ST4, the lateral cutting process ST5, the oblique cutting process ST6, the thrusting process ST7, the lateral cutting process ST8, and the oblique cutting process ST9 are performed in this order. The cutting step of the medium 2 includes the thrusting process ST1, lateral cutting processes ST2 and ST3, the thrusting process ST4, the lateral cutting process ST5, the oblique cutting process ST6, the thrusting process ST7, the lateral cutting process ST8, and the oblique cutting process ST9.

As illustrated in FIG. 9, assuming that a portion of the medium 2 where printing (processing) by the printing mechanism 3 is performed is a printed portion 2a, and a portion of the medium 2 on the upstream side of the printed portion 2a in the medium conveyance direction where printing by the printing mechanism 3 is not performed is a non-printed portion 2b, the thrusting process ST1, the lateral cutting processes ST2 and ST3, the thrusting process ST4, the lateral cutting process ST5, the oblique cutting process ST6, the thrusting process ST7, the lateral cutting process ST8, and the oblique cutting process ST9 are performed on the non-printed portion 2b. The printed portion 2a is a processed portion, and the non-printed portion 2b is a non-processed portion.

In the thrusting process ST1, the cutter blade 8 is thrust at a position between both end portions of the medium 2 in the left-right direction (see thrusting spot SP1 in FIG. 9(A)). In the thrusting process ST1, after the cutter unit 9 with the cutter holder 31 raised is moved to a predetermined position, the cutter holder 31 is lowered to thrust the medium 2 with the cutter blade 8. In the thrusting process ST1, the cutter holder 31 is in the rotation regulating state, and the cutter blade 8 does not rotate with respect to the unit frame 32.

In the lateral cutting process ST2, the medium 2 is cut by moving the cutter blade 8 toward the left side from the thrusting spot SP1 as a starting point to the left end surface of the medium 2 (see FIG. 9(A)). That is, in the lateral cutting process ST2, the medium 2 is cut by moving the cutter unit 9 toward the left side with the medium 2 stopped. In the lateral cutting process ST3, the medium 2 is cut by moving the cutter blade 8 toward the right side from the thrusting spot SP1 as a starting point to the right end surface of the medium 2 (see FIG. 9(B)). That is, in the lateral cutting process ST3, the medium 2 is cut by moving the cutter unit 9 toward the right side with the medium 2 stopped. In these lateral cutting processes ST2 and ST3, the cutter holder 31 is in the rotation regulating state. Therefore, the cutter blade 8 does not rotate with respect to the unit frame 32.

The thrusting process ST1 corresponds to a third thrusting process. The lateral cutting process ST2 corresponds to a sixth cutting process. The lateral cutting process ST3 corresponds to a seventh cutting process. The thrusting spot SP1 corresponds to a third thrusting spot. The thrusting process ST1 and the lateral cutting processes ST2 and ST3 constitute a second cutting process ST11 in which the cutter blade 8 is relatively moved in the left-right direction to the medium 2 to cut the medium 2 in the entire region in the left-right direction. Thus, the medium 2 is cut. In the following description, the medium 2 disposed on the conveyance direction upstream side of the cutting position of the medium 2 in the second cutting process ST11 is referred to as an upstream medium 2c. The end surface on the conveyance direction downstream side of the upstream medium 2c after the second cutting process ST11 is finished is defined as a first end surface 2d.

In the thrusting process ST4, the cutter blade 8 is thrust into the left end portion of the upstream medium 2c so as to penetrate the upstream medium 2c (see the thrusting spot SP2 in FIG. 9(C)). In the thrusting process ST4, similarly to the thrusting process ST1, the cutter unit 9 in a state in which the cutter holder 31 is raised is moved to a predetermined position, and then the cutter holder 31 is lowered to thrust the upstream medium 2c with the cutter blade 8. In the thrusting process ST4, the cutter holder 31 is in the rotation regulating state, and the cutter blade 8 does not rotate with respect to the unit frame 32.

In the lateral cutting process ST5, the cutter blade 8 is moved toward the left side with the thrusting spot SP2 as a starting point, and the upstream medium 2c is cut from the thrusting spot SP2 to the left end surface of the upstream medium 2c (see FIG. 9(C)). Specifically, in the lateral cutting process ST5, the upstream medium 2c is cut by moving the cutter unit 9 toward the left side with the upstream medium 2c stopped. In the lateral cutting process ST5, the cutter holder 31 is in the rotation regulating state. Therefore, the cutter blade 8 does not rotate with respect to the unit frame 32.

In the oblique cutting process ST6, the cutter blade 8 is relatively moved toward the downstream side and the right side in the conveyance direction with respect to the upstream medium 2c from the thrusting spot SP2 to the first end surface 2d with the thrusting spot SP2 as a starting point, and the upstream medium 2c is cut from the thrusting spot SP2 to the first end surface 2d (see FIG. 10(A)). Specifically, in the oblique cutting process ST6, the upstream medium 2c is cut by moving the cutter unit 9 toward the right side at a predetermined speed while conveying the upstream medium 2c toward the conveyance direction upstream side at a predetermined speed. In the oblique cutting process ST6, the upstream medium 2c is linearly cut from the thrusting spot SP2 to the first end surface 2d.

As illustrated in FIG. 10(B), when the oblique cutting process ST6 is finished, a second end surface 2e parallel to the left-right direction and a third end surface 2f inclined (specifically, the conveyance direction is inclined toward the conveyance direction downstream side and toward the right side) with respect to the left-right direction are formed on the upstream medium 2c at the conveyance direction downstream end of the upstream medium 2c. The second end surface 2e is formed between the left end surface of the upstream medium 2c and the thrusting spot SP2. The third end surface 2f is formed between the thrusting spot SP2 and the first end surface 2d. The right end of the third end surface 2f is disposed on the left side of the center of the first end surface 2d in the left-right direction.

In the oblique cutting process ST6, the cutter holder 31 is in a rotatable state, and the cutter blade 8 is in a rotatable state with respect to the unit frame 32. In the oblique cutting process ST6, the cutter blade 8 rotates with respect to the unit frame 32 so that the relative movement direction of the cutter blade 8 with respect to the upstream medium 2c coincides with the width direction of the cutter blade 8, and then moves relatively to the upstream medium 2c while maintaining a state in which the relative movement direction of the cutter blade 8 with respect to the upstream medium 2c coincides with the width direction of the cutter blade 8.

The thrusting process ST4 corresponds to the first thrusting process. The oblique cutting process ST6 corresponds to the first cutting process. The lateral cutting process ST5 corresponds to the fourth cutting process. The lateral cutting process ST5, which is the fourth cutting process, is performed after the thrusting process ST4, which is the first thrusting process ST4, and before the oblique cutting process ST6, which is the first cutting process. The thrusting spot SP2 corresponds to the first thrusting spot.

In the thrusting process ST7, the cutter blade 8 is thrust into the right end portion of the upstream medium 2c so as to penetrate the upstream medium 2c (see the thrusting spot SP2 in FIG. 10(B)). In the thrusting process ST7, similarly to the thrusting process ST1, the cutter unit 9 in a state in which the cutter holder 31 is raised is moved to a predetermined position, and then the cutter holder 31 is lowered to thrust the upstream medium 2c with the cutter blade 8. The thrusting spot SP3 is formed at the same position as the thrusting spot SP2 in the medium conveyance direction. Therefore, after the oblique cutting process ST6 and before the thrusting process ST7, the upstream medium 2c is conveyed toward the conveyance direction downstream side by a predetermined amount. The distance (distance in the left-right direction) from the left end surface of the upstream medium 2c to the thrusting spot SP2 and the distance (distance in the left-right direction) from the right end surface of the upstream medium 2c to the thrusting spot SP3 are equal. In the thrusting process ST7, the cutter holder 31 is in the rotation regulating state. Therefore, the cutter blade 8 does not rotate with respect to the unit frame 32.

In the lateral cutting process ST8, the cutter blade 8 is moved toward the right side with the thrusting spot SP3 as a starting point to cut the upstream medium 2c from the thrusting spot SP3 to the right end surface of the upstream medium 2c (see FIG. 10(B)). Specifically, in the lateral cutting process ST8, the upstream medium 2c is cut by moving the cutter unit 9 toward the right side with the upstream medium 2c stopped. In the lateral cutting process ST8, the cutter holder 31 is in the rotation regulating state. Therefore, the cutter blade 8 does not rotate with respect to the unit frame 32.

In the oblique cutting process ST9, the cutter blade 8 is relatively moved toward the downstream side and the left side in the conveyance direction with respect to the upstream medium 2c from the thrusting spot SP3 to the first end surface 2d with the thrusting spot SP3 as a starting point, and the upstream medium 2c is cut from the thrusting spot SP3 to the first end surface 2d (see FIG. 10(C)). Specifically, in the oblique cutting process ST9, the upstream medium 2c is cut by moving the cutter unit 9 leftward at a predetermined speed while conveying the upstream medium 2c toward the conveyance direction upstream side at a predetermined speed. In the oblique cutting process ST9, the upstream medium 2c is linearly cut from the thrusting spot SP3 to the first end surface 2d.

As illustrated in FIG. 10(C), when the oblique cutting process ST9 is finished, a fourth end surface 2g parallel to the left-right direction and a fifth end surface 2h inclined (specifically, the conveyance direction is inclined toward the conveyance direction downstream side and toward the left side) with respect to the left-right direction are formed at the conveyance direction downstream end of the upstream medium 2c. The fourth end surface 2g is formed between the right end surface of the upstream medium 2c and the thrusting spot SP3. The fifth end surface 2h is formed between the thrusting spot SP3 and the first end surface 2d. The left end of the fifth end surface 2h is disposed on the right side of the center of the first end surface 2d in the left-right direction. Therefore, even after the oblique cutting process ST9 is finished, the center of the first end surface 2d in the left-right direction remains. The end surface on the conveyance direction downstream side of the upstream medium 2c after the oblique cutting process ST9 is configured by the first end surface 2d, the second end surface 2e, the third end surface 2f, the fourth end surface 2g, and the fifth end surface 2h (see FIG. 3).

In the oblique cutting process ST9, the cutter holder 31 is in a rotatable state, and the cutter blade 8 is in a rotatable state with respect to the unit frame 32. In the oblique cutting process ST9, the cutter blade 8 rotates with respect to the unit frame 32 so that the relative movement direction of the cutter blade 8 with respect to the upstream medium 2c coincides with the width direction of the cutter blade 8, and then moves relatively to the upstream medium 2c while maintaining a state in which the relative movement direction of the cutter blade 8 with respect to the upstream medium 2c coincides with the width direction of the cutter blade 8.

The thrusting process ST7 corresponds to the second thrusting process. The oblique cutting process ST9 corresponds to the third cutting process. The lateral cutting process ST8 corresponds to the fifth cutting process. The lateral cutting process ST8, which is the fifth cutting process, is performed after the thrusting process ST7, which is the second thrusting process, and before the oblique cutting process ST9, which is the third cutting process. The thrusting spot SP3 corresponds to the second thrusting spot.

The cutting angle (that is, the inclination angle of the third end surface 2f with respect to the first end surface 2d) of the upstream medium 2c with respect to the first end surface 2d in the oblique cutting process ST6 is set to θ1 (see FIG. 10(A)). The cutting angle (that is, the inclination angle of the fifth end surface 2h with respect to the first end surface 2d) of the upstream medium 2c with respect to the first end surface 2d in the oblique cutting process ST9 is set to θ2 (see FIG. 10(C)). These cutting angles θ1 and θ2 are equal. The cutting angles θ1 and θ2 are preferably 7° to 13°. More specifically, the cutting angles θ1 and θ2 are preferably 8° to 12°. In the present example embodiment, a case where the cutting angles θ1 and θ2 are each 10° will be described as an example.

The cutting angles θ1 and θ2 are constant regardless of the width of the medium 2 to be cut. That is, the cutting angles θ1 and θ2 are 10° regardless of the width of the medium 2 to be cut. For example, even when the width of the medium 2 to be cut is 1600 mm, the cutting angles θ1 and θ2 are 10°, and even when the width of the medium 2 to be cut is 1000 mm, the cutting angles θ1 and θ2 are 10°. Further, since the thrusting spot SP2 and the thrusting spot SP3 are formed at the same position in the medium conveyance direction, and the distance from the left end surface of the upstream medium 2c to the thrusting spot SP2 and the distance from the right end surface of the upstream medium 2c to the thrusting spot SP3 are equal, the third end surface 2f and the fifth end surface 2h are formed to be bilaterally symmetrical.

As illustrated in FIG. 3, the end surface on the conveyance direction downstream side of the upstream medium 2c after the medium 2 is cut before the replacement of the medium 2′ is configured by the first end surface 2d, the second end surface 2e, the third end surface 2f, the fourth end surface 2g, and the fifth end surface 2h. Therefore, when the medium 2 is once removed from the printing apparatus 1 and then attached to the printing apparatus 1 again, the region around the first end surface 2d in the upstream medium 2c is fixed to the paper tube 26.

Here, when a new medium 2 is attached to the printing apparatus 1, the end surface on the conveyance direction downstream side of the medium 2 fixed to the paper tube 26 has a shape parallel to the left-right direction. In this case, the thrusting process ST4, the lateral cutting process ST5, the oblique cutting process ST6, the thrusting process ST7, the lateral cutting process ST8, and the oblique cutting process ST9 are performed before the end portion on the conveyance direction downstream side of the medium 2 is fixed to the paper tube 26.

The thrusting process ST1, the lateral cutting processes ST2 and ST3, the thrusting process ST4, the lateral cutting process ST5, the oblique cutting process ST6, the thrusting process ST7, the lateral cutting process ST8, and the oblique cutting process ST9 are automatically and continuously performed. That is, in the printing apparatus 1, the control unit 14 stores a control program for continuously executing the thrusting process ST1, the lateral cutting processes ST2 and ST3, the thrusting process ST4, the lateral cutting process ST5, the oblique cutting process ST6, the thrusting process ST7, the lateral cutting process ST8, and the oblique cutting process ST9, and the control unit 14 continuously executes these steps on the basis of this control program. For example, when replacement of the medium 2 becomes necessary and the operator of the printing apparatus 1 presses a predetermined operation button, the control unit 14 continuously executes these steps.

That is, when the operator presses the operation button, the control unit 14 first executes the thrusting process ST1 (thrusting step S1), then executes the lateral cutting process ST2 (lateral cutting step S2), and then executes the lateral cutting process ST3 (lateral cutting step S3). Thereafter, the control unit 14 executes the thrusting process ST4 (thrusting step S4), then executes the lateral cutting process ST5 (lateral cutting step S5), and then executes the oblique cutting process ST6 (oblique cutting step S6). Thereafter, the control unit 14 executes the thrusting process ST7 (thrusting step S7), then executes the lateral cutting process ST8 (lateral cutting step S8), and then executes the oblique cutting process ST9 (oblique cutting step S9).

The thrusting step S4 corresponds to the first thrusting step. The oblique cutting step S6 corresponds to the first cutting step. thrusting step S7 corresponds to the second thrusting step. The oblique cutting step S9 corresponds to the third cutting step. lateral cutting step S5 corresponds to the fourth cutting step. This is executed before the oblique cutting step S6 which is the first cutting step. The lateral cutting step S8 corresponds to the fifth cutting step. This step is performed before the oblique cutting step S9 which is the third cutting step.

In the lateral cutting steps S2, S3, S5, and S8, the control unit 14 controls the medium conveyance mechanism 10 and the carriage driving mechanism 11 to relatively move the cutter unit 9 to the medium 2 in the left-right direction and cut the medium 2 in the left-right direction in the lateral cutting mode. In the lateral cutting mode, the control unit 14 controls the switching mechanism 34 to bring the cutter holder 31 into the rotation regulating state. Specifically, the switching mechanism 34 brings the cutter holder 31 into the rotation regulating state in the lateral cutting mode.

In the oblique cutting steps S6 and S9, the control unit 14 controls the medium conveyance mechanism 10 and the carriage driving mechanism 11 to relatively move the cutter unit 9 to the medium 2 in the medium conveyance direction and the left-right direction so as to cut the medium 2 in a direction inclined with respect to the left-right direction in the oblique cutting mode.

Specifically, in the oblique cutting step S6, the control unit 14 cuts the medium 2 in the first oblique cutting mode as the oblique cutting mode in which the medium 2 is cut between the intermediate position of the medium 2 in the left-right direction and one end side (left end side) of the medium 2 in the left-right direction (specifically, between the intermediate position of the first end surface 2d and the thrusting spot SP2 in the left-right direction), and in the oblique cutting step S9, the controller cuts the medium 2 in the second oblique cutting mode as the oblique cutting mode in which the medium 2 is cut between the intermediate position of the medium 2 in the left-right direction and the other end side (right end side) of the medium 2 in the left-right direction (specifically, between the intermediate position of the first end surface 2d and the thrusting spot SP3 in the left-right direction).

In the oblique cutting mode, the control unit 14 controls the switching mechanism 34 to set the cutter holder 31 to be in the rotatable state. That is, the switching mechanism 34 sets the cutter holder 31 to be in the rotatable state in the oblique cutting mode. In the first oblique cutting mode and the second oblique cutting mode, the control unit 14 controls the conveyance speed of the medium 2 by the medium conveyance mechanism 10 and the moving speed of the cutter unit 9 by the carriage driving mechanism 11 according to the predetermined data input to the control unit 14 to cut the medium 2 at a desired angle with respect to the left-right direction. Examples of the data input to the control unit 14 include conveyance speed data of the medium 2 in the first oblique cutting mode and the second oblique cutting mode, moving speed data of the cutter unit 9, and position data of the cutter blade 8 at the start of cutting.

The cutting angle θ1 of the medium 2 with respect to the left-right direction in the first oblique cutting mode and the cutting angle θ2 of the medium 2 with respect to the left-right direction in the second oblique cutting mode are set to 7° to 13°. More specifically, the cutting angles θ1 and θ2 are preferably set to 8° to 12°. In the present example embodiment, a case where the cutting angles θ1 and θ2 are set to 10° is exemplified. After the printing of the medium 2 by the printing mechanism 3, the control unit 14 cuts the non-printed portion 2b over the entire region in the left-right direction by the lateral cutting mode in the lateral cutting steps S2 and S3, and then cuts the medium 2 in the first oblique cutting mode and cuts the medium 2 in the second oblique cutting mode with respect to the non-printed portion 2b disposed on the conveyance direction upstream side of the cutting position in the lateral cutting steps S2 and S3 in the oblique cutting steps S6 and S9.

As described above, in the present example embodiment, in the thrusting process ST4, the cutter blade 8 is thrust into the upstream medium 2c so as to penetrate the upstream medium 2c, and then in the oblique cutting process ST6, the cutter blade 8 is relatively moved toward the downstream side and the right side in the conveyance direction with respect to the upstream medium 2c with the thrusting spot SP2 as a starting point, and the upstream medium 2c is cut in the direction inclined with respect to the left-right direction. In the present example embodiment, in the thrusting process ST7, the cutter blade 8 is thrust into the upstream medium 2c so as to penetrate the upstream medium 2c, and then in the oblique cutting process ST9, the cutter blade 8 is relatively moved toward the downstream side and the left side in the conveyance direction with respect to the upstream medium 2c with the thrusting spot SP3 as a starting point, and the upstream medium 2c is cut in the direction inclined with respect to the left-right direction.

Thus, in the oblique cutting processes ST6 and ST9, the upstream medium 2c can be started to be cut in a direction inclined with respect to the left-right direction using the cutter blade 8 penetrating the upstream medium 2c. That is, since the cutting of the medium 2 is started in a state where the cutter blade 8 is positioned in the medium 2, the shape of the cut portion is easily stabilized as compared with, for example, a cutting method in which the medium 2 is cut by moving the cutter blade 8 from one end to the other end in the width direction of the medium 2. Therefore, the shape of the cut portion is stabilized regardless of the characteristics of the medium.

In the oblique cutting processes ST6 and ST9, the upstream medium 2c is cut to the first end surface 2d, which is the end surface on the conveyance direction downstream side of the upstream medium 2c, while conveying the upstream medium 2c toward the conveyance direction upstream side. Thus, when cutting the upstream medium 2c in the oblique cutting processes ST6 and ST9, it is possible to reduce the occurrence of wrinkles in the portion of the upstream medium 2c between the conveyance roller 19 and the pad roller 20 and the cutter blade 8 in the medium conveyance direction. Therefore, the upstream medium 2c can be cut more appropriately in the direction inclined with respect to the left-right direction.

After the cutter blade 8 is thrust into the medium 2 so as to penetrate the medium 2 in the thrusting process ST1, the medium 2 is cut in the left-right direction by moving the cutter blade 8 in the left-right direction with respect to the medium 2 with the thrusting spot SP1 as a starting point in the lateral cutting processes ST2 and ST3. Thus, in the lateral cutting processes ST2 and ST3, the medium 2 can be started to be cut in the left-right direction using the cutter blade 8 penetrating the medium 2. Therefore, the medium 2 can be appropriately cut in the left-right direction.

On the end surface on the conveyance direction downstream side of the medium 2, the third end surface 2f inclined toward the conveyance direction downstream side toward the right side and the fifth end surface 2h inclined toward the conveyance direction downstream side toward the left side are formed symmetrically. Therefore, even if the medium 2 attached again to the printing apparatus 1 is not cut, the medium 2 is easily wound by the paper tube 26 at the start of winding of the medium 2 by the paper tube 26 after the end portion on the conveyance direction downstream side of the medium 2 is fixed to the paper tube 26 in the replacement operation of the medium 2.

Further, the cutting angles θ1 and θ2 of the upstream medium 2c with respect to the left-right direction are constant regardless of the width of the medium 2 to be cut, and in the oblique cutting processes ST6 and ST9, the rotation angle of the cutter holder 31 with respect to the unit frame 32 is constant regardless of the width of the medium 2 to be cut. Therefore, in the oblique cutting processes ST6 and ST9, it is possible to reduce excessive rotation of the cutter holder 31 with respect to the unit frame 32.

In the printing apparatus 1, the cutter unit 9 includes the switching mechanism 34 that switches the state of the cutter holder 31 between a rotation regulating state in which the rotation of the cutter holder 31 with respect to the unit frame 32 is regulated and a rotatable state in which the cutter holder 31 can be rotated with respect to the unit frame 32.

When cutting the medium 2 in the oblique cutting mode in which the cutter unit 9 is relatively moved to the medium 2 in the medium conveyance direction and the left-right direction to cut the medium 2 in the direction inclined with respect to the left-right direction, the control unit 14 sets the cutter holder 31 in the rotatable state, but when cutting the medium 2 in the lateral cutting mode in which the cutter unit 9 is relatively moved to the medium 2 in the left-right direction to cut the medium 2 in the left-right direction, the control unit sets the cutter holder 31 in the rotation regulating state.

Thus, even if the medium 2 can be cut in the lateral cutting mode in which the medium 2 is cut in the left-right direction and the medium 2 can be cut in the oblique cutting mode in which the medium 2 is cut in the direction inclined with respect to the left-right direction, the state of the cutter holder 31 when cutting the medium 2 in the lateral cutting mode can be stabilized, and as a result, the state of the cutter blade 8 when cutting the medium 2 in the lateral cutting mode can be stabilized.

The switching mechanism 34 includes a regulation member 42 for regulating the rotation of the cutter holder 31, and a solenoid 43 for moving the regulation member 42 to the regulation position 42A and the regulation release position 42B. Therefore, when the regulation member 42 is disposed at the regulation position 42A, the cutter holder 31 is in the rotation regulating state, and when the regulation member 42 is disposed at the regulation release position 42B, the cutter holder 31 is in the rotatable state. This makes it possible to switch the state of the cutter holder 31 with a relatively simple configuration.

On the end surface on the conveyance direction downstream side of the medium 2, the third end surface 2f inclined toward the conveyance direction downstream side toward the right side and the fifth end surface 2h inclined toward the conveyance direction downstream side toward the left side are formed symmetrically. Therefore, even if the medium 2 attached again to the printing apparatus 1 is not cut, the medium 2 is easily wound by the paper tube 26 at the start of winding of the medium 2 by the paper tube 26 after the end portion on the conveyance direction downstream side of the medium 2 is fixed to the paper tube 26 in the replacement operation of the medium 2.

The outer diameter of the paper tube 26 is 3 inches or 2 inches, and the medium 2 is made of soft polyvinyl chloride or tarpaulin. The cutting angles θ1 and θ2 of the medium 2 in the first oblique cutting mode and the second oblique cutting mode with respect to the left-right direction are 10°. Therefore, at the start of the winding of the medium 2 by the paper tube 26, the medium 2 can be appropriately wound by the paper tube 26 while the breakage of the medium 2 is reduced.

The cutter unit 9 is mounted on the carriage 7, and can move the cutter unit 9 in the left-right direction in addition to the head 6 using the carriage driving mechanism 11. Therefore, the configuration of the printing apparatus 1 can be simplified as compared with a case where a drive mechanism for moving the cutter unit 9 in the left-right direction is separately provided.

In the embodiment described above, the case where the cutter holder 31 is in the rotation regulating state in the lateral cutting processes ST5 and ST8 has been exemplified. However, the cutter holder 31 may be in the rotatable state in the lateral cutting processes ST5 and ST8. In addition, the cutter holder 31 may be in a rotatable state in the lateral cutting processes ST2, ST3, ST5, and ST8. In addition, the cutter holder 31 may be in a rotatable state in the thrusting processes ST1, ST4, and ST7.

After the thrusting process ST4, the oblique cutting process ST6 may be performed, and then the lateral cutting process ST5 may be performed. After the thrusting process ST7, the oblique cutting process ST9 may be performed, and then the lateral cutting process ST8 may be performed.

Instead of the lateral cutting process ST5, an oblique cutting process may be performed in which the cutter blade 8 is relatively moved to the medium 2 in the longitudinal direction and the left-right direction of the medium 2 to cut the upstream medium 2c from the thrusting spot SP2 to the left end surface of the upstream medium 2c in a direction inclined with respect to the left-right direction. Instead of the lateral cutting process ST8, an oblique cutting process may be performed in which the cutter blade 8 is relatively moved to the medium 2 in the longitudinal direction and the left-right direction of the medium 2 to cut the upstream medium 2c from the thrusting spot SP3 to the right end surface of the upstream medium 2c in a direction inclined with respect to the left-right direction. In these oblique cutting processes, the cutter holder 31 is in a rotatable state.

Further, by fixing the medium 2 on the platen 18 using a jig (not illustrated) or the like, the thrusting processes ST1, ST4, and ST7 can be omitted. In this case, after the lateral cutting process (cutting of the medium 2 in the lateral cutting mode) of cutting the medium 2 in the entire region in the left-right direction by moving the cutter blade 8 in the left-right direction from the right end surface to the left end surface of the medium 2 with respect to the medium 2 is performed, an oblique cutting process (cutting of the medium 2 in the oblique cutting mode) of cutting the upstream medium 2c from the left end surface of the upstream medium 2c to the first end surface 2d by relatively moving the cutter blade 8 toward the downstream side and the right side in the conveyance direction with respect to the upstream medium 2c, and an oblique cutting process (cutting of the medium 2 in the oblique cutting mode) of cutting the upstream medium 2c from the right end surface of the upstream medium 2c to the first end surface 2d by relatively moving the cutter blade 8 toward the downstream side and the left side in the conveyance direction with respect to the upstream medium 2c are performed.

Only the thrusting process ST4, the oblique cutting process ST6, the thrusting process ST7, the oblique cutting process ST9, and the lateral cutting processes ST2 and ST3 may be performed in this order. For example, in the thrusting process ST4, the cutter blade 8 is thrust at an intermediate position in the left-right direction of the medium 2, and in the oblique cutting process ST6, the cutter blade 8 is relatively moved toward the upstream side and the left side in the conveyance direction with respect to the medium 2 from the thrusting spot SP2 to the left end surface of the medium 2, and the medium 2 is cut from the thrusting spot SP2 to the left end surface of the medium 2.

Furthermore, in the thrusting process ST7, the cutter blade 8 is thrust at an intermediate position in the left-right direction of the medium 2, and in the oblique cutting process ST9, the cutter blade 8 is relatively moved toward the upstream side and the right side in the conveyance direction with respect to the medium 2 from the thrusting spot SP3 to the right end surface of the medium 2, and the medium 2 is cut from the thrusting spot SP3 to the right end surface of the medium 2. In the lateral cutting processes ST2 and ST3, the medium 2 is cut by moving the cutter blade 8 from the thrusting spot SP2 or the thrusting spot SP3 to both end surfaces of the medium 2 in the left-right direction.

The upstream medium 2c may be cut so that the right end of the third end surface 2f and the left end of the fifth end surface 2h are connected. That is, the upstream medium 2c may be cut so that the first end surface 2d does not remain after the oblique cutting process ST9 is finished. Furthermore, the cutting angle θ1 and the cutting angle 02 may be different.

The thrusting spot SP2 and the thrusting spot SP3 may be shifted in the medium conveyance direction. Further, the distance in the left-right direction from the left end surface of the upstream medium 2c to the thrusting spot SP2 and the distance in the left-right direction from the right end surface of the upstream medium 2c to the thrusting spot SP3 may be different. The cutting angles θ1 and θ2 may vary depending on the width of the medium 2 to be cut. For example, the cutting angles θ1 and θ2 may vary according to the width of the medium 2 to be cut so that the distance between the second end surface 2e, the fourth end surface 2g, and the first end surface 2d in the medium conveyance direction becomes constant regardless of the width of the medium 2 to be cut.

The thrusting process ST1, the lateral cutting processes ST2 and ST3, the thrusting process ST4, the lateral cutting process ST5, the oblique cutting process ST6, the thrusting process ST7, the lateral cutting process ST8, and the oblique cutting process ST9 may not be automatically and continuously performed. For example, each time the operator presses a predetermined operation button, the operation may be performed step by step. Each process may be performed while the operator manually operates the medium conveyance mechanism 10, the carriage driving mechanism 11, the up-down moving mechanism 33, the switching mechanism 34, and the like.

The cutter unit 9 may not be mounted on the carriage 7. In this case, a carriage on which the cutter unit 9 is mounted and a cutter unit driving mechanism that moves the carriage in the left-right direction are separately provided. In this case, a second cutter unit driving mechanism that moves the carriage on which the cutter unit 9 is mounted in the front-rear direction may be provided. In this case, for example, a moving mechanism for relatively moving the cutter unit 9 with respect to the medium 2 in the longitudinal direction of the medium 2 and the width direction of the medium 2 may be configured by the cutter unit driving mechanism and the second cutter unit driving mechanism.

The switching mechanism 34 may include a motor as a drive source instead of the solenoid 43. The medium 2 may be made of a resin other than polyvinyl chloride, or may be made of paper.

### First Modification

Hereinafter, a printing apparatus 1A according to a first modification will be described.

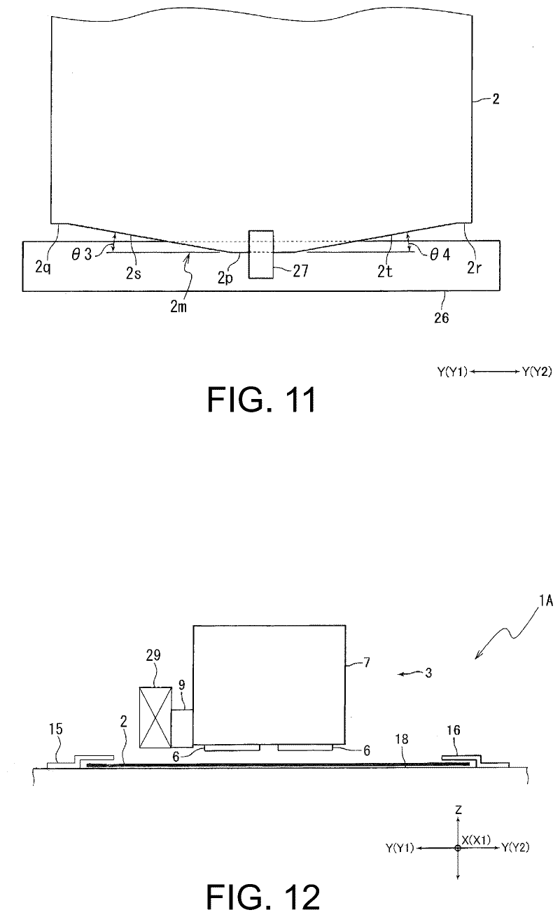

FIG. 11 is a diagram for explaining the medium 2 in a state of being fixed to the paper tube 26 in the printing apparatus 1A.

FIG. 12 is a diagram for explaining the periphery of the carriage 7 of the printing apparatus 1A, and is a view of the periphery of the carriage 7 of the printing apparatus 1A as viewed from the front side.

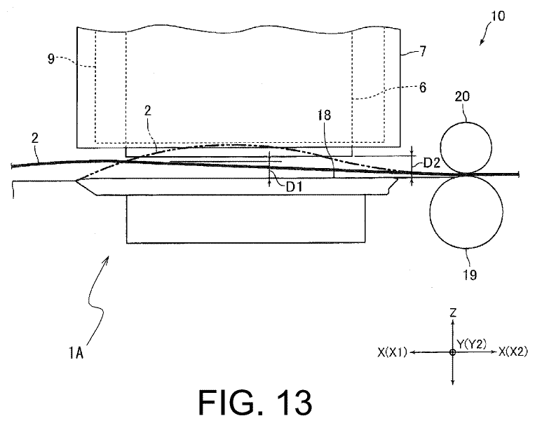

FIG. 13 is a diagram for explaining the periphery of the carriage 7 of the printing apparatus 1A, and is a view of the periphery of the carriage 7 of the printing apparatus 1A as viewed from the right side.

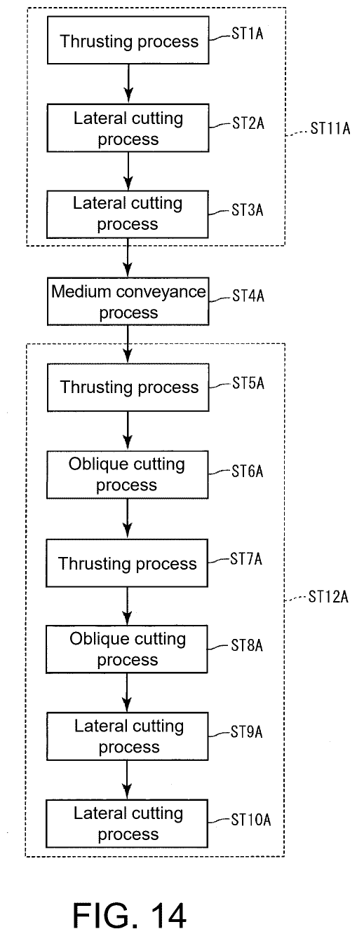

FIG. 14 is a flowchart for explaining a cutting procedure for cutting the medium 2 using the printing apparatus 1A.

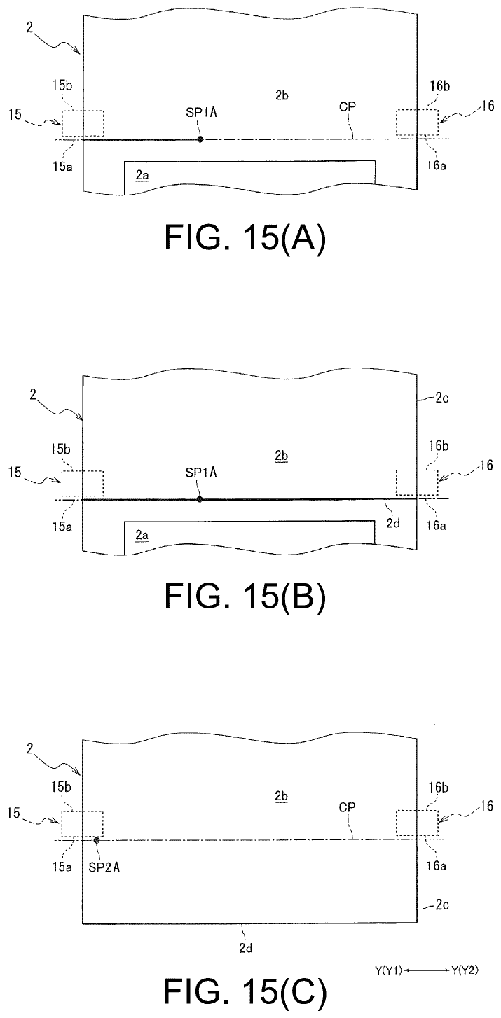

FIGS. 15 to 17 are diagrams for explaining a cutting method of the medium 2 cut in the cutting procedure of the medium 2 illustrated in FIG. 14.

The position indicated by the alternate long and short dash line in FIGS. 15 to 17 is a cutter blade position CP which is the position of the blade edge of the cutter blade 8 in the medium conveyance direction.

The roll-shaped medium 2 tends to have a stronger curling tendency toward a smaller diameter side. Then, the medium 2 may lift up from the platen 18 in an arcuate manner due to the curling tendency. Then, the portion of the medium 2 floating from the platen 18 comes into contact with the carriage 7, and the medium 2 may not be appropriately cut (see the two-dot chain line in FIG. 13). The present invention can also cut the medium 2 in consideration of the curling tendency. In the first modification, portions different from those of the above-described embodiment will be described. Portions common to those of the above-described embodiment will not be described and will be denoted by the same reference numerals.

As illustrated in FIG. 12, in the printing apparatus 1A according to the first modification, a first medium guide 15 and a second medium guide 16 are provided on the upper surface of the platen 18. The first medium guide 15 and the second medium guide 16 are formed in the same shape.

The first medium guide 15 is fixed to the left end portion of the upper surface of the platen 18, and presses the left end portion of the medium 2 placed on the platen 18 from above. The second medium guide 16 is fixed to the right end portion of the upper surface of the platen 18, and presses the right end portion of the medium 2 placed on the platen 18 from above. The first medium guide 15 and the second medium guide 16 are disposed at the same position in the medium conveyance direction.

In the printing apparatus 1A, the ink of ultraviolet curing type is ejected from the head 6. The printing apparatus 1A includes an ultraviolet irradiation unit 29 that irradiates the ink ejected from the head 6 onto the medium 2 with ultraviolet light. The ultraviolet irradiation unit 29 is mounted on the carriage 7. The ultraviolet irradiation unit 29 is disposed on the left side of the cutter unit 9.

### (Medium Cutting Method)

As illustrated in FIG. 14, the cutting method of the medium 2 using the printing apparatus 1A includes a thrusting process ST1A of thrusting the medium 2 with the cutter blade 8 so as to penetrate the medium 2, and lateral cutting processes ST2A and ST3A of cutting the medium 2 in the left-right direction by relatively moving the cutter blade 8 in the left-right direction with respect to the medium 2 with a thrusting spot SP1A (see FIG. 15(A)), which is a spot where the cutter blade 8 has been thrust in the thrusting process ST1A, as a starting point. The cutting method of the medium 2 includes a medium conveyance process ST4A of conveying the medium 2 by a predetermined amount toward the conveyance direction downstream side.

The cutting method of the medium 2 includes a thrusting process ST5A of thrusting the left end portion of the medium 2 with the cutter blade 8 so as to penetrate the medium 2, an oblique cutting process ST6A of cutting the medium 2 at least in a direction inclined with respect to the left-right direction by relatively moving the cutter blade 8 with respect to the medium 2 toward the downstream side and the right side in the conveyance direction with a thrusting spot SP2A (see FIG. 15(C)), which is a spot thrust with the cutter blade 8 in the thrusting process ST5A, as a starting point, and a lateral cutting process ST10A of cutting the medium 2 in the left-right direction by relatively moving the cutter blade 8 with respect to the medium 2 with the thrusting spot SP2A as a starting point.

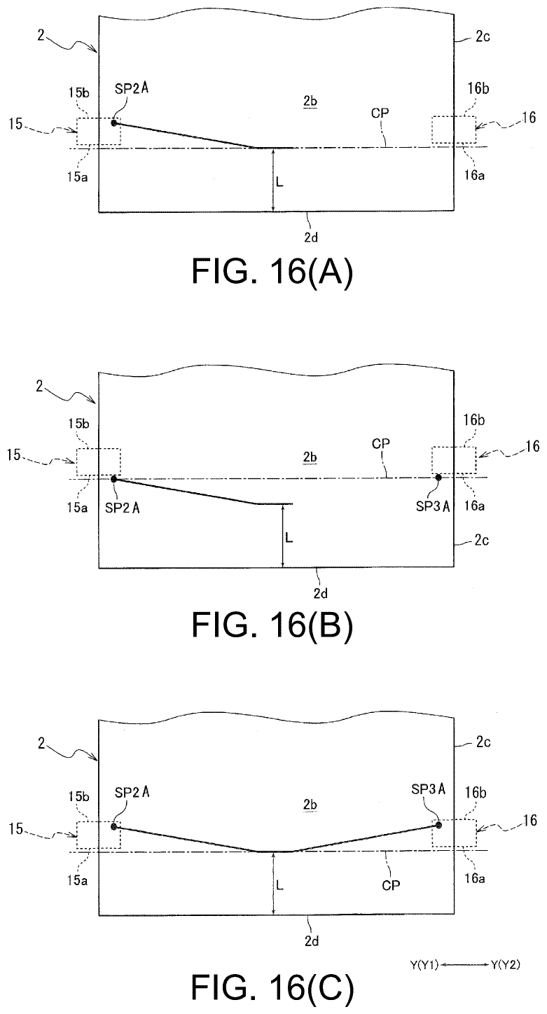

Furthermore, the cutting method of the medium 2 includes a thrusting process ST7A of thrusting the right end portion of the medium 2 with the cutter blade 8 so as to penetrate the medium 2, an oblique cutting process ST8A of cutting the medium 2 at least in a direction inclined with respect to the left-right direction by relatively moving the cutter blade 8 with respect to the medium 2 toward the downstream side and the right side in the conveyance direction with a thrusting spot SP3A (see FIG. 16(B)), which is a spot thrust with the cutter blade 8 in the thrusting process ST7A, as a starting point, and a lateral cutting process ST9A of cutting the medium 2 in the left-right direction by relatively moving the cutter blade 8 with respect to the medium 2 with the thrusting spot SP3A as a starting point.

The thrusting process ST1A, the lateral cutting process ST2A, the lateral cutting process ST3A, the medium conveyance process ST4A, the thrusting process ST5A, the oblique cutting process ST6A, the thrusting process ST7A, the oblique cutting process ST8A, the lateral cutting process ST9A, and the lateral cutting process ST10A are performed in this order. The cutting process of the medium 2 includes the thrusting process ST1A, the lateral cutting processes ST2A and ST3A, the medium conveyance process ST4A, the thrusting process ST5A, the oblique cutting process ST6A, the thrusting process ST7A, the oblique cutting process ST8A, and the lateral cutting processes ST9A and ST10A.

At the start of the cutting process of the medium 2, the carriage 7 and the cutter unit 9 are disposed at a predetermined standby position (home position). The carriage 7 and the cutter unit 9 disposed at the standby position are disposed on the right side of the medium 2. Although not illustrated, the printing apparatus 1A includes a maintenance unit disposed on the right side of the platen 18, and the carriage 7 and the cutter unit 9 disposed at the standby position are disposed above the maintenance unit. In the maintenance unit, cleaning of the head 6 is performed so that clogging does not occur in the plurality of nozzles formed on the lower end surface of the head 6.

Assuming that a portion of the medium 2 on which printing by the printing mechanism 3 has been performed is a printed portion 2a, and a portion of the medium 2 on the upstream side of the printed portion 2a in the medium conveyance direction and on which printing by the printing mechanism 3 has not been performed is a non-printed portion 2b, the thrusting process ST1A, the lateral cutting processes ST2A and ST3A, the thrusting process ST5A, the oblique cutting process ST6A, the thrusting process ST7A, the oblique cutting process ST8A, the lateral cutting process ST9A, and the lateral cutting process ST10A are performed on the non-printed portion 2b.

In the thrusting process ST1A, the cutter blade 8 is thrust at a position between both end portions of the medium 2 in the left-right direction (see the thrusting spot SP1A in FIG. 15(A)). In the thrusting process ST1A, after the cutter unit 9 with the cutter holder 31 raised is moved to a predetermined position, the cutter holder 31 is lowered to thrust the medium 2 with the cutter blade 8. Specifically, in the thrusting process ST1, after the cutter unit 9 with the cutter blade 8 disposed at the retreating position is moved to a predetermined position, the cutter blade 8 is moved to the cuttable position to thrust the medium 2 with the cutter blade 8. In the thrusting process ST1A, the cutter holder 31 is in the rotation regulating state. Therefore, the cutter blade 8 does not rotate with respect to the unit frame 32.

In the lateral cutting process ST2A, the medium 2 is cut by moving the cutter blade 8 toward the left side from the thrusting spot SP1A as a starting point to the left end surface of the medium 2 (see FIG. 15(A)). Specifically, in the lateral cutting process ST2A, the medium 2 is cut by moving the cutter unit 9 toward the left side with the medium 2 stopped. In the lateral cutting process ST3A, the medium 2 is cut by moving the cutter blade 8 toward the right side from the thrusting spot ST1A as a starting point to the right end surface of the medium 2 (see FIG. 15(B)). Specifically, in the lateral cutting process ST3A, the medium 2 is cut by moving the cutter unit 9 toward the right side with the medium 2 stopped. In these lateral cutting processes ST2A and ST3A, the cutter holder 31 is in the rotation regulating state. Therefore, the cutter blade 8 does not rotate with respect to the unit frame 32.

The thrusting process ST1A and the lateral cutting processes ST2A and ST3A constitute a linear cutting process ST11A in which the medium 2 is cut in the entire region in the left-right direction by moving the cutter blade 8 in the left-right direction in a state where the medium 2 is stopped. When the linear cutting process ST11A is completed, the medium 2 is separated at the cutting position of the medium 2 in the linear cutting process ST11A. Assuming the medium 2 disposed on the conveyance direction upstream side with respect to the cutting position of the medium 2 in the linear cutting process ST11A as an upstream medium 2c, the end surface on the conveyance direction downstream side of the upstream medium 2c has a linear shape parallel to the left-right direction.

In the printing apparatus 1A, the medium 2 is printed by the head 6 before the linear cutting process ST11A. In the linear cutting process ST11A, a portion of the medium 2 on the conveyance direction upstream side of the printed portion (that is, the printed portion 2a) is cut. In the following description, the end surface on the conveyance direction downstream side of the upstream medium 2c when the linear cutting process ST11A is completed is referred to as a first end surface 2d. The upstream medium 2c corresponds to the second upstream medium.

In the medium conveyance process ST4A, the medium 2 is conveyed by a predetermined amount toward the conveyance direction downstream side after the linear cutting process ST11A. A specific conveyance amount of the medium 2 in the medium conveyance process ST4A will be described later.

In the thrusting process ST5A, the cutter blade 8 is thrust into the left end portion of the upstream medium 2c so as to penetrate the medium 2 (see the thrusting spot SP2A in FIG. 15(C)). In the thrusting process ST5A, as in the thrusting process ST1A, the cutter unit 9 in a state in which the cutter holder 31 is raised is moved to a predetermined position, and then the cutter holder 31 is lowered to thrust the medium 2 with the cutter blade 8. In the thrusting process ST5A, the cutter holder 31 is in the rotation regulating state. Therefore, the cutter blade 8 does not rotate with respect to the unit frame 32.

In the oblique cutting process ST6A, the medium 2 is cut to the vicinity of the intermediate position in the left-right direction by relatively moving the cutter blade 8 toward the downstream side and the right side in the conveyance direction with respect to the medium 2 with the thrusting spot SP2A as a starting point, and then the medium 2 is cut by moving the cutter blade 8 to the right by a predetermined amount (see FIG. 16 (A)). Specifically, in the oblique cutting process ST6, the medium 2 is cut by moving the cutter unit 9 toward the right side at a predetermined speed while conveying the upstream medium 2c toward the conveyance direction upstream side at a predetermined speed to cut the medium 2 from the thrusting spot SP2A to the vicinity of the intermediate position in the left-right direction, and then moving the cutter unit 9 to the right by a predetermined amount with the medium 2 stopped to cut the medium 2.

In the oblique cutting process ST6A, the medium 2 is linearly cut from the thrusting spot SP2A toward the obliquely right side, and then the medium 2 is linearly cut toward the right side. The cutting position of the medium 2 cut in the oblique cutting process ST6A does not reach the first end surface 2d in the medium conveyance direction. The cutting position of the medium 2 cut in the oblique cutting process ST6A does not reach the right end surface of the medium 2 in the left-right direction.

In the oblique cutting process ST6A, the cutter holder 31 is in a rotatable state. Thus, the cutter blade 8 is rotatable with respect to the unit frame 32. In the oblique cutting process ST6A, the cutter blade 8 rotates with respect to the unit frame 32 so that the relative movement direction of the cutter blade 8 with respect to the medium 2 coincides with the width direction of the cutter blade 8, and then relatively moves to the medium 2 while maintaining a state in which the relative movement direction of the cutter blade 8 with respect to the medium 2 coincides with the width direction of the cutter blade 8.

In the thrusting process ST7A, the cutter blade 8 is thrust into the right end portion of the upstream medium 2c so as to penetrate the medium 2 (see the thrusting spot SP3A in FIG. 16(B)). In the thrusting process ST7A, as in the thrusting process ST1A, the cutter unit 9 in a state in which the cutter holder 31 is raised is moved to a predetermined position, and then the cutter holder 31 is lowered to thrust the medium 2 with the cutter blade 8. The thrusting spot SP3A is formed at the same position as the thrusting spot SP2 in the medium conveyance direction.

Therefore, after the oblique cutting process ST6A and before the thrusting process ST7A, the medium 2 is conveyed by a predetermined amount toward the conveyance direction downstream side. Specifically, after the oblique cutting process ST6A and before the thrusting process ST7A, the medium 2 is conveyed toward the conveyance direction downstream side by the same amount as the conveyance amount of the medium 2 in the oblique cutting process ST6A. The distance from the left end surface of the medium 2 to the thrusting spot SP2A (distance in the left-right direction) is equal to the distance from the right end surface of the medium 2 to the thrusting spot SP3A (distance in the left-right direction). In the thrusting process ST7A, the cutter holder 31 is in the rotation regulating state. Therefore, the cutter blade 8 does not rotate with respect to the unit frame 32.

In the oblique cutting process ST8A, the medium 2 is cut by relatively moving the cutter blade 8 toward the downstream side and the left side in the conveyance direction with respect to the medium 2 with the thrusting spot SP3A as a starting point (see FIG. 16 (C)). Specifically, in the oblique cutting process ST8, the medium 2 is cut by moving the cutter unit 9 leftward at a predetermined speed while conveying the upstream medium 2c toward the conveyance direction upstream side at a predetermined speed. In the oblique cutting process ST8A, the medium 2 is linearly cut from the thrusting spot SP3A to the right end of the cutting position in the oblique cutting process ST6A.

In the oblique cutting process ST8A, the cutter holder 31 is in a rotatable state. Thus, the cutter blade 8 is rotatable with respect to the unit frame 32. In the oblique cutting process ST8A, the cutter blade 8 rotates with respect to the unit frame 32 so that the relative movement direction of the cutter blade 8 with respect to the medium 2 coincides with the width direction of the cutter blade 8, and then relatively moves to the medium 2 while maintaining a state in which the relative movement direction of the cutter blade 8 with respect to the medium 2 coincides with the width direction of the cutter blade 8.

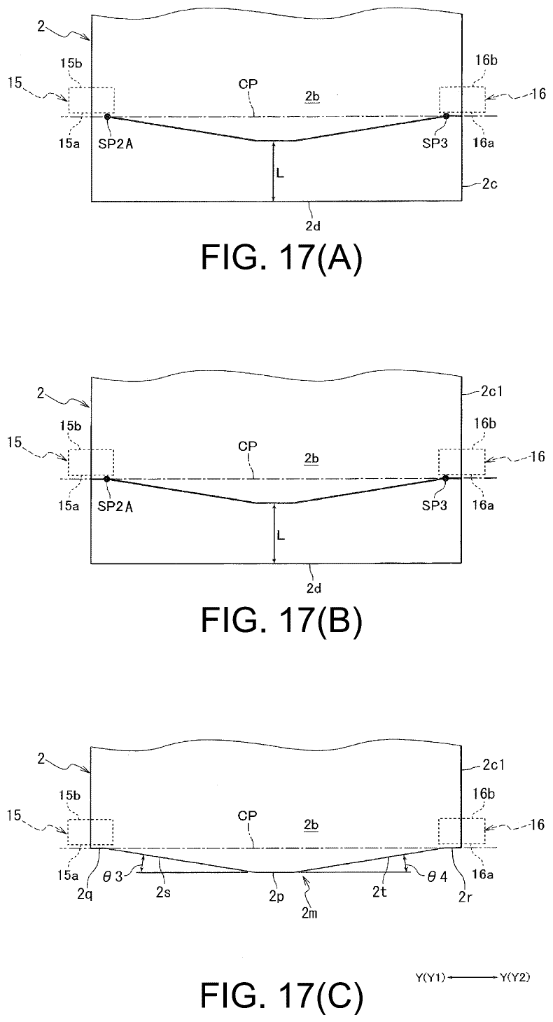

In the lateral cutting process ST9A, the cutter blade 8 is moved to the right side with respect to the medium 2 with the thrusting spot SP3A as a starting point, and the medium 2 is cut in the left-right direction from the thrusting spot SP3A to the right end surface of the medium 2 (see FIG. 17(A)). Specifically, in the lateral cutting process ST9A, the medium 2 is cut by moving the cutter unit 9 toward the right side with the upstream medium 2c stopped. In the lateral cutting process ST9A, the cutter holder 31 is in the rotation regulating state. Therefore, the cutter blade 8 does not rotate with respect to the unit frame 32. After the oblique cutting process ST8A and before the lateral cutting process ST9A, the medium 2 is conveyed toward the conveyance direction downstream side by the same amount as the conveyance amount of the medium 2 in the oblique cutting process ST8A.

In the lateral cutting process ST10A, the cutter blade 8 is moved toward the left side with respect to the medium 2 with the thrusting spot SP2A as a starting point, and the medium 2 is cut in the left-right direction from the thrusting spot SP2A to the left end surface of the medium 2 (see FIG. 17(B)). Specifically, in the lateral cutting process ST10A, the medium 2 is cut by moving the cutter unit 9 toward the left side with the upstream medium 2c stopped. In the lateral cutting process ST10A, the cutter holder 31 is in the rotation regulating state. Therefore, the cutter blade 8 does not rotate with respect to the unit frame 32. In the lateral cutting processes ST9A and ST10A, the cutter unit 9 may be reciprocated in the left-right direction in order to reliably cut the medium 2. In this case, the cutter unit 9 may be reciprocated a plurality of times in the left-right direction.

The thrusting process ST5A corresponds to the first thrusting process. The oblique cutting process ST6A corresponds to the first oblique cutting process. The thrusting process ST7A corresponds to the second thrusting process. The oblique cutting process ST8A corresponds to the second oblique cutting process. The lateral cutting process ST10A corresponds to the first lateral cutting process, and is performed after the first oblique cutting process and the second oblique cutting process. The lateral cutting process ST9A corresponds to the second lateral cutting process, and is performed after the first oblique cutting process and the second oblique cutting process and before the first lateral cutting process. The thrusting spot SP2A corresponds to the first thrusting spot. The thrusting spot SP3 corresponds to the second thrusting spot.

The thrusting process ST5A, the oblique cutting process ST6A, the thrusting process ST7A, the oblique cutting process ST8A, and the lateral cutting processes ST9A and ST10A constitute a convex cutting process ST12A. After the medium conveyance process ST4A, the convex cutting process ST12A moves the cutter 8 in the left-right direction and conveys the medium 2 to cut the medium 2 in the entire region in the left-right direction. When the convex cutting process ST12A is completed, the medium 2 is separated at the cutting position of the medium 2 in the convex cutting process ST12A. When the medium 2 (upstream medium 2c) disposed on the further conveyance direction upstream side than the cutting position is defined as an upstream medium 2cl in the medium 2 (upstream medium 2c) in the convex cutting process ST12A, the end surface on the conveyance direction downstream side of the upstream medium 2cl has a trapezoidal convex shape. In the following description, the end surface on the conveyance direction downstream side of the upstream medium 2e when the convex cutting process ST12A is completed is referred to as a second end surface 2m. The upstream medium 2cl corresponds to the first upstream medium.

As illustrated in FIG. 17(C), the second end surface 2m includes three end surfaces 2p, 2q, and 2r parallel to the left-right direction, a linear end surface 2s inclined toward the conveyance direction downstream side toward the right side, and a linear end surface 2t inclined toward the conveyance direction downstream side toward the left side. The end surface 2p constitutes a central portion of the second end surface 2m in the left-right direction. The end surface 2q constitutes a left end portion of the second end surface 2m. The end surface 2r constitutes a right end portion of the second end surface 2m. One end of the end surface 2s is connected to the left end of the end surface 2p, and the other end of the end surface 2s is connected to the right end of the end surface 2q. One end of the end surface 2t is connected to the right end of the end surface 2p, and the other end of the end surface 2t is connected to the left end of the end surface 2r.

As illustrated in FIG. 17(C), the cutting angle (that is, the inclination angle of the end surface 2s with respect to the end surface 2p) of the medium 2 with respect to the end surface 2p in the oblique cutting process ST6A is set to θ3. The cutting angle (that is, the inclination angle of the end surface 2t with respect to the end surface 2p) of the medium 2 with respect to the end surface 2p in the oblique cutting process ST8A is set to θ4. These cutting angles θ3 and 04 are equal. Therefore, the second end surface 2m has an isosceles trapezoidal shape. The cutting angles θ3 and θ4 are set to 7° to 13°. More specifically, the cutting angles θ1 and θ2 are preferably set to 8° to 12°. In the present example embodiment, a case where the cutting angles θ1 and θ2 are set to 10° is exemplified.

The cutting angles θ3 and θ4 are constant regardless of the width of the medium 2 to be cut. That is, even when the width dimension of the medium 2 to be cut varies, the cutting angles θ3 and θ4 are 10°. For example, even when the width dimension of the medium 2 to be cut is 1600 mm, the cutting angles θ3 and θ4 are 10°, and even when the width dimension of the medium 2 to be cut is 1000 mm, the cutting angles θ3 and θ4 are 10°. The thrusting spot SP2A and the thrusting spot SP3A are formed at the same position in the medium conveyance direction, and the distance from the left end surface of the upstream medium 2c to the thrusting spot SP2 is equal to the distance from the right end surface of the upstream medium 2c to the thrusting spot SP3. Therefore, the end surface 2s and the end surface 2t are formed symmetrically.

As illustrated in FIG. 17(A), the first medium guide 15 and the second medium guide 16 are disposed at the same position in the medium conveyance direction. A conveyance direction downstream end 15a of the first medium guide 15 and a conveyance direction downstream end 16a of the second medium guide 16 are disposed on the conveyance direction upstream side of the cutter blade position CP in the conveyance direction. That is, the conveyance direction downstream end 15a of the first medium guide 15 and the conveyance direction downstream end 16a of the second medium guide 16 are disposed on the conveyance direction upstream side of the blade edge of the cutter blade 8.

A conveyance direction upstream end 15b of the first medium guide 15 is disposed on the conveyance direction upstream side of the thrusting spot SP2A when the oblique cutting process ST6A is completed. A conveyance direction upstream end 16b of the second medium guide 16 is disposed on the conveyance direction upstream side of the thrusting spot SP3A when the oblique cutting process ST8A is completed.

The cutting angle θ3 is set such that the thrusting spot SP2 when the oblique cutting process ST6 is completed is located on the conveyance direction downstream side of the conveyance direction upstream end 15b of the first medium guide 15. The cutting angle θ4 is set such that the thrusting spot SP3 when the oblique cutting process ST8A is completed is located on the conveyance direction downstream side of the conveyance direction upstream end 16b of the second medium guide 16.

The second end surface 2m of the upstream medium 2cl after cutting the medium 2 performed before the replacement of the medium 2 has a convex shape forming a trapezoidal shape. Therefore, when once detached from the printing apparatus 1A and then attached to the printing apparatus 1A again, the region around the end surface 2p of the upstream medium 2cl is fixed to the paper tube 26.

As described above, the medium 2 may come into contact with the carriage 7 due to the curling tendency of the medium 2, so that the shape of the cut portion of the medium 2 may not be stable (see two-dot chain line in FIG. 13).

Therefore, in the first modification, in the medium conveyance process ST4A, the medium 2 is conveyed by a certain amount toward the conveyance direction downstream side in consideration of the region where the curling tendency appears. Specifically, in the medium conveyance process ST4A, the medium 2 is conveyed to a position where a predetermined interval L is formed between the first end surface 2d, which is the conveyance direction downstream end of the upstream medium 2c, and the end surface 2p, which is the conveyance direction downstream end of the upstream medium 2cl (see FIG. 17(B)). That is, in the medium conveyance process ST4, the medium 2 is conveyed so that the predetermined interval L is formed between the conveyance direction downstream end of the medium 2 and the conveyance direction downstream end of the upstream medium 2e before the convex cutting process ST12.

As illustrated in FIG. 13, this interval L is a distance until the maximum distance D1 (distance in the up-down direction between the highest spot of the medium 2 in the portion disposed on the lower side of the head 6 in the convex cutting process ST12 and the upper surface of the platen 18) in the up-down direction between the portion of the medium 2 disposed on the lower side of the head 6 in the convex cutting process ST12A and the upper surface of the platen 18 becomes smaller than the distance (head gap) D2 in the up-down direction between the lower end surface of the head 6 and the upper surface of the platen 18 (D1<D2).

As a result, even if the medium 2 has a curling tendency, the maximum distance D1 becomes smaller than the distance D2. In the present example embodiment, the interval L is set to 100 mm. In the medium conveyance process ST4A, if the interval L of 100 mm is formed between the first end surface 2d and the end surface 2p, it is possible to reduce the contact of the medium 2 with the lower end surface of the head 6 even if the medium 2 has a curling tendency. The conveyance distance of the medium 2 in the medium conveyance process ST4A is constant regardless of whether the medium 2 has a curling tendency. The conveyance distance of the medium 2 in the medium conveyance process ST4 is constant regardless of the strength of the curling tendency of the medium 2. The distance D2 is set to about 2 mm.

The linear cutting process ST11A, the medium conveyance process ST4A, and the convex cutting process ST12A are automatically and continuously performed. In the printing apparatus 1A, the control unit 14 stores a control program for continuously executing the linear cutting process ST11A, the medium conveyance process ST4A, and the convex cutting process ST12A. Based on this control program, the control unit 14 continuously executes these processes. For example, when replacement of the medium 2 becomes necessary and the operator of the printing apparatus 1 presses a predetermined operation button, the control unit 14 continuously executes these steps. That is, when the operator presses the operation button, the control unit 14 sequentially executes the linear cutting process ST11, the medium conveyance process ST4, and the convex cutting process ST12 in this order.

In the medium cutting method according to the first modification, the step of executing the linear cutting process ST11A constitutes a linear cutting step. In the linear cutting step, the cutter blade 8 is moved in the left-right direction by the carriage driving mechanism 11 with the medium 2 stopped to cut the medium 2 in the entire region in the left-right direction. The step of executing the medium conveyance process ST4A constitutes a medium conveyance step. In the medium conveyance step, after the linear cutting step, the medium 2 is conveyed by a predetermined amount toward the conveyance direction downstream side by the medium conveyance mechanism 10. In the medium conveyance step, the medium 2 is conveyed to a position where a predetermined interval L is formed between the first end surface 2d and the end surface 2p. The step of executing the convex cutting process ST12A constitutes a convex cutting step. In the convex cutting step, after the medium conveyance step, the cutter blade 8 is moved in the left-right direction by the carriage driving mechanism 11, and the medium 2 is conveyed by the medium conveyance mechanism 10 to cut the medium 2 in the entire region in the left-right direction.

In the medium cutting method according to the first modification, in the medium conveyance process ST4A after the linear cutting process ST11A of cutting the medium 2 in the entire region in the left-right direction so that the first end surface 2d of the upstream medium 2c becomes a linear shape parallel to the left-right direction and before the convex cutting process ST12A of cutting the medium 2 in the entire region in the left-right direction so that the second end surface 2m of the upstream medium 2cl becomes a convex shape forming a trapezoidal shape, the medium 2 is conveyed toward the conveyance direction downstream side to the position where the predetermined interval L is formed between the conveyance direction downstream side of the upstream medium 2c and the conveyance direction downstream end of the upstream medium 2c1.

Thus, before the convex cutting process ST12 is performed, the distance between the first end surface 2d of the upstream medium 2c and the cutter unit 9 in the medium conveyance direction can be increased. Therefore, even if the curling tendency of the medium 2 becomes strong, the floating of the medium 2 from the platen 18 at the arrangement position of the cutter unit 9 in the medium conveyance direction can be reduced when the convex cutting process ST12A is performed. As a result, even if the curling tendency of the medium 2 becomes strong, one end portion in the longitudinal direction of the medium 2 can be appropriately cut so that the end surface of the medium 2 becomes a convex shape forming a trapezoidal shape after the medium 2 is cut in a straight line parallel to the left-right direction over the entire region in the left-right direction before the medium 2 is replaced.

Furthermore, in the medium conveyance process ST4A, the medium 2 is conveyed to a position where the maximum distance D1 in the up-down direction between the portion of the medium 2 disposed on the lower side of the head 6 in the convex cutting process ST12A and the upper surface of the platen 18 is smaller than the distance D2 in the up-down direction between the lower end surface of the head 6 and the upper surface of the platen 18. Thus, even if the curling tendency of the medium 2 becomes strong, the contact between the head 6 moving in the left-right direction and the medium 2 can be reduced when the convex cutting process ST12A is performed. Therefore, even if the curling tendency of the medium 2 becomes strong, the one end portion in the longitudinal direction of the medium 2 can be reliably cut so that the end surface of the medium 2 becomes a convex shape forming a trapezoidal shape, and the contact between the medium 2 and the head 6 can be reduced.

In the medium conveyance process ST4A, if the medium 2 is not conveyed toward the conveyance direction downstream side to a position where the interval L is formed between the conveyance direction downstream side of the upstream medium 2c and the conveyance direction downstream end of the upstream medium 2c1, the medium 2 having a strong curling tendency may greatly float from the platen 18. When the medium 2 having a stronger curling tendency greatly floats from the platen 18, for example, as indicated by a two-dot chain line in FIG. 13, the maximum distance D1 in the up-down direction between the medium 2 and the upper surface of the platen 18 becomes larger than the distance D2, and the head 6 and the carriage 7 come into contact with the medium 2 in the convex cutting process ST12A.

The lateral cutting processes ST9A and ST10A are performed after the oblique cutting processes ST6A and ST8A, and even when the oblique cutting processes ST6A and ST8A are completed, the medium 2 is not completely cut in the left-right direction, and the medium 2 on the conveyance direction upstream side and the medium 2 on the conveyance direction downstream side are connected on both sides in the left-right direction. Thus, the medium 2 on the conveyance direction downstream side can be reduced from being torn by the gravity acting on the medium 2 on the conveyance direction downstream side during the oblique cutting process ST8A.

The lateral cutting process ST9A is performed before the lateral cutting process ST10A. In this case, the medium 2 on the conveyance direction downstream side may be torn and dropped by gravity acting on the medium 2 on the conveyance direction downstream side during the lateral cutting process ST10A. However, even if the medium 2 on the conveyance direction downstream side is torn and dropped during the lateral cutting process ST10A, the medium 2 on the conveyance direction downstream side, which is torn and dropped, drops while moving to the left. Therefore, it is possible to reduce the contact between the head 6 disposed on the right side of the cutter unit 9 and the medium 2 on the conveyance direction downstream side that is torn and dropped. As a result, it is possible to reduce the contact between the head 6 and the medium 2 on the conveyance direction downstream side that is torn and dropped.

A conveyance direction upstream end 15b of the first medium guide 15 is disposed on the conveyance direction upstream side of the thrusting spot SP2A when the oblique cutting process ST6A is completed. Thus, when the medium 2 is conveyed toward the conveyance direction downstream side after the oblique cutting process ST6A and before the thrusting process ST7A, it is possible to reduce the portion of the medium 2 cut in the oblique cutting process ST6A from being caught by the conveyance direction upstream end 15b of the first medium guide 15. Similarly, the conveyance direction upstream end 16b of the second medium guide 16 is disposed on the conveyance direction upstream side with respect to the thrusting spot SP3A when the oblique cutting process ST8A is completed. Thus, when the medium 2 is conveyed toward the conveyance direction downstream side after the oblique cutting process ST8A and before the lateral cutting process ST9A, it is possible to reduce the portion of the medium 2 cut in the oblique cutting process ST8A from being caught by the conveyance direction upstream end 16b of the second medium guide 16.

The conveyance amount of the medium 2 to the conveyance direction upstream side when the oblique cutting process ST6A is performed is equal to the conveyance amount of the medium 2 to the conveyance direction upstream side when the oblique cutting process ST8A is performed. Thus, when the medium 2 is conveyed toward the conveyance direction downstream side after the oblique cutting process ST6 and before the lateral cutting process ST9, it is possible to reduce the portion of the medium 2 cut in the oblique cutting process ST8A from being caught by the conveyance direction upstream end 15b of the first medium guide 15. Therefore, the medium 2 can be appropriately conveyed.

The cutting angles θ3 and θ4 of the medium 2 with respect to the left-right direction in the oblique cutting processes ST6A and ST8A are constant regardless of the width of the medium 2 to be cut. Thus, in the oblique cutting processes ST6A and ST8A, the rotation angle of the cutter holder 31 with respect to the unit frame 32 is constant regardless of the width of the medium 2 to be cut. This makes it possible to reduce excessive rotation of the cutter holder 31 with respect to the unit frame 32 in the oblique cutting processes ST6A and ST8A.

### Second Modification

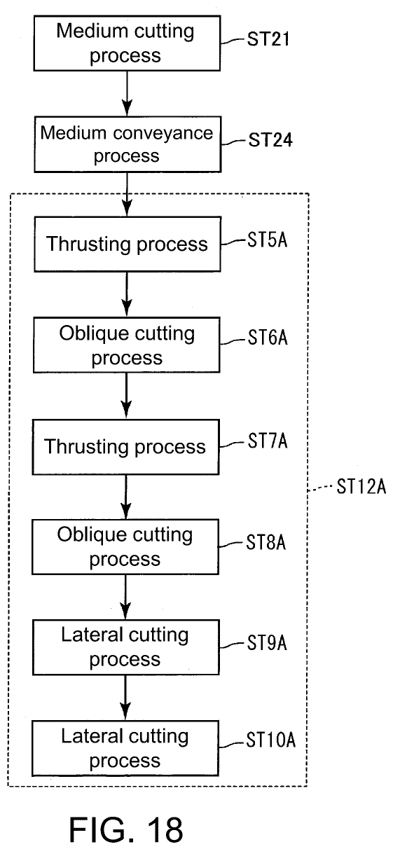

FIG. 18 is a flowchart for explaining a cutting procedure of the medium 2 according to a second modification. In the second modification, a case of cutting the medium 2 using the printing apparatus 1A of the first modification will be described as an example.

In the medium cutting method according to the second modification, the linear cutting process ST11A (see FIG. 14) is performed on the medium 2 before replacement, and the convex cutting process ST12A is performed on another medium 2′ after replacement. When the linear cutting process ST11A (see FIG. 14) for the medium 2 before replacement is completed, the medium 2 is removed from the printing apparatus 1A. The medium 2 once removed from the printing apparatus 1A has a linear end surface parallel to the left-right direction on the conveyance direction downstream side. In the following description, a case where the medium 2 once removed from the printing apparatus 1A is attached again will be described as an example. Note that a new medium 2′ may be attached to the printing apparatus 1A. Also in the new medium 2′, the end surface on the conveyance direction downstream side of the medium 2′ is linear parallel to the left-right direction.

As illustrated in FIG. 18, the cutting method of the medium 2 according to the second modification includes a medium setting process ST21 of setting the medium 2 wound in a roll shape in the medium feeding mechanism 12, a medium conveyance process ST24 of conveying the medium 2 by a predetermined amount toward the conveyance direction downstream side after the medium setting process ST21, and a convex cutting process ST12A of moving the cutter blade 8 in the left-right direction and conveying the medium 2 to cut the medium 2 in the entire region in the left-right direction after the medium conveyance process ST24. In the second modification, the cutting process of the medium 2 performed on the medium 2 after replacement includes the medium setting process ST21, the medium conveyance process ST24, and the convex cutting process ST12A.

In the medium setting process ST21, the feed roll 23 is set in the medium feeding mechanism 12, and the end portion on the conveyance direction downstream side of the medium 2 is sandwiched between the conveyance roller 19 and the pad roller 20. In the medium conveyance process ST24, the medium 2 is conveyed to a position where a predetermined interval L is formed between the conveyance direction downstream end of the medium 2 before the convex cutting process ST12A and the conveyance direction downstream end of the upstream medium 2cl (see FIG. 17). Specifically, in the medium conveyance process ST24, even if the medium 2 has a curling tendency, the medium 2 is conveyed to a position where the maximum distance D1 is smaller than the distance D2 (see FIG. 13). In the convex cutting process ST12B, the medium 2 is cut in the entire region in the left-right direction so that the second end surface 2m of the upstream medium 2cl becomes a convex shape forming a trapezoidal shape.

When the convex cutting process ST12A is completed, the medium 2 is conveyed toward the conveyance direction downstream side by a predetermined amount. Then, the operator fixes the end portion on the conveyance direction downstream side of the medium 2 to the paper tube 26 with the tape 27. Thereafter, printing of the medium 2 is performed. That is, the printing of the medium 2 by the printing mechanism 3 is not performed after the medium conveyance process ST24 and before the convex cutting process ST12A, and the printing of the medium 2 by the printing mechanism 3 is performed after the convex cutting process ST12A.

Although not illustrated, after the printing is completed, the linear cutting process ST11A (see FIG. 14) of cutting a portion on the conveyance direction upstream side of the printed portion is performed on the medium 2.

The medium conveyance process ST24 and the convex cutting process ST12 are automatically and continuously performed. The control unit 14 stores a control program for continuously executing the medium conveyance process ST24 and the convex cutting process ST12A. Based on this control program, the control unit 14 continuously executes these processes. For example, when the operator of the printing apparatus 1A presses a predetermined operation button after the medium setting process ST21 is completed, the control unit 14 continuously executes these processes. That is, when the operator presses the operation button, the control unit 14 sequentially executes the medium conveyance process ST24, and the convex cutting process ST12A in this order.

In the medium cutting method according to the second modification, the step of executing the medium conveyance process ST24 constitutes a medium conveyance step. In the medium conveyance step, after the medium 2 wound in a roll shape is set in the medium feeding mechanism 12, the medium 2 is conveyed by a predetermined amount toward the conveyance direction downstream side by the medium conveyance mechanism 10. In the medium conveyance step, the medium 2 is conveyed to a position where a predetermined interval L is formed between the conveyance direction downstream end of the medium 2 and the conveyance direction downstream end of the upstream medium 2c1. The step of executing the convex cutting process ST12A constitutes a convex cutting step. In the convex cutting step, after the medium conveyance step, the cutter blade 8 is moved in the left-right direction by the carriage driving mechanism 11, and the medium 2 is conveyed by the medium conveyance mechanism 10 to cut the medium 2 in the entire region in the left-right direction. After the medium conveyance step and before the convex cutting step, the printing of the medium 2 by the printing mechanism 3 is not performed, and the printing of the medium 2 by the printing mechanism 3 is performed after the convex cutting step.

This makes it possible to increase the distance in the medium conveyance direction between the conveyance direction downstream end of the medium 2 and the cutter unit 9 before the convex cutting process ST12A is performed. Therefore, even if the curling tendency of the medium 2 becomes strong, the floating of the medium 2 from the platen 18 at the arrangement position of the cutter unit 9 in the medium conveyance direction can be reduced when the convex cutting process ST12A is performed. As a result, even if the curling tendency of the medium 2 becomes strong, one end portion in the longitudinal direction of the medium 2 can be appropriately cut so that the end surface of the medium 2 becomes a convex shape forming a trapezoidal shape after the medium 2 is replaced.

### Third Modification

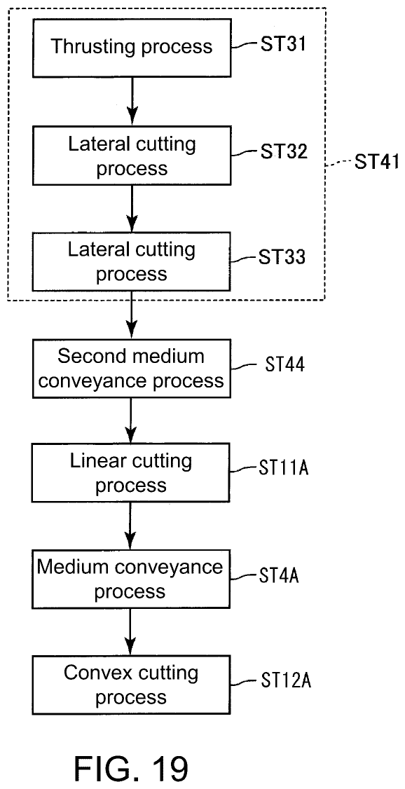

FIG. 19 is a flowchart for explaining a cutting procedure of the medium 2 according to the third modification.

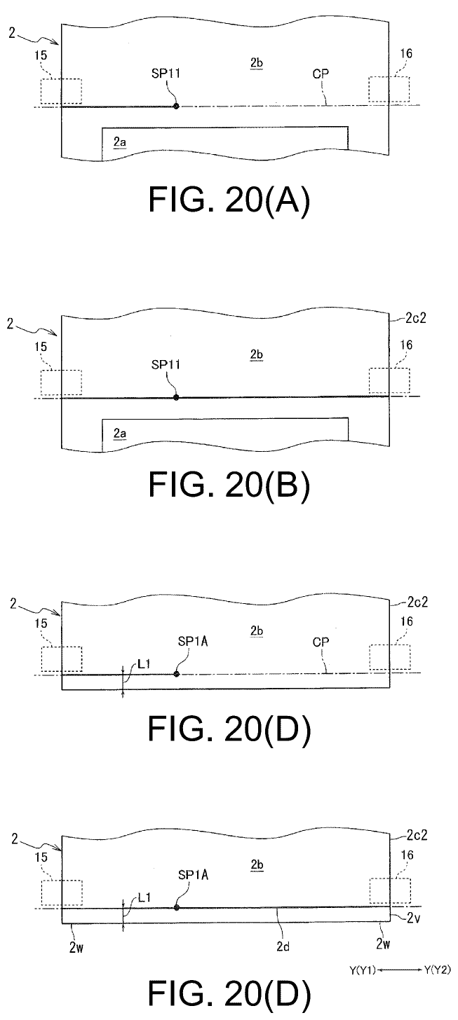

FIG. 20 is a diagram for explaining a cutting method of the medium 2 cut by the cutting procedure of the medium 2 illustrated in FIG. 19.

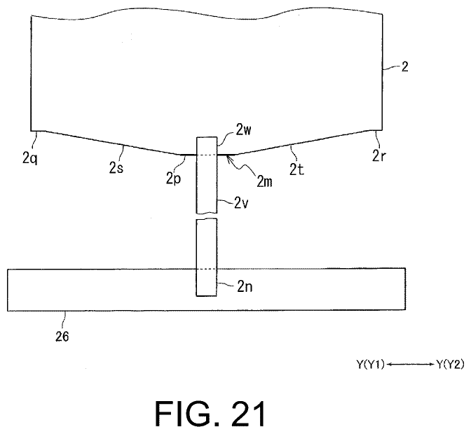

FIG. 21 is a diagram for explaining a connection method of connecting the end portion on the conveyance direction downstream side of the medium 2 and the paper tube 26 using the downstream medium 2t formed by being cut by the cutting procedure of the medium 2 illustrated in FIG. 19.

In the medium cutting method according to the third modification, a second linear cutting process ST41 of moving the cutter blade 8 in the left-right direction with the medium 2 stopped with respect to the medium 2 before replacement to cut the medium 2 in the entire region in the left-right direction, and a second medium conveyance process ST44 of conveying the medium 2 by a predetermined amount toward the conveyance direction downstream side after the second linear cutting process ST41 are performed. As illustrated in FIG. 19, the second linear cutting process ST41 and the second medium conveyance process ST44 are performed before the linear cutting process ST11A. That is, the linear cutting process ST11A is performed after the second medium conveyance process ST44.

The second linear cutting process ST41 includes a thrusting process ST31 corresponding to the thrusting process ST1A (see FIG. 14), a lateral cutting process ST32 corresponding to the lateral cutting process ST2A (see FIG. 14), and a lateral cutting process ST33 corresponding to the lateral cutting process ST3A (see FIG. 14).

In the thrusting process ST31, the cutter blade 8 is thrust at an intermediate position of the medium 2 in the left-right direction (see FIG. 20(A)). In the lateral cutting process ST32, the medium 2 is cut by moving the cutter blade 8 toward the left side up to the left end surface of the medium 2 with the thrusting spot SP11 as a starting point, which is the spot thrust by the cutter blade 8 in the thrusting process ST31 (see FIG. 20(A)). In the lateral cutting process ST33, the medium 2 is cut by moving the cutter blade 8 toward the right side from the thrusting spot SP11 as a starting point to the right end surface of the medium 2 (see FIG. 20(B)).

When the second linear cutting process ST41 is completed, the medium 2 is separated at the cutting position of the medium 2 in the second linear cutting process ST41. Assuming the medium 2 disposed on the conveyance direction upstream side with respect to the cutting position of the medium 2 in the second linear cutting process ST41 as an upstream medium 2c2, the end surface on the conveyance direction downstream side of the upstream medium 2c2 has a linear shape parallel to the left-right direction. In the printing apparatus 1A, the medium 2 is printed by the head 6 before the second linear cutting process ST41. In the second linear cutting process ST41, a portion of the medium 2 on the conveyance direction upstream side of the printed portion (that is, the printed portion 2a) is cut.

In the second medium conveyance process ST44, the medium 2 is conveyed by a predetermined amount toward the conveyance direction downstream side after the second linear cutting process ST41. Specifically, in the second medium conveyance process ST44, the medium 2 is conveyed toward the conveyance direction downstream side to a position where a predetermined interval L1 is formed between the end surface on the conveyance direction downstream side of the upstream medium 2c2 and the first end surface 2d of the upstream medium 2c described above. For example, in the second medium conveyance process ST44, the medium 2 is conveyed toward the conveyance direction downstream side to a position where the interval L1 of about 30 mm to 100 mm is formed between the end surface on the conveyance direction downstream side of the upstream medium 2c2 and the first end surface 2d.

That is, assuming that the medium 2 disposed on the conveyance direction downstream side of the cutting position in the linear cutting process ST11A performed thereafter is a downstream medium 2v, in the second medium conveyance process ST44, when the linear cutting process ST11A is completed, the medium 2 is conveyed toward the conveyance direction downstream side by a predetermined amount so that the belt-like downstream medium 2v having a predetermined width of about 30 mm to 100 mm is formed. The width of the medium 2 is, for example, about 1000 mm to 1600 mm.

In the subsequent linear cutting process ST11A, the medium 2 is cut. Specifically, first, in the thrusting process ST1A, the cutter blade 8 is thrust into the thrusting spot SP1A between both end portions of the medium 2 in the left-right direction. Next, in the lateral cutting process ST2A, the medium 2 is cut by moving the cutter blade 8 toward the left side from the thrusting spot SP1A as a starting point to the left end surface of the medium 2 (see FIG. 20(C)). Thereafter, in the lateral cutting process ST3A, the medium 2 is cut by moving the cutter blade 8 toward the right side from the thrusting spot SP1A as a starting point to the right end surface of the medium 2 (see FIG. 20(D)). When the linear cutting process ST11A is completed, the downstream medium 2v is formed. The downstream medium 2v is formed in a belt shape.

In the third modification, a belt-like downstream medium 2v is used instead of the tape 27, and the end portion on the conveyance direction downstream side of the medium 2 after replacement is connected to the paper tube 26.

As illustrated in FIG. 21, specifically, a straight line along the longitudinal direction of the belt-like downstream medium 2v is provided in a direction along the conveyance direction. Both end portions 2w and 2w of the downstream medium 2 in the longitudinal direction are fixed to the medium 2 and the paper tube 26 with tapes (not illustrated).

The medium winding mechanism 13 is disposed below the printing mechanism 3. Here, as the distance between the printing mechanism 3 and the paper tube 26 in the medium conveyance direction becomes longer, the medium 2 needs to be pulled out more in order to be connected to the paper tube 26. Since printing is not performed on the medium 2 drawn out to be connected to the paper tube 26, loss of the medium 2 occurs.

Therefore, as shown in the third modification, the belt-like downstream medium 2v is used to connect the end portion on the conveyance direction downstream side of the medium 2 and the paper tube 26. As a result, even if the distance between the printing mechanism 3 and the paper tube 26 becomes long, the medium 2 itself does not need to be pulled out greatly, so the loss can be reduced.

In the second modification (see FIG. 18), as in the third modification, the cutting method of the medium 2 performed on the medium 2 before replacement may include the second linear cutting process ST41 and the second medium conveyance process ST44. Specifically, before the linear cutting process ST11A performed after completion of printing, the second linear cutting process ST41 and the second medium conveyance process ST44 are performed. In the second modification, a belt-like portion corresponding to the downstream medium 2v may be formed after the medium setting process ST21 and before the medium conveyance process ST24. In this case, the cutting method of the medium 2 carried out with respect to the medium 2 after the replacement includes a cutting process of moving the cutter blade 8 in the left-right direction in a state where the medium 2 is stopped and cutting the medium 2 in the entire region in the left-right direction.

The medium end connection method described in the third modification will be described below.

A medium end connection method is to connect the end portion of the medium on the conveyance direction downstream side in a medium cutting device including: a cutter unit having a cutter blade for cutting a long medium; a medium conveyance mechanism that conveys the medium in a longitudinal direction of the medium; a cutter unit driving mechanism that moves the cutter unit in a width direction of the medium orthogonal to a longitudinal direction of the medium and a thickness direction of the medium; and, in which when an upstream side in a conveyance direction of the medium by the medium conveyance mechanism is defined as a conveyance direction upstream side and a downstream side in a conveyance direction of the medium is defined as a conveyance direction downstream side, a medium winding mechanism that rotates a winding paper tube to which an end portion on the conveyance direction downstream side of the medium is connected to wind the medium around the paper tube, and connects the end portion on the conveyance direction downstream side of the medium to the paper tube.

The medium end connection method includes a cutting process of cutting the medium in an entire region in a width direction of the medium so as to form a belt-like portion having a predetermined width in a conveyance direction of the medium; and
a connecting process of fixing one end portion in a longitudinal direction of the belt-like portion to an end portion on a downstream side in a conveyance direction of the medium, fixing anther end portion in the longitudinal direction of the belt-like portion to the paper tube, and connecting the end portion on the conveyance direction downstream side of the medium to the paper tube.

If the end portion on the conveyance direction downstream side of the medium is connected to the paper tube by the medium end connection method, for example, even if the distance in the conveyance direction of the medium between the paper tube and the processing mechanism for performing predetermined processing on the medium such as the printing mechanism that performs printing processing on the medium is long, the end portion on the conveyance direction downstream side of the medium disposed in the vicinity of the processing mechanism and the paper tube can be connected by the belt-like portion, and thus the processing of the medium can be performed with less loss by the processing mechanism. Therefore, even if the distance between the processing mechanism and the paper tube in the conveyance direction of the medium is long, the loss of the medium can be reduced. In this medium end connection method, the convex cutting process ST12A may not be performed.

As illustrated in FIG. 19, in the third modification, the second linear cutting process ST41, the second medium conveyance process ST44, and the linear cutting process ST11A constitute a cutting process of cutting the medium 2 in the entire region in the width direction (left-right direction) of the medium 2 so as to form a belt-like portion (that is, the downstream medium 2v) having a predetermined width in the medium conveyance direction. Further, in the third modification, the process of fixing one downstream medium end portion 2w to the end portion on the conveyance direction downstream side of the medium 2, fixing another end portion 2w of the downstream medium to the paper tube 26, and connecting the end portion on the conveyance direction downstream side of the medium 2 to the paper tube 26 is a connecting process of fixing one end portion in the longitudinal direction of the belt-like portion to the end portion on the conveyance direction downstream side of the medium 2, fixing another end portion in the longitudinal direction of the belt-like portion to the paper tube 26, and connecting the end portion on the conveyance direction downstream side of the medium 2 to the paper tube 26. Instead of the belt-like portion (downstream medium 2v), an elongated belt-like tape or the like may be used to connect the end portion on the conveyance direction downstream side of the medium 2 to the paper tube 26.

### Fourth Modification

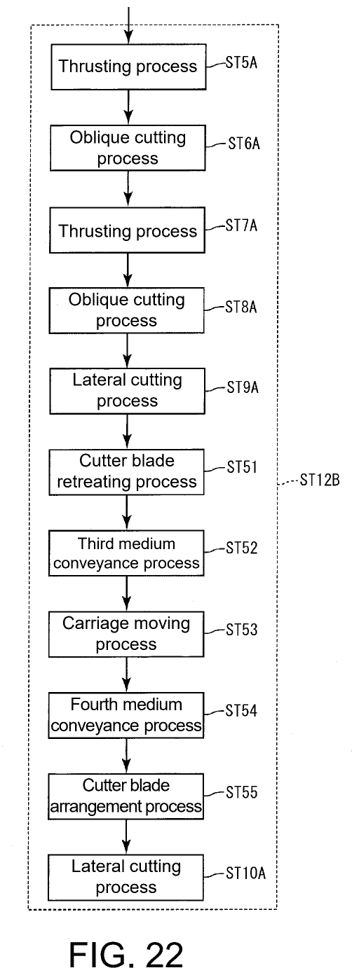

FIG. 22 is a flowchart for explaining a convex cutting process ST12B according to the fourth modification.

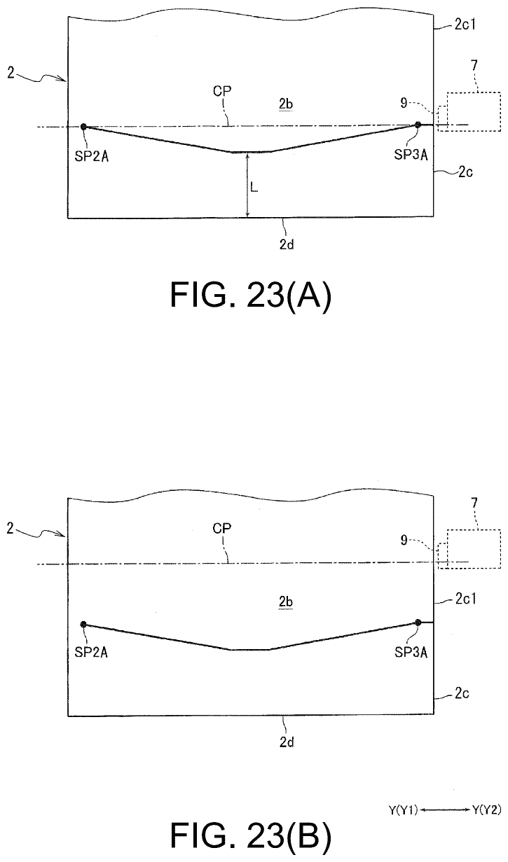

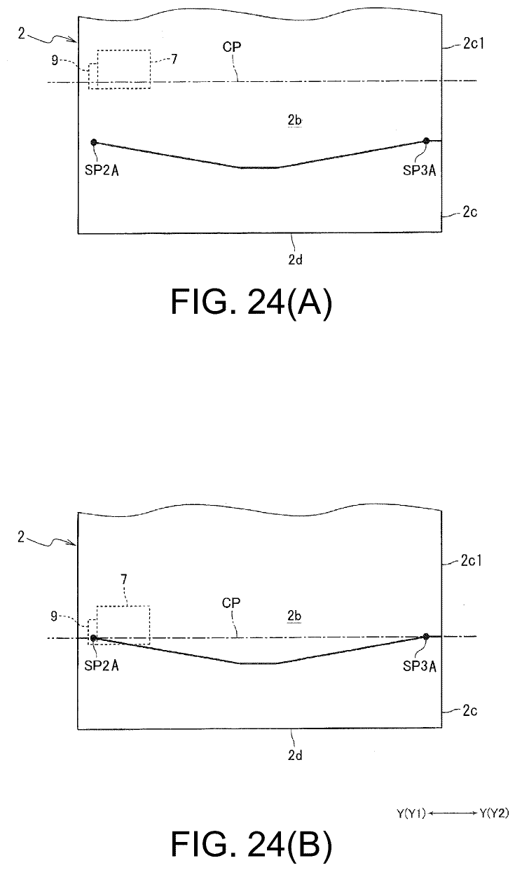

FIGS. 23 and 24 are diagrams for explaining a convex cutting process ST12B illustrated in FIG. 22.

If the curling tendency of the medium 2 becomes stronger in the cutting method shown in the first modification (FIG. 14), the floating of the portion of the upstream medium 2cl on the conveyance direction downstream side may become large even before the lateral cutting process ST10A is performed after the lateral cutting process ST9A. Then, after the lateral cutting process ST9A, the cutter unit 9 mounted on the carriage 7 moving toward the left side for performing the lateral cutting process ST10A comes into contact with the upstream medium 2cl, which may interfere with the movement of the carriage 7.

Therefore, in the convex cutting process ST12B according to the fourth modification, a cutter blade retreating process ST51, a third medium conveyance process ST52, a carriage moving process ST53, a fourth medium conveyance process ST54, and a cutter blade arrangement process ST55 are performed in this order.

In the cutter blade retreating process ST51, after the lateral cutting process ST9A, the cutter blade 8 disposed at the cuttable position (lowered position) where the medium 2 can be cut by the cutter blade 8 is moved to the retreating position (raised position) where the cutter blade 8 is not in contact with the medium 2.

The third medium conveyance process ST52 conveys the medium 2 toward the conveyance direction downstream side by a predetermined amount after the lateral cutting process ST9A (see FIG. 23(B)).

In the carriage moving process ST53, the carriage 7 is moved toward the left side until the blade edge of the cutter blade 8 is disposed at the same position as the thrusting spot SP2A in the left-right direction (see FIG. 24(A)).

As illustrated in FIG. 24(B), the fourth medium conveyance process ST54 conveys the medium 2 toward the conveyance direction upstream side until the blade edge of the cutter blade 8 is disposed at the same position as the thrusting spot SP2A in the medium conveyance direction (see FIG. 24(B)).

In the cutter blade arrangement process ST55, the cutter blade 8 disposed at the retreating position is moved to the cuttable position.

In this case, the lateral cutting process ST10A is performed after the cutter blade arrangement process ST55. When the lateral cutting process ST9A ends, the carriage 7 is disposed at a position illustrated in FIG. 23(A), for example. The cutter blade retreating process ST51 may be performed after the third medium conveyance process ST52.

In the third medium conveyance process ST52, the medium 2 is conveyed by a certain amount toward the conveyance direction downstream side. Specifically, in the third medium conveyance process ST52, the medium 2 is conveyed toward the conveyance direction downstream side to a position where the cutter unit 9 that moves toward the left side in the carriage moving process ST53 does not come into contact with the portion on the conveyance direction downstream side of the upstream medium 2cl even if the curling tendency of the medium 2 becomes strong and the floating of the portion on the conveyance direction downstream side of the upstream medium 2e becomes large after the lateral cutting process ST9A. For example, in the third medium conveyance process ST52, the medium 2 is conveyed by 80 mm toward the conveyance direction downstream side. In the fourth medium conveyance process ST54, the medium 2 is conveyed toward the conveyance direction upstream side by the same conveyance amount as the transport amount of the medium 2 in the third medium conveyance process ST52.

When the ultraviolet irradiating unit 29 is mounted on the left end portion of the carriage 7, if the curling tendency of the medium 2 becomes strong and the floating of the conveyance direction downstream side of the upstream medium 2cl is increased after the lateral cutting process ST9A, the ultraviolet irradiation unit 29 moving toward the left side in the carriage moving process ST53 is more likely to come into contact with the conveyance direction downstream side of the upstream medium 2cl. In this case, in the third medium conveyance process ST52, the medium 2 is conveyed to a position where the ultraviolet irradiating unit 29 moving toward the left side in the carriage moving process ST53 does not come into contact with the conveyance direction downstream side of the upstream medium 2c1.

In the fourth modification, the medium 2 is conveyed by the predetermined amount toward the conveyance direction downstream side in the third medium conveyance process ST52, and then the carriage 7 is moved toward the left side in the carriage moving process ST53. Therefore, even if the curling tendency of the medium 2 becomes stronger, the carriage 7 moved toward the left side for performing the lateral cutting process ST10A can be moved without any trouble after the lateral cutting process ST9A.

### Fifth Modification

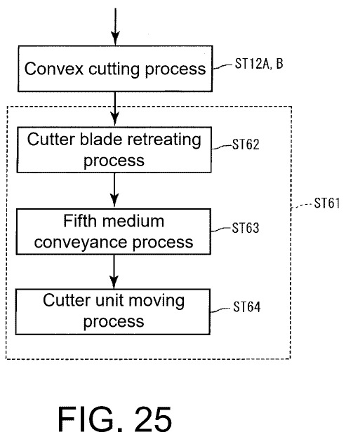

FIG. 25 is a flowchart for explaining a cutting method of the medium 2 according to the fifth modification.

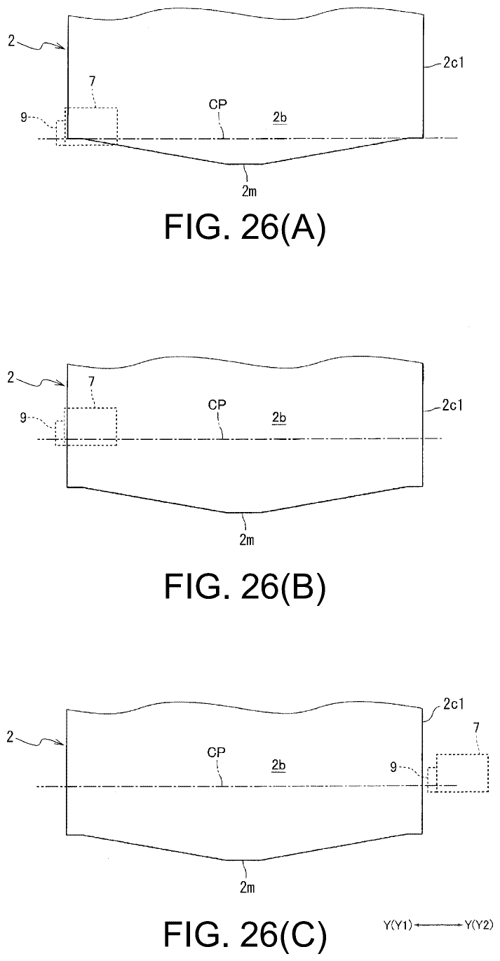

FIG. 26 is a diagram for explaining a cutting method of the medium 2 illustrated in FIG. 25.

In the medium cutting method according to the fifth modification, a standby position moving process ST61 of moving the carriage 7 and the cutter unit 9 to the standby position is included in the cutting method of the medium 2 after the convex cutting processes ST12A and 12B. That is, the carriage 7 and the cutter unit 9 may be moved to the standby position after the lateral cutting process ST10A. When the lateral cutting process ST10A is completed, the cutter blade 8 is disposed on the left side of the medium 2 (see FIG. 26(A)). Further, the carriage 7 and the cutter unit 9 disposed at the standby position are disposed on the right side of the medium 2.

In the standby position moving process ST61, after the lateral cutting process ST10A, the cutter blade 8 may be moved to the retreating position where the cutter blade 8 does not contact the medium 2, and then the carriage 7 and the cutter unit 9 may be moved toward the right side as they are to the standby position. However, when the lateral cutting process ST10A ends, the left end portion of the upstream medium 2e on the conveyance direction downstream side may be curled up. Therefore, if the cutter blade 8 is moved to the retreating position after the lateral cutting process ST10A is finished, and then the carriage 7 and the cutter unit 9 are moved toward the right side as they are to the standby position, the cutter unit 9 may come into contact with the curled portion of the left end portion of the upstream medium 2e, which may interfere with the movement of the carriage 7 and the cutter unit 9.

Therefore, in the fifth modification, the standby position moving process ST61 includes a cutter blade retreating process ST62 of moving the cutter blade 8 disposed at the cuttable position to the retreating position after the lateral cutting process ST10A, a fifth medium conveyance process ST63 of conveying the medium 2 by a predetermined amount toward the conveyance direction downstream side as illustrated in FIG. 26(B) after the lateral cutting process ST10, and a cutter unit moving process ST64A of moving the carriage 7 and the cutter unit 9 to the standby position as illustrated in FIG. 26(C) after the cutter blade retreating process ST62 and the fifth medium conveyance process ST63. The cutter blade retreating process ST62 is performed, for example, before the fifth medium conveyance process ST63. The cutter blade retreating process ST62 may be performed after the fifth medium conveyance process ST63.

In the fifth medium conveyance process ST63, the medium 2 is conveyed by a constant amount toward the conveyance direction downstream side. Specifically, in the fifth medium conveyance process ST63, even if the left end portion of the upstream medium 2e on the conveyance direction downstream side is turned up, the medium 2 is conveyed toward the conveyance direction downstream side to a position where the cutter unit 9 moving toward the right side in the cutter unit moving process ST64 does not contact the turning up portion on the left end side of the upstream medium 2e. In this modification, even if the left end side of the upstream medium 2e is turned up, the carriage 7 and the cutter unit 9 moving to the standby position can be moved without any trouble after the convex cutting processes ST12A and 12B.

The medium cutting method according to the present invention is not limited to that shown in the above-described first to fifth modifications. For example, after the thrusting process ST7A and the oblique cutting process ST8A are performed, the thrusting process ST5A and the oblique cutting process ST6A may be performed. The medium 2 may be cut linearly from the thrusting spot SP2A toward the obliquely right side in the obliquely cutting process ST6A, the medium 2 may be cut linearly from the thrusting spot SP3A toward the obliquely left side in the obliquely cutting process ST8A, and then the medium 2 may be cut linearly toward the left side (that is, in parallel with the left-right direction) to the right end of the cutting position in the obliquely cutting process ST6A.

The medium 2 may be cut linearly from the thrusting spot SP2A toward the obliquely right side in the obliquely cutting process ST6, and the medium 2 may be cut linearly from the thrusting spot SP3A toward the obliquely left side in the obliquely cutting process ST8 to the right end of the cutting position in the obliquely cutting process ST6. In this case, the second end surface 2m, which is an end surface on the conveyance direction downstream side of the upstream medium 2e, has a triangular convex shape (specifically, a convex shape having an isosceles triangle shape). That is, the end surface 2p is not formed on the second end surface 2m in this case, and the right end of the end surface 2s and the left end of the end surface 2t are connected.

The cutting angle θ3 and the cutting angle θ4 may be different. Furthermore, the thrusting spot SP2A and the thrusting spot SP3A may be shifted in the medium conveyance direction, or the distance in the left-right direction from the left end surface of the medium 2 to the thrusting spot SP2A and the distance in the left-right direction from the right end surface of the medium 2 to the thrusting spot SP3A may be different. Furthermore, the cutting angles θ3 and θ4 may vary according to the width of the medium 2 to be cut. For example, the cutting angles θ3 and θ4 may vary according to the width of the medium 2 to be cut so that the distance between the end surfaces 2q and 2r and the end surface 2p in the medium conveyance direction becomes constant regardless of the width of the medium 2 to be cut.

The lateral cutting process ST10A may be performed before the lateral cutting process ST9A. In this case, the convex cutting processes ST12A and B include a cutter blade retreating process of moving the cutter blade 8 disposed at the cuttable position to the retreating position after the lateral cutting process ST10A, a third medium conveyance process of conveying the medium 2 toward the conveyance direction downstream side by a predetermined amount after the lateral cutting process ST10A, a carriage moving process of moving the carriage 7 toward the right side until the blade edge of the cutter blade 8 is disposed at the same position as the thrusting spot SP3A in the left-right direction after the cutter blade retreating process and the third medium conveyance process, a fourth medium conveyance process of conveying the medium 2 toward the conveyance direction upstream side until the blade edge of the cutter blade 8 is disposed at the same position as the thrusting spot SP3 in the medium conveyance direction after the carriage moving process, and, a cutter blade arrangement process of moving the cutter blade 8 disposed at the retreating position to the cuttable position after the fourth medium conveyance process. In this case, the lateral cutting process ST9A is performed after the cutter blade arrangement process.

In this case, in the third medium conveyance process, even if the curling tendency of the medium 2 becomes strong and the floating of the portion on the conveyance direction downstream side of the upstream medium 2e becomes large after the lateral cutting process ST9A, the medium 2 is conveyed to a position where the carriage 7 moving toward the right side in the carriage moving process ST53 does not contact the portion on the conveyance direction downstream side of the upstream medium 2e. In this case, even if the curling tendency of the medium 2 becomes strong, the carriage 7 moving toward the right side for performing the lateral cutting process ST9A can be moved without any trouble after the lateral cutting process ST10A.

The lateral cutting process ST10A may be performed before the oblique cutting process ST6A, or the lateral cutting process ST9A may be performed before the oblique cutting process ST8A.

The convex cutting processes ST12A and B may not include the thrusting process ST7A and the lateral cutting processes ST9A and ST10A. In this case, for example, in the thrusting process ST5A, the cutter blade 8 is thrust at an intermediate position in the left-right direction of the medium 2, and in the oblique cutting process ST6A, the medium 2 is cut from the thrusting spot SP2 to the left end surface of the medium 2. In the oblique cutting process ST8A, the medium 2 is cut from the thrusting spot SP2 to the right end surface of the medium 2.

Further, the convex cutting processes ST12A and B may not include the thrusting processes ST5 and ST7A and the lateral cutting processes ST9A and ST10A. In this case, for example, in the oblique cutting process ST6A, the medium 2 is cut from the left end surface of the medium 2 to the intermediate position in the left-right direction, and in the oblique cutting process ST8A, the medium 2 is cut from the right end surface of the medium 2 to the right end of the cutting position in the oblique cutting process ST6A.

The linear cutting process ST11A, the medium conveyance process ST4A, and the convex cutting processes ST12A and B may not be performed automatically and continuously. For example, each process may be performed every time the operator presses a predetermined operation button. Each process may be performed while the operator manually operates the medium conveyance mechanism 10, the carriage driving mechanism 11, the up-down moving mechanism 33, the switching mechanism 34, and the like. Furthermore, in the second modification, the medium conveyance process ST24 and the convex cutting process ST12A may not be automatically and continuously performed.

As described above, the embodiment and the modification of the present invention have been described. The present invention is not limited only to the aspects of these embodiments and modifications. The above-described embodiments and modifications may be arbitrarily combined.

Although the embodiment of the present invention has been described above, the above embodiment merely shows one application example of the present invention, and the technical scope of the present invention is not intended to be limited to the specific configuration of the above embodiment. Modifications can be made as appropriate within the scope of the technical idea of the invention.

### REFERENCE SIGNS LIST

1, 1A printing apparatus (medium cutting device)
2 medium
2a printed portion (processed portion)
2b non-printed portion (non-processed portion)
2c upstream medium (second upstream medium)
2d first end surface (end surface on downstream side in conveyance direction of second upstream medium)
2c1 upstream medium (first upstream medium)
2m second end surface (end surface on downstream side in conveyance direction of first upstream medium)
2v downstream medium
2w downstream medium end portion
3 printing mechanism (processing mechanism)
6 head (inkjet head)
7 carriage
8 cutter blade
9 cutter unit
10 medium conveyance mechanism
11 carriage driving mechanism (cutter unit driving mechanism)
12 medium feeding mechanism
13 medium winding mechanism
15 first medium guide
15a conveyance direction downstream end of first medium guide
15b conveyance direction upstream end of first medium guide
16 second medium guide
16a conveyance direction downstream end of second medium guide
16b conveyance direction upstream end of second medium guide
18 platen
21 moving mechanism
26 paper tube
31 cutter holder
32 unit frame
33 up-down moving mechanism (cutter blade moving mechanism)
34 switching mechanism
42 regulation member
42A regulation position
42B regulation release position
43 solenoid (drive source)
D1 maximum distance in up-down direction between medium and upper surface of platen
D2 distance in up-down direction between lower end surface of inkjet head and upper surface of platen
L interval
SP1, SP1A thrusting spot (third thrusting spot)
SP2, SP2A thrusting spot (first thrusting spot)
SP3, SP3A thrusting spot (second thrusting spot)
ST1 thrusting process (third thrusting process)
ST2 lateral cutting process (sixth cutting process)
ST3 lateral cutting process (seventh cutting process)
ST4 thrusting process (first thrusting process)
ST5 lateral cutting process (fourth cutting process)
ST6 oblique cutting process (first cutting process)
ST7 thrusting process (second thrusting process)
ST8 lateral cutting process (fifth cutting process)
ST9 oblique cutting process (third cutting process)
ST11 second cutting process
ST4A, ST24 medium conveyance process
ST5A thrusting process (first thrusting process)
ST6A oblique cutting process (first oblique cutting process)
ST7A thrusting process (second thrusting process)
ST8A oblique cutting process (second oblique cutting process)
ST9A lateral cutting process (second lateral cutting process)
ST10A lateral cutting process (first lateral cutting process)
ST11A linear cutting process
ST12A, 12B convex cutting process
ST21 medium setting process
ST41 second linear cutting process
ST44 second medium conveyance process
ST51 cutter blade retreating process
ST52 third medium conveyance process
ST53 carriage moving process
ST54 fourth medium conveyance process
ST55 cutter blade arrangement process
ST61 standby position moving process
ST62 cutter blade retreating process
ST63 fifth medium conveyance process
ST64 cutter unit moving process
Y width direction of medium
Y1 first direction side
Y2 second direction side
θ1, θ3 cutting angle
θ2, θ4 cutting angle

1. A medium cutting method for cutting a medium in a medium cutting device including a cutter unit having a cutter blade for cutting a long medium and a moving mechanism for relatively moving the cutter unit to the medium in a width direction of the medium orthogonal to a longitudinal direction of the medium and a thickness direction of the medium and the longitudinal direction of the medium, the medium cutting method comprising:
a first thrusting process of thrusting the cutter blade into the medium so as to penetrate the medium;
a first cutting process of cutting the medium in a direction inclined with respect to the width direction of the medium by relatively moving the cutter blade with respect to the medium in the longitudinal direction of the medium and the width direction of the medium with a first thrusting spot as a starting point, which is a spot thrust by the cutter blade in the first thrusting process.

2. The medium cutting method according to claim 1, comprising:
a second cutting process of relatively moving the cutter blade to the medium in the width direction of the medium to cut the medium in an entire region in the width direction of the medium, wherein
the moving mechanism includes a medium conveyance mechanism that conveys the medium in the longitudinal direction of the medium and a cutter unit driving mechanism that moves the cutter unit in the width direction of the medium, and
when an upstream side in a conveyance direction of the medium is defined as a conveyance direction upstream side, a downstream side in a conveyance direction of the medium is defined as a conveyance direction downstream side, one side in the width direction of the medium is defined as a first direction side, an other side in the width direction of the medium is defined as a second direction side, the medium disposed on the conveyance direction upstream side with respect to a cutting position of the medium in the second cutting process is defined as an upstream medium, and an end surface on the conveyance direction downstream side of the upstream medium after the second cutting process is finished is defined as a first end surface,
in the first thrusting process, the cutter blade is thrust into the upstream medium, and
in the first cutting process, the upstream medium is cut from the first thrusting spot to the first end surface.

3. The medium cutting method according to claim 2, comprising:
a second thrusting process of thrusting the cutter blade into the upstream medium so as to penetrate the upstream medium; and
a third cutting process of cutting the upstream medium in a direction inclined with respect to the width direction of the medium by relatively moving the cutter blade with respect to the upstream medium in the longitudinal direction of the medium and the width direction of the medium with a second thrusting spot as a starting point, which is a spot thrust by the cutter blade in the second thrusting process, wherein
the medium cutting device includes a medium winding mechanism that rotates a winding core material to which an end portion of the medium on the conveyance direction downstream side is fixed and winds the medium around the core material, in the first thrusting process, the cutter blade is thrust into an end portion of the upstream medium on the first direction side,
in the first cutting process, the cutter blade is relatively moved with respect to the upstream medium from the first thrusting spot to the first end surface toward the conveyance direction downstream side and the second direction side,
in the second thrusting process, the cutter blade is thrust into an end portion of the upstream medium on the second direction side, and
in the third cutting process, the cutter blade is relatively moved with respect to the upstream medium from the second thrusting spot to the first end surface toward the conveyance direction downstream side and the first direction side.

4. The medium cutting method according to claim 3, comprising:
a fourth cutting process of moving the cutter blade toward the first direction side with respect to the upstream medium with the first thrusting spot as a starting point to cut the upstream medium in the width direction of the medium from the first thrusting spot to an end surface of the upstream medium on the first direction side after the first thrusting process and before the first cutting process; and
a fifth cutting process of moving the cutter blade toward the second direction side with respect to the upstream medium with the second thrusting spot as a starting point to cut the upstream medium in the width direction of the medium from the second thrusting spot to the end surface on the second direction side of the upstream medium after the second thrusting process and before the third cutting process.

5. The medium cutting method according to claim 3, wherein
the cutter unit includes a cutter holder to which the cutter blade is fixed, and a unit frame that rotatably holds the cutter holder,
the cutter holder is rotatable with respect to the unit frame with the thickness direction of the medium as an axial direction of rotation,
in the first cutting process and the third cutting process, the cutter blade is rotatable with respect to the unit frame, and
a cutting angle of the upstream medium with respect to the width direction of the medium in the first cutting process and a cutting angle of the upstream medium with respect to the width direction of the medium in the third cutting process are constant regardless of a width of the medium.

6. The medium cutting method according to claim 2, wherein
the second cutting process includes:
a third thrusting process of thrusting the medium with the cutter blade so as to penetrate the medium;
a sixth cutting process of moving the cutter blade toward the first direction side with respect to the medium to cut the medium in the width direction of the medium with a third thrusting spot as a starting point, which is a spot thrust with the cutter blade in the third thrusting process; and
a seventh cutting process of moving the cutter blade toward the second direction side with respect to the medium to cut the medium in the width direction of the medium with the third thrusting spot as a starting point up to an end surface on the second direction side of the medium.

7-21. (canceled)

22. A medium cutting method for cutting a medium in a medium cutting device including a cutter unit having a cutter blade for cutting a long medium, a processing mechanism for performing predetermined processing on the medium, a medium feeding mechanism for holding the medium before processing wound in a roll shape, a medium conveyance mechanism for conveying the medium in a longitudinal direction of the medium, and a cutter unit driving mechanism for moving the cutter unit in a width direction of the medium orthogonal to the longitudinal direction of the medium and a thickness direction of the medium, the medium cutting method comprising:
when, in a conveyance direction of the medium by the medium conveyance mechanism, a side on which the cutter blade is disposed with respect to the medium feeding mechanism is defined as a conveyance direction downstream side, and a side opposite to the conveyance direction downstream side is defined as a conveyance direction upstream side,
a medium setting process of setting the medium wound in a roll shape in the medium feeding mechanism;
a medium conveyance process of conveying the medium by a predetermined amount toward the conveyance direction downstream side after the medium setting process; and
a convex cutting process of moving the cutter blade in the width direction of the medium and conveying the medium to cut the medium in an entire region in the width direction of the medium after the medium conveyance process, wherein
when the medium disposed on the conveyance direction upstream side from the cutting position of the medium in the convex cutting process is defined as a first upstream medium,
an end surface of the first upstream medium on the conveyance direction downstream side has a trapezoidal shape or a triangular convex shape,
the medium is not processed by the processing mechanism after the medium conveyance process and before the convex cutting process, and the medium is processed by the processing mechanism after the convex cutting process, and
in the medium conveyance process, the medium is conveyed to a position where a predetermined interval is formed between the conveyance direction downstream end of the medium and the conveyance direction downstream end of the first upstream medium before the convex cutting process.

23. The medium cutting method according to claim 22, comprising:
a linear cutting process of moving the cutter blade in the width direction of the medium in a state where the medium is stopped to cut the medium in an entire region in the width direction of the medium, wherein
when the medium disposed on the conveyance direction upstream side of a cutting position of the medium in the linear cutting process is defined as a second upstream medium,
an end surface of the second upstream medium on the conveyance direction downstream side is linear parallel to the width direction of the medium,
the processing mechanism is a printing mechanism including an inkjet head that ejects ink onto the medium to perform printing,
the medium cutting device includes a carriage on which the cutter unit and the inkjet head are mounted and which is moved in the width direction of the medium by the cutter unit driving mechanism, and a medium winding mechanism which rotates a winding core material to which an end portion on the conveyance direction downstream side of the medium is connected and winds the printed medium around the core material,
the medium is printed by the inkjet head after the convex cutting process and before the linear cutting process, and
in the linear cutting process, a portion of the medium on the conveyance direction upstream side of a portion where printing has been performed is cut.

24. The medium cutting method according to claim 23, wherein
the medium cutting device includes a platen which is disposed below the carriage and on which a part of the medium in the conveyance direction of the medium is placed, and
in the medium conveyance process, the medium is conveyed to a position where a maximum distance in an up-down direction between a portion of the medium disposed on a lower side of the inkjet head in the convex cutting process and an upper surface of the platen is smaller than a distance in an up-down direction between a lower end surface of the inkjet head and the upper surface of the platen.

25. The medium cutting method according to claim 22, wherein
when one side in the width direction of the medium is a first direction side and a side opposite to the first direction side is a second direction side,
the convex cutting process includes:
a first thrusting process of thrusting the cutter blade into an end portion of the medium on the first direction side so as to penetrate the medium;
a first oblique cutting process of cutting the medium at least in a direction inclined with respect to the width direction of the medium by relatively moving the cutter blade with respect to the medium toward the conveyance direction downstream side and the second direction side with a first thrusting spot as a starting point, which is a spot thrust by the cutter blade in the first thrusting process;
a second thrusting process of thrusting the cutter blade into an end portion of the medium on the second direction side so as to penetrate the medium;
a second oblique cutting process of cutting the medium at least in a direction inclined with respect to the width direction of the medium by relatively moving the cutter blade with respect to the medium toward the conveyance direction downstream side and the first direction side with a second thrusting spot as a starting point, which is a spot thrust by the cutter blade in the second thrusting process;
a first lateral cutting process of, after the first oblique cutting process and the second oblique cutting process, moving the cutter blade in the first direction with respect to the medium with the first thrusting spot as a starting point to cut the medium in the width direction of the medium from the first thrusting spot to an end surface of the medium on the first direction side; and
a second lateral cutting process of, after the first oblique cutting process and the second oblique cutting process, moving the cutter blade toward the second direction side with respect to the medium with the second thrusting spot as a starting point to cut the medium in the width direction of the medium from the second thrusting spot to an end surface on the second direction side of the medium.

26. The medium cutting method according to claim 25, wherein
the medium cutting device includes a carriage on which the cutter unit is mounted and which is moved in the width direction of the medium by the cutter unit driving mechanism, and an inkjet head which is mounted on the carriage and which ejects ink onto the medium to perform printing,
the inkjet head is disposed on the second direction side of the cutter unit, and
the second lateral cutting process is performed before the first lateral cutting process.

27. The medium cutting method according to claim 25, wherein
the medium cutting device includes a carriage on which the cutter unit is mounted and which is moved in the width direction of the medium by the cutter unit driving mechanism,
the cutter unit includes a cutter blade moving mechanism that moves the cutter blade between a retreating position where the cutter blade is not in contact with the medium and a cuttable position where the medium can be cut by the cutter blade,
the second lateral cutting process is performed before the first lateral cutting process,
the convex cutting process includes:
a cutter blade retreating process of moving the cutter blade disposed at the cuttable position to the retreating position after the second lateral cutting process;
a third medium conveyance process of conveying the medium by a predetermined amount toward a conveyance direction downstream side after the second lateral cutting process;
a carriage moving process of moving the carriage toward the first direction side until a blade edge of the cutter blade is disposed at a same position as the first thrusting spot in the width direction of the medium after the cutter blade retreating process and the third medium conveyance process;
a fourth medium conveyance process of conveying the medium toward the conveyance direction upstream side until a blade edge of the cutter blade is disposed at a same position as the first thrusting spot in the conveyance direction of the medium after the carriage moving process; and
a cutter blade arrangement process of moving the cutter blade disposed at the retreating position to the cuttable position after the fourth medium conveyance process, and
the first lateral cutting process is performed after the cutter blade arrangement process.

28. The medium cutting method according to claim 25, wherein
the medium cutting device includes a carriage on which the cutter unit is mounted and which is moved in the width direction of the medium by the cutter unit driving mechanism,
the cutter unit includes a cutter blade moving mechanism that moves the cutter blade between a retreating position where the cutter blade is not in contact with the medium and a cuttable position where the medium can be cut by the cutter blade,
the first lateral cutting process is performed before the second lateral cutting process,
the convex cutting process includes:
a cutter blade retreating process of moving the cutter blade disposed at the cuttable position to the retreating position after the first lateral cutting process;
a third medium conveyance process of conveying the medium by a predetermined amount toward a conveyance direction downstream side after the first lateral cutting process;
a carriage moving process of moving the carriage toward the second direction side until a blade edge of the cutter blade is disposed at a same position as the second thrusting spot in the width direction of the medium after the cutter blade retreating process and the third medium conveyance process;
a fourth medium conveyance process of conveying the medium toward the conveyance direction upstream side until a blade edge of the cutter blade is disposed at a same position as the second thrusting spot in the conveyance direction of the medium after the carriage moving process; and
a cutter blade arrangement process of moving the cutter blade disposed at the retreating position to the cuttable position after the fourth medium conveyance process, and
the second lateral cutting process is performed after the cutter blade arrangement process.

29. The medium cutting method according to claim 25, comprising:
a standby position moving process of moving the cutter unit to a predetermined standby position after the convex cutting process, wherein
the cutter unit includes a cutter blade moving mechanism that moves the cutter blade between a retreating position where the cutter blade is not in contact with the medium and a cuttable position where the medium can be cut by the cutter blade,
the second lateral cutting process is performed before the first lateral cutting process,
the cutter unit disposed at the standby position is disposed on the second direction side with respect to the medium,
the cutter blade is disposed on the first direction side with respect to the medium when the first lateral cutting process is completed, and
the standby position moving process includes:
a cutter blade retreating process of moving the cutter blade disposed at the cuttable position to the retreating position after the first lateral cutting process;
a fifth medium conveyance process of conveying the medium by a predetermined amount toward the conveyance direction downstream side after the first lateral cutting process; and
a cutter unit moving process of moving the cutter unit to the standby position after the cutter blade retreating process and the fifth medium conveyance process.

30. The medium cutting method according to claim 25, wherein
the medium cutting device includes a platen on which a part of the medium in the conveyance direction of the medium is placed, a first medium guide that presses an end portion of the medium placed on the platen on the first direction side from above, and a second medium guide that presses an end portion of the medium placed on the platen on the second direction side from above,
the conveyance direction downstream end of the first medium guide and the conveyance direction downstream end of the second medium guide are disposed on the conveyance direction upstream side of a blade edge of the cutter blade,
the conveyance direction upstream end of the first medium guide is disposed on the conveyance direction upstream side of the first thrusting spot when the first oblique cutting process is completed, and
the conveyance direction upstream end of the second medium guide is disposed on the conveyance direction upstream side of the second thrusting spot when the second oblique cutting process is completed.

31. The medium cutting method according to claim 25, wherein
the cutter unit includes a cutter holder to which the cutter blade is fixed, and a unit frame that rotatably holds the cutter holder,
the cutter holder is rotatable with respect to the unit frame with the thickness direction of the medium as an axial direction of rotation,
in the first oblique cutting process and the second oblique cutting process, the cutter blade is rotatable with respect to the unit frame, and
a cutting angle of the medium with respect to the width direction of the medium in the first oblique cutting process and a cutting angle of the medium with respect to the width direction of the medium in the second oblique cutting process are constant regardless of a width of the medium.

32. (canceled)

33. (canceled)

34. A control method of a medium cutting device including a cutter unit having a cutter blade for cutting a long medium, a medium feeding mechanism for holding the medium wound in a roll shape, a medium conveyance mechanism for conveying the medium in a longitudinal direction of the medium, and a cutter unit driving mechanism for moving the cutter unit in a width direction of the medium orthogonal to the longitudinal direction of the medium and a thickness direction of the medium, the control method comprising:
when, in a conveyance direction of the medium by the medium conveyance mechanism, a side on which the cutter blade is disposed with respect to the medium feeding mechanism is defined as a conveyance direction downstream side, and a side opposite to the conveyance direction downstream side is defined as a conveyance direction upstream side,
a linear cutting step of moving, by the cutter unit driving mechanism, the cutter blade in the width direction of the medium in a state where the medium is stopped to cut the medium in an entire region in the width direction of the medium;
a medium conveyance step of conveying, by the medium conveyance mechanism, the medium by a predetermined amount toward the conveyance direction downstream side after the linear cutting step; and
a convex cutting step of moving, by the cutter unit driving mechanism, the cutter blade in the width direction of the medium and conveying the medium by the medium conveyance mechanism to cut the medium in an entire region in the width direction of the medium after the medium conveyance step, wherein
when the medium disposed on the conveyance direction upstream side of the cutting position of the medium in the convex cutting step is defined as a first upstream medium, and the medium disposed on the conveyance direction upstream side of the cutting position of the medium in the linear cutting step is defined as a second upstream medium,
an end surface of the second upstream medium on the conveyance direction downstream side is linear parallel to the width direction of the medium,
an end surface of the first upstream medium on the conveyance direction downstream side has a trapezoidal shape or a triangular convex shape, and
in the medium conveyance step, the medium is conveyed to a position where a predetermined interval is formed between the conveyance direction downstream end of the second upstream medium and the conveyance direction downstream end of the first upstream medium.

35. (canceled)
